(19) United States
(12) Patent Application Publication
(10) Pub. No.: US 2023/0204731 A1
(43) Pub. Date: Jun. 29, 2023

(54) LIDAR DEVICE

(71) Applicant: SOS LAB Co., Ltd., Gwangju (KR)

(72) Inventors: Sangwoo PARK, Seoul (KR); Jinyoung OH, Gwangju (KR); Dongkyu KIM, Gwangju (KR)

(21) Appl. No.: 17/745,550

(22) Filed: May 16, 2022

(30) Foreign Application Priority Data
Dec. 29, 2021 (KR) 10-2021-0190527
Dec. 29, 2021 (KR) 10-2021-0190528

(51) Int. Cl. G01S 7/4865; G01S 17/08; G01S 17/931; G01S 7/4863

(52) U.S. Cl. CPC G01S 7/4865; G01S 17/08; G01S 17/931; G01S 7/4863; G01S 17/933

(57) ABSTRACT

A Light Detection and Ranging (LiDAR) device comprising: a laser detecting array including a first detecting unit, a delay generating unit configured to obtain a detection signal from the first detecting unit and output a delay signal, a signal detecting unit configured to detect the delay signal outputted from the delay generating unit using a preset clock, a memory unit configured to store a histogram data based on a detection result by the signal detecting unit and a data processing unit for calculating a distance value for the first detecting unit based on the histogram data stored in the memory unit, wherein the delay generating unit applies a first delay value for a first detecting cycle, and applies a second delay value for a second detecting cycle, wherein the first delay value and the second delay value are different from each other.

### CROSS-REFERENCE TO RELATED APPLICATIONS

This application claims priority to and the benefit of Korean Patent Application No. 10-2021-0190527, filed on Dec. 29, 2021 and Korean Patent Application No. 10-2021-0190528, filed on Dec. 29, 2021, the disclosure of which is incorporated herein by reference in their entirety.

### TECHNICAL FIELD

The present invention relates to an optic unit and a light detection and ranging (LiDAR) device including an optic unit, and more particularly, to a LiDAR device including a sub-optic unit and a transmission optic unit.

In addition, the present invention relates to a LiDAR device, and more particularly, to a LiDAR device using a delay generating unit to have distance resolution higher than that of a preset clock.

### BACKGROUND

Recently, with interest in autonomous vehicles and driverless vehicles, a light detection and ranging (LiDAR) device has been in the spotlight. A LiDAR device is a device that acquires surrounding distance information using a laser, and due to advantages such as excellent precision and resolution and an ability to identify an object stereoscopically, the LiDAR device is being applied not only to automobiles but also to various fields such as drone and aircraft fields.

Meanwhile, in the case of a bi-axial LiDAR device, unlike a co-axial lidar device, it may be difficult to detect an object located within a certain range according to an arrangement of a transmission module and a reception module.

Therefore, it is important to minimize such a minimum measurement distance and to minimize a dead zone of a LiDAR device.

In addition, in the case of a LiDAR device that detects a signal acquired from a detecting unit and measures a distance, the performance of distance resolution may vary according to a resolution of a preset clock for detecting the signal acquired from the detecting unit.

However, when the resolution of a preset clock is high, an amount of histogram data or the like for measuring one distance may be increased.

Therefore, there is a need to manufacture a LiDAR device in which the resolution of a preset clock is set within a reasonable range and which has distance resolution higher than that of the preset clock.

### SUMMARY OF THE INVENTION

The present invention is directed to providing a light detection and ranging (LiDAR) device with a minimized dead zone.

The present invention is directed to providing a LiDAR device which measures a distance using histogram data about a plurality of cycles and has distance resolution higher than that of a preset clock.

Technical solutions of the present invention may not be limited to the above, and other technical solutions which are not described herein should be clearly understood by those skilled in the art, to which the present invention belongs, from the present specification and the accompanying drawings.

According to an aspect of the present invention, there is provided a LiDAR device including a transmission module which includes an emitter array and a first optic unit, wherein the emitter array includes a first emitting unit, a reception module which includes a detector array and a second optic unit, and a sub-optic unit disposed on an optical path through which a first laser emitted from the first emitting unit is guided by the first optic unit, wherein the sub-optic unit includes a diffuser configured to diffuse at least a portion of the first laser, a size of the diffuser is less than a diameter of the first optic unit and is less than a diameter of the first laser emitted from the first emitting unit, and the diameter of the first laser is defined as a diameter on a surface on which the diffuser is disposed.

According to another aspect of the present invention, there is provided a LiDAR device including a laser detecting array which includes a first detecting unit, a delay generating unit configured to acquire a detection signal from the first detecting unit and output a delay signal, a signal detecting unit configured to detect the delay signal emitted from the delay generating unit using preset clocks, a memory unit configured to store histogram data based on a detection result of the signal detecting unit, and a data processing unit configured to calculate a distance value for the first detecting unit based on the histogram data stored in the memory unit, wherein the delay generating unit applies a first delay value to a first cycle to output a delay signal and applies a second delay value to a second cycle to output a delay signal, and the first delay value and the second delay value are different from each other.

According to still another aspect of the present invention, there is a provided a LiDAR device including a laser detecting array which includes a first detecting unit, a delay generating unit configured to acquire a detection signal from the first detecting unit and output a delay signal to which at least one delay value of first to N^{th} delay values is applied, a signal detecting unit configured to detect the delay signal emitted from the delay generating unit using preset clocks, a memory unit configured to store histogram data based on a detection result of the signal detecting unit, and a data processing unit configured to calculate a distance value for the first detecting unit based on the histogram data stored in the memory unit, wherein the delay generating unit applies the first to N^{th} delay values to M cycles, and the number of cycles to which the same delay value is applied is M/N.

According to yet another aspect of the present invention, there is a provided a LiDAR device including a laser detecting array which includes a first detecting unit, a delay generating unit configured to acquire a detection signal from the first detecting unit and output a delay signal, a signal detecting unit configured to detect the delay signal emitted from the delay generating unit using preset clocks, a memory unit configured to store histogram data based on a detection result of the signal detecting unit, and a data processing unit configured to calculate a distance value for the first detecting unit based on the histogram data stored in the memory unit, wherein, when the LiDAR device operates in a first mode, the delay generating unit applies the same delay value to a plurality of cycles, and when the LiDAR device operates in a second mode, the delay generating unit applies two or more different delay values to the plurality of cycles.

The objects of the present invention are not limited to the above-described objects, and other objects which are not described herein should be clearly understood by those skilled in the art, to which the present invention belongs, from the following detailed description and the accompanying drawings.

### BRIEF DESCRIPTION OF THE DRAWINGS

FIG. 1 is a diagram for describing a light detection and ranging (LiDAR) device according to one embodiment.

FIG. 2 is a diagram illustrating a LiDAR device according to one embodiment.

FIG. 3 is a diagram illustrating a LiDAR device according to another embodiment.

FIG. 4 is a diagram illustrating a laser emitting unit according to one embodiment.

FIG. 5 shows diagrams illustrating a vertical cavity surface emitting laser (VCSEL) unit according to one embodiment.

FIG. 6 shows diagrams illustrating a VCSEL array according to one embodiment.

FIG. 7 is a side view illustrating a VCSEL array and a metal contact according to one embodiment.

FIG. 8 is a diagram illustrating a VCSEL array according to one embodiment.

FIG. 9 is a diagram for describing a LiDAR device according to one embodiment.

FIG. 10 is a diagram for describing a collimation component according to one embodiment.

FIG. 11 is a diagram for describing a collimation component according to one embodiment.

FIG. 12 is a diagram for describing a collimation component according to one embodiment.

FIG. 13 shows diagrams for describing a collimation component according to one embodiment.

FIG. 14 is a diagram for describing a steering component according to one embodiment.

FIGS. 15 and 16 are diagrams for describing a steering component according to one embodiment.

FIG. 17 is a diagram for describing a steering component according to one embodiment.

FIG. 18 is a diagram for describing a steering component according to one embodiment.

FIG. 19 is a diagram for describing a metasurface according to one embodiment.

FIG. 20 is a diagram for describing a metasurface according to one embodiment.

FIG. 21 is a diagram for describing a metasurface according to one embodiment.

FIG. 22 is a diagram for describing a rotating polygon mirror according to one embodiment.

FIG. 23 is a top view for describing a viewing angle of a rotating polygon mirror having three reflective surfaces and a body of which upper and lower portions have an equilateral triangle shape.

FIG. 24 is a top view for describing a viewing angle of a rotating polygon mirror having four reflective surfaces and a body of which upper and lower portions have a square shape.

FIG. 25 is a top view for describing a viewing angle of a rotating polygon mirror having five reflective surfaces and a body of which upper and lower portions have a regular pentagon shape.

FIG. 26 is a diagram for describing a radiating part and a light receiving part of a rotating polygon mirror according to one embodiment.

FIG. 27 is a diagram for describing an optic unit according to one embodiment.

FIG. 28 is a diagram for describing an optic unit according to one embodiment.

FIG. 29 is a diagram for describing a meta-component according to one embodiment.

FIG. 30 is a diagram for describing a meta-component according to another embodiment.

FIG. 31 is a diagram for describing a single photon avalanche diode (SPAD) array according to one embodiment.

FIG. 32 shows diagrams for describing a histogram of an SPAD according to one embodiment.

FIG. 33 is a diagram for describing a silicon photomultiplier (SiPM) according to one embodiment.

FIG. 34 shows diagrams for describing a histogram of an SiPM according to one embodiment.

FIG. 35 shows diagrams for describing a semi-flash LiDAR according to one embodiment.

FIG. 36 is a diagram for describing a configuration of a semi-flash LiDAR according to one embodiment.

FIG. 37 shows diagrams for describing a configuration of a semi-flash LiDAR according to another embodiment.

FIG. 38 shows diagrams for describing a configuration of a semi-flash LiDAR according to still another embodiment.

FIG. 39 is a diagram for describing a LiDAR device according to one embodiment.

FIG. 40 is a diagram for describing a reception module according to one embodiment.

FIG. 41 is a diagram for describing a reception module according to one embodiment.

FIG. 42 shows diagrams for describing an incident angle of a light ray of parallel light incident on a lens assembly according to one embodiment.

FIG. 43 is a diagram for describing a reception module according to one embodiment.

FIG. 44 is a graph for describing a bandwidth and a center wavelength of a filter layer.

FIG. 45 is a graph for describing a bandwidth and a center wavelength of a filter layer.

FIGS. 46 and 47 are diagrams for describing a reception module according to one embodiment.

FIG. 48 is a diagram for describing a LiDAR device according to one embodiment.

FIG. 49 is a graph for describing a design of a filter layer and a design of a wavelength of a laser emitting array included in the LiDAR device according to one embodiment shown in FIG. 48.

FIG. 50 is a diagram for describing a LiDAR device and a dead zone and a minimum measurement distance of the LiDAR device according to one embodiment.

FIGS. 51 and 52 are diagrams for describing a transmission module included in a LiDAR device according to one embodiment.

FIG. 53 is a diagram for describing a laser radiated through a transmission module according to one embodiment.

FIG. 54 is a diagram for describing a LiDAR device and a dead zone and a minimum measurement distance of the LiDAR device according to one embodiment.

FIGS. 55 and 56 are diagrams for describing a sub-optic unit according to one embodiment.

FIG. 57 is a diagram for describing a laser radiated through a transmission module according to one embodiment.

FIG. 58 shows diagrams for describing various embodiments of a laser radiated through a transmission module.

FIG. 59 shows diagrams for describing various embodiments of an arrangement of a sub-optic unit.

FIG. 60 is a diagram for describing an interference phenomenon with an external device according to one embodiment.

FIG. 61 shows diagrams for describing a plurality of data sets based on a plurality of output signals of a detecting unit according to one embodiment.

FIG. 62 shows diagrams for describing a histogram in which a plurality of data sets are accumulated according to one embodiment.

FIG. 63 shows diagrams for describing a plurality of data sets based on a plurality of output signals of a detecting unit according to another embodiment.

FIG. 64 shows diagrams for describing a histogram in which a plurality of data sets are accumulated according to another embodiment.

FIG. 65 is a diagram for describing a timing of a laser emitting signal of a laser emitting unit and a timing of a received signal of a detecting unit.

FIG. 66 shows diagrams for describing a histogram according to a timing of a laser emitting signal of a laser emitting unit.

FIG. 67 is a diagram for describing a method of controlling a LiDAR device according to one embodiment.

FIG. 68 is a diagram for describing a situation assumed to describe the invention according to one embodiment.

FIG. 69 shows diagrams for describing the operation of a signal processing unit for measuring a distance to a first object in a LiDAR device according to one embodiment.

FIG. 70 shows diagrams for describing the operation of a signal processing unit for measuring a distance to a second object in a LiDAR device according to one embodiment.

FIG. 71 is a diagram for describing a LiDAR device according to one embodiment.

FIG. 72 shows diagrams for describing the operation of a signal processing unit for measuring a distance to a first object in a LiDAR device according to one embodiment.

FIG. 73 shows diagrams for describing the operation of a signal processing unit for measuring a distance to a second object in a LiDAR device according to one embodiment.

FIG. 74 is a diagram for describing a delay generating unit according to one embodiment.

FIG. 75 is a diagram for describing a delay value according to one embodiment.

FIG. 76 is a diagram for describing an operation mode of a LiDAR device according to one embodiment.

FIG. 77 is a diagram for describing a delay generating unit according to one embodiment.

FIG. 78 is a diagram for describing the operation of a signal processing unit for measuring a distance to a second object in a LiDAR device according to one embodiment.

FIG. 79 is a diagram for describing a data processing unit according to one embodiment.

FIG. 80 is a diagram for describing a data processing unit according to one embodiment.

### DETAILED DESCRIPTION OF EXEMPLARY EMBODIMENTS

Embodiments described in this specification are made to clearly explain the scope of the present invention to those having ordinary skill in the art and are not intended to limit the present invention. It should be interpreted that the present invention may include substitutions and modifications within the technical scope of the present invention.

The terms used in this specification are selected from general terms, which are widely used currently, based on functions of components according to the embodiment of the present invention, and may have meanings varying according to the intentions of those skilled in the art, the customs in the related art, or advent of new technology. However, when a specified term is defined and used in an arbitrary sense, a meaning of the term will be described separately. Accordingly, the terms used in this specification should not be defined as simple names of the components but be defined based on the actual meaning of the terms and the whole context throughout the present specification.

In the present specification, the accompanying drawings are to facilitate the description of the present invention and the shape in the drawings may be exaggerated for the purpose of convenience of description so that the present invention should not be limited to the drawings.

In the present specification, the detailed descriptions of the generally known structure or function related to the present invention which make the subject matter of the present invention unclear, will be omitted if necessary.

According to one embodiment of the present invention, as a light detection and ranging (LiDAR) device, there may be provided a LiDAR device including a transmission module which includes an emitter array and a first optic unit, wherein the emitter array includes a first emitting unit, a reception module which includes a detector array and a second optic unit, and a sub-optic unit disposed on an optical path through which a first laser emitted from the first emitting unit is guided by the first optic unit, wherein the sub-optic unit includes a diffuser configured to diffuse at least a portion of the first laser, a size of the diffuser is less than a diameter of the first optic unit and is less than a diameter of the first laser emitted from the first emitting unit, and the diameter of the first laser is defined as a diameter on a surface on which the diffuser is disposed.

Here, the sub-optic unit may further include a steering component.

Here, the diffuser included in the sub-optic unit may be disposed to diffuse a portion of the first laser steered by the steering component included in the sub-optic unit.

Here, a size of the steering component included in the sub-optic unit may be less than a diameter of a pupil of the first optic unit and may be less than the diameter of the first laser emitted from the first emitting unit.

Here, the steering component may steer a portion of the first laser in a direction, in which the reception module is located, with respect to a center of the transmission module.

Here, the steering component may be disposed closer to the first optic unit than the diffuser.

Here, an angle of view of the diffuser may be greater than an angle of view of the first optic unit.

Here, the size of the diffuser may be less than a diameter of an outermost lens of the first optic unit.

Here, a center of the diffuser may be aligned with a center of the first optic unit.

Here, the diffuser may be disposed in an area in which optical paths, through which lasers emitted from the emitting array are guided by the first optic unit, overlap each other.

Here, the LiDAR device may include a window, and the sub-optic unit may be disposed on the window.

Here, the LiDAR device may further include a sub-optic mount, the sub-optic unit may be located on the sub-optic mount, and the sub-optic mount may be mounted on the first optic unit.

Here, the sub-optic unit may be formed integrally with the first optic unit.

Here, the sub-optic unit may be formed as a part of the outermost lens of the first optic unit.

Here, the emitter array may include a plurality of emitting units, and each of the plurality of emitting units may include at least one vertical cavity surface emitting laser (VCSEL). The detector array may include a plurality of detecting units, and each of the plurality of detecting units may include at least one single photon avalanche diode (SPAD).

According to one embodiment of the present invention, as a LiDAR device for measuring a distance using histogram data about a plurality of cycles, there may be provided a LiDAR device including a laser detecting array which includes a first detecting unit, a delay generating unit configured to acquire a detection signal from the first detecting unit and output a delay signal, a signal detecting unit configured to detect the delay signal emitted from the delay generating unit using preset clocks, a memory unit configured to store histogram data based on a detection result of the signal detecting unit, and a data processing unit configured to calculate a distance value for the first detecting unit based on the histogram data stored in the memory unit, wherein the delay generating unit applies a first delay value to a first cycle to output a delay signal and applies a second delay value to a second cycle to output a delay signal, and the first delay value and the second delay value are different from each other.

Here, the number of cycles to which the first delay value is applied among the plurality of cycles may be two or more, and the number of cycles to which the second delay value is applied among the plurality of cycles may be two or more.

Here, all of the preset clocks for the plurality of cycles may be the same.

Here, the first delay value and the second delay value may be less than a time bin unit length of the histogram data.

Here, the second delay value may be twice the first delay value.

Here, the number of the cycles to which the first delay value is applied may be the same as the number of the cycles to which the second delay value is applied.

Here, a difference between the first delay value and the second delay value may be less than the time bin unit length of the histogram data.

Here, the data processing unit may extract valid data based on the histogram data and may calculate the distance value for the first detecting unit based on the extracted valid data.

Here, the data processing unit may calculate a central time value based on counting values and time bin values included in the valid data and may calculate the distance value for the first detecting unit based on the central time value.

According to one embodiment of the present invention, as a LiDAR device for measuring a distance using histogram data about M cycles, there may be provided a LiDAR device including a laser detecting array which includes a first detecting unit, a delay generating unit configured to acquire a detection signal from the first detecting unit and output a delay signal to which at least one delay value of first to N^{th} delay values is applied, a signal detecting unit configured to detect the delay signal emitted from the delay generating unit using preset clocks, a memory unit configured to store histogram data based on a detection result of the signal detecting unit, and a data processing unit configured to calculate a distance value for the first detecting unit based on the histogram data stored in the memory unit, wherein the delay generating unit applies the first to N^{th} delay values to M cycles, and the number of cycles to which the same delay value is applied is M/N.

Here, the M cycles may be 128 cycles, N delay values may be 16 delay values, and the number of the cycles to which the same delay value is applied may be 8.

According to one embodiment of the present invention, as a LiDAR device for measuring a distance using histogram data about a plurality of cycles, there may be provided a LiDAR device including a laser detecting array which includes a first detecting unit, a delay generating unit configured to acquire a detection signal from the first detecting unit and output a delay signal, a signal detecting unit configured to detect the delay signal emitted from the delay generating unit using preset clocks, a memory unit configured to store histogram data based on a detection result of the signal detecting unit, and a data processing unit configured to calculate a distance value for the first detecting unit based on the histogram data stored in the memory unit, wherein, when the LiDAR device operates in a first mode, the delay generating unit applies the same delay value to the plurality of cycles, and when the LiDAR device operates in a second mode, the delay generating unit applies two or more different delay values to the plurality of cycles.

Here, a delay value applied by the delay generating unit when the LiDAR device operates in the first mode may be the same as one value of the one or more two different delay values applied by the delay generating unit when the LiDAR device operates in the second mode.

Here, the one or more two different delay values applied by the delay generating unit when the LiDAR device operates in the second mode may include a first delay value and a second delay value, the first delay value may be less than the delay value applied by the delay generating unit when the LiDAR device operates in the first mode, and the second delay value may be greater than the delay value applied by the delay generating unit when the LiDAR device operates in the first mode.

Here, the detector array may include a plurality of detecting units, and each of the plurality of detecting units may include at least one single photon avalanche diode (SPAD).

Hereinafter, a LiDAR device of the present disclosure will be described.

A LiDAR device is a device for detecting a distance to an object and the location of an object using a laser. For example, a LiDAR device may emit a laser beam. When the emitted laser beam is reflected by an object, the LiDAR device may receive the reflected laser beam and measure a distance between the object and the LiDAR device and the location of the object. In this case, the distance from the object and the location of the object may be expressed in a coordination system. For example, the distance from the object and the location of the object may be expressed in a spherical coordinate system (r, θ, φ). However, the present disclosure is not limited thereto, and the distance and location may be expressed in a Cartesian coordinate system (X, Y, Z) or a cylindrical coordinate system (r, θ, z).

Also, the LiDAR device may use laser beams output from the LiDAR device and reflected by an object in order to measure a distance from the object.

The LiDAR device according to an embodiment may use a time of flight (TOF) of a laser beam, which is the time taken by a laser beam to be detected after being emitted, in order to measure the distance from the object. For example, the LiDAR device may measure the distance from the object using a difference between a time value based on an emitting time of an emitted laser beam and a time value based on a detection time of a detected laser beam reflected by the object.

Also, the LiDAR device may measure the distance from the object using a difference between a time value at which an emitted laser beam is detected immediately without reaching an object and a time value based on a detection time of a detected laser beam reflected by the object.

There may be a difference between a time point at which the LiDAR device transmits a trigger signal for emitting a laser beam using a control unit and an actual emission time point, which is a time when the laser beam is actually emitted from a laser beam output element. Actually, no laser beam is emitted in a period between the time point of the trigger signal and the actual emission time point. Thus, when the period is included in the ToF of the laser beam, precision may be decreased.

The actual emission time point of the laser beam may be used to improve the precision of the measurement of the TOF of the laser beam. However, it may be difficult to determine the actual emission time point of the laser beam. Therefore, a laser beam should be directly delivered to a detecting unit as soon as or immediately after the laser beam is emitted from the laser emitting element without reaching the object.

For example, an optic may be disposed on an upper portion of the laser emitting element, and thus the optic may enable a laser beam emitted from the laser emitting element to be detected by a detecting unit immediately without reaching an object. The optic may be a mirror, a lens, a prism, a metasurface, or the like, but the present disclosure is not limited thereto. The optic may include one optic or a plurality of optics.

Also, for example, a detecting unit may be disposed on an upper portion of the laser emitting element, and thus a laser beam emitted from the laser emitting element may be detected by the detecting unit immediately without reaching an object. The detecting unit may be spaced a distance of 1 mm, 1 μm, 1 nm, or the like from the laser emitting element, but the present disclosure is not limited thereto. Alternatively, the detecting unit may be adjacent to the laser emitting element with no interval therebetween. An optic may be present between the detecting unit and the laser emitting element, but the present disclosure is not limited thereto.

Also, the LiDAR device according to an embodiment may use a triangulation method, an interferometry method, a phase shift measurement, and the like rather than the TOF method to measure a distance to an object, but the present disclosure is not limited thereto.

A LiDAR device according to an embodiment may be installed in a vehicle. For example, the LiDAR device may be installed on a vehicle's roof, hood, headlamp, bumper, or the like.

Also, a plurality of LiDAR devices according to an embodiment may be installed in a vehicle. For example, when two LiDAR devices are installed on a vehicle's roof, one LiDAR device is for monitoring an area in front of the vehicle, and the other one is for monitoring an area behind the vehicle, but the present disclosure is not limited thereto. Also, for example, when two LiDAR devices are installed on a vehicle's roof, one LiDAR device is for monitoring an area to the left of the vehicle, and the other one is for monitoring an area to the right of the vehicle, but the present disclosure is not limited thereto.

Also, the LiDAR device according to an embodiment may be installed in a vehicle. For example, when the LiDAR device is installed in a vehicle, the LiDAR device is for recognizing a driver's gesture while driving, but the present disclosure is not limited thereto. Also, for example, when the LiDAR device is installed inside or outside a vehicle, the LiDAR device is for recognizing a driver's face, but the present disclosure is not limited thereto.

A LiDAR device according to an embodiment may be installed in an unmanned aerial vehicle. For example, the LiDAR device may be installed in an unmanned aerial vehicle (UAV) System, a drone, a remotely piloted vehicle (RPV), an unmanned aircraft system (UAS), a remotely piloted air/aerial vehicle (RPAV), a remotely piloted aircraft system (RPAS), or the like.

Also, a plurality of LiDAR devices according to an embodiment may be installed in an unmanned aerial vehicle. For example, when two LiDAR devices are installed in an unmanned aerial vehicle, one LiDAR device is for monitoring an area in front of the unmanned aerial vehicle, and the other one is for monitoring an area behind the unmanned aerial vehicle, but the present disclosure is not limited thereto. Also, for example, when two LiDAR devices are installed in an unmanned aerial vehicle, one LiDAR device is for monitoring an area to the left of the aerial vehicle, and the other one is for monitoring an area to the right of the aerial vehicle, but the present disclosure is not limited thereto.

A LiDAR device according to an embodiment may be installed in a robot. For example, the LiDAR device may be installed in a personal robot, a professional robot, a public service robot, or other industrial robots or manufacturing robots.

Also, a plurality of LiDAR devices according to an embodiment may be installed in a robot. For example, when two LiDAR devices are installed in a robot, one LiDAR device is for monitoring an area in front of the robot, and the other one is for monitoring an area behind the robot, but the present disclosure is not limited thereto. Also, for example, when two LiDAR devices are installed in a robot, one LiDAR device is for monitoring an area to the left of the robot, and the other one is for monitoring an area to the right of the robot, but the present disclosure is not limited thereto.

Also, a LiDAR device according to an embodiment may be installed in a robot. For example, when the LiDAR device is installed in a robot, the LiDAR device is for recognizing a human face, but the present disclosure is not limited thereto.

Also, a LiDAR device according to an embodiment may be installed for industrial security. For example, the LiDAR device may be installed in a smart factory for the purpose of industrial security.

Also, a plurality of LiDAR devices according to an embodiment may be installed in a smart factory for the purpose of industrial security. For example, when two LiDAR devices are installed in a smart factory, one LiDAR device is for monitoring an area in front of the smart factory, and the other one is for monitoring an area behind the smart factory, but the present disclosure is not limited thereto. Also, for example, when two LiDAR devices are installed in a smart factory, one LiDAR device is for monitoring an area to the left of the smart factory, and the other one is for monitoring an area to the right of the smart factory, but the present disclosure is not limited thereto.

Also, a LiDAR device according to an embodiment may be installed for industrial security. For example, when the LiDAR device is installed for industrial security, the LiDAR device is for recognizing a human face, but the present disclosure is not limited thereto.

Various embodiments of elements of the LiDAR device will be described in detail below.

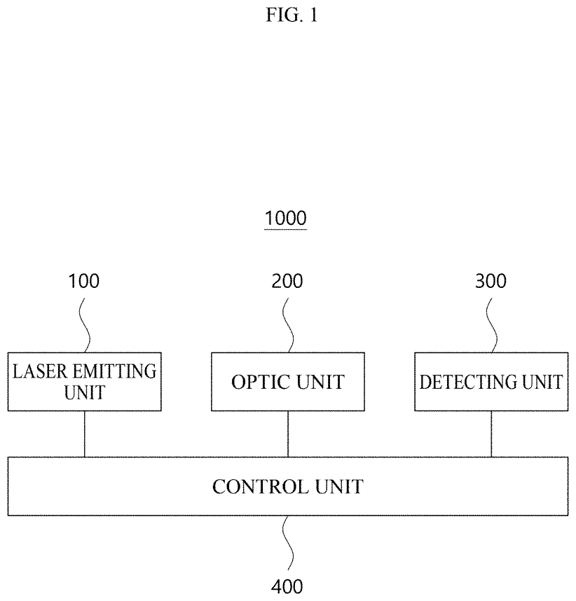

FIG. 1 is a diagram illustrating a LiDAR device according to an embodiment.

Referring to FIG. 1, a LiDAR device 1000 according to an embodiment may include a laser emitting unit 100.

In this case, the laser emitting unit 100 according to an embodiment may emit a laser beam.

Also, the laser emitting unit 100 may include one or more laser emitting elements. For example, the laser emitting unit 100 may include a single laser emitting element and may include a plurality of laser emitting elements. Also, when the laser emitting unit 100 includes a plurality of laser emitting elements, the plurality of laser emitting elements may constitute one array.

Also, the laser emitting unit 100 may include a laser diode (LD), a solid-state laser, a high power laser, a light-emitting diode (LED), a vertical-cavity surface-emitting laser (VCSEL), an external cavity diode laser (ECDL), and the like, but the present disclosure is not limited thereto.

Also, the laser emitting unit 100 may output a laser beam of a certain wavelength. For example, the laser emitting unit 100 may output a laser beam with a wavelength of 905 nm or a laser beam with a wavelength of 1550 nm. Also, for example, the laser emitting unit 100 may output a laser beam with a wavelength of 940 nm. Also, for example, the laser emitting unit 100 may output a laser beam with a plurality of wavelengths ranging between 800 nm and 1000 nm. Also, when the laser emitting unit 100 includes a plurality of laser emitting elements, some of the plurality of laser emitting elements may output a laser beam with a wavelength of 905 nm, and the others may output a laser beam with a wavelength of 1500 nm.

Referring to FIG. 1 again, the LiDAR device 1000 according to an embodiment may include an optic unit 200.

Herein, the optic unit may be variously expressed as a steering unit, a scanning unit, etc., but the present disclosure is not limited thereto.

In this case, the optic unit 200 according to an embodiment may change a flight path of a laser beam. For example, the optic unit 200 may change a flight path of a laser beam such that a laser beam emitted from the laser emitting unit 100 is directed to a scanning region. Also, for example, the optic unit 200 may change a flight path of laser beam such that a laser beam reflected by an object located in the scanning region is directed to a detecting unit.

In this case, the optic unit 200 according to an embodiment may change a flight path of laser beam by reflecting a laser beam. For example, the optic unit 200 may change flight path of a laser beam by reflecting a laser beam emitted from the laser emitting unit 100 such that the laser beam is directed to the scanning region. Also, for example, the optic unit 200 may change a flight path of laser beam such that a laser beam reflected by an object located in the scanning region is directed to the detecting unit.

Also, the optic unit 200 according to an embodiment may include various optic means to reflect laser beams. For example, the optic unit 200 may include a mirror, a resonance scanner, a micro-electromechanical system (MEMS) mirror, a voice coil motor (VCM), a polygonal mirror, a rotating mirror, or a galvano mirror, and the like, but the present disclosure is not limited thereto.

Also, the optic unit 200 according to an embodiment may change a flight path of laser beam by refracting laser beams. For example, the optic unit 200 may change a flight path of laser beam by refracting a laser beam emitted from the laser emitting unit 100 such that the laser beam is directed to the scanning region. Also, for example, the optic unit 200 may change a flight path of laser beam such that a laser beam reflected by an object located in the scanning region is directed to the detecting unit.

Also, the optic unit 200 according to an embodiment may include various optic means to refract laser beams. For example, the optic unit 200 may include lenses, prisms, microlenses, or microfluidic lenses, but the present disclosure is not limited thereto.

Also, the optic unit 200 according to an embodiment may change a flight path of laser beam by changing the phase of a laser beam. For example, the optic unit 200 may change a flight path of laser beam by changing the phase of a laser beam emitted from the laser emitting unit 100 such that the laser beam is directed to the scanning region. Also, for example, the optic unit 200 may change a flight path of laser beam such that a laser beam reflected by an object located in the scanning region is directed to the detecting unit.

Also, the optic unit 200 according to an embodiment may include various optic means to change the phase of a laser beam. For example, the optic unit 200 may include an optical phased array (OPA), a metalens, a metasurface, or the like, but the present disclosure is not limited thereto.

Also, the optic unit 200 according to an embodiment may include one or more optic means. Also, for example, the optic unit 200 may include a plurality of optic means.

Referring to FIG. 1 again, the LiDAR device 1000 according to an embodiment may include a detecting unit 300.

Herein, the detecting unit may be variously expressed as a light receiving unit, a sensor unit, etc., but the present disclosure is not limited thereto.

In this case, the detecting unit 300 according to an embodiment may detect laser beams. For example, the detecting unit may detect a laser beam reflected by an object located in the scanning region.

Also, the detecting unit 300 according to an embodiment may receive a laser beam and generate an electric signal based on the received laser beam. For example, the detecting unit 300 may detect a laser beam reflected by an object located in the scanning region and generate an electric signal based on the received laser beam. Also, for example, the detecting unit 300 may receive a laser beam reflected by an object located in the scanning region through one or more optical means and generate an electric signal based on the received laser beam. Also, for example, the detecting unit 300 may receive a laser beam reflected by an object located in the scanning region through an optical filter and generate an electric signal based on the received laser beam.

Also, the detecting unit 300 according to an embodiment may detect the laser beam based on the generated electric signal. For example, the detecting unit 300 may detect the laser beam by comparing the magnitude of the generated electric signal to a predetermined threshold, but the present disclosure is not limited thereto. Also, for example, the detecting unit 300 may detect the laser beam by comparing the rising edge, falling edge, or the median of the rising edge and the falling edge of the generated electric signal to a predetermined threshold, but the present disclosure is not limited thereto. Also, for example, the detecting unit 300 may detect the laser beam by comparing the peak value of the generated electric signal to a predetermined threshold, but the present disclosure is not limited thereto.

Also, the detecting unit 300 according to an embodiment may include various detecting elements. For example, the detecting unit 300 may include a PN photodiode, a phototransistor, a PIN photodiode, an avalanche photodiode (APD), a single-photon avalanche diode (SPAD), silicon photomultipliers (SiPM), a time-to-digital converter (TDC), a comparator, a complementary metal-oxide-semiconductor (CMOS), a charge-coupled device (CCD), or the like, but the present disclosure is not limited thereto.

For example, the detecting unit 300 may be a two-dimensional (2D) SPAD array, but the present disclosure is not limited thereto. Also, for example, the SPAD array may include a plurality of SPAD units, and each SPAD unit may include a plurality of SPAD pixels.

In this case, the detecting unit 300 may generate a histogram by accumulating a plurality of data sets based on output signals of the detecting elements N times using the 2D SPAD array. For example, the detecting unit 300 may use the histogram to detect a reception time point of a laser beam that is reflected by an object and received.

For example, the detecting unit 300 may use the histogram to determine the peak time point of the histogram as the reception time point at which the laser beam reflected by the object is received, but the present disclosure is not limited thereto. Also, for example, the detecting unit 300 may use the histogram to determine a time point at which the histogram is greater than or equal to a predetermined value as the reception time point at which the laser beam reflected by the object is received, but the present disclosure is not limited thereto.

Also, the detecting unit 300 according to an embodiment may include one or more detecting elements. For example, the detecting unit 300 may include a single detecting element and may also include a plurality of detecting elements.

Also, the detecting unit 300 according to an embodiment may include one or more optical elements. For example, the detecting unit 300 may include an aperture, a microlens, a converging lens, a diffuser, or the like, but the present disclosure is not limited thereto.

Also, the detecting unit 300 according to an embodiment may include one or more optical filters. The detecting unit 300 may detect a laser beam reflected by an object through an optical filter. For example, the detecting unit 300 may include a band-pass filter, a dichroic filter, a guided-mode resonance filter, a polarizer, a wedge filter, or the like, but the present disclosure is not limited thereto.

Referring to FIG. 1 again, the LiDAR device 1000 according to an embodiment may include a processor 400.

Herein, the processor may be variously expressed as a processor or the like, but the present disclosure is not limited thereto.

In this case, the processor 400 according to an embodiment may control the operation of the laser emitting unit 100, the optic unit 200, or the detecting unit 300.

Also, the processor 400 according to an embodiment may control the operation of the laser emitting unit 100.

For example, the processor 400 may control an emission time point of a laser emitting from the laser emitting unit 100. Also, the processor 400 may control the power of the laser emitting from the laser emitting unit 100. Also, the processor 400 may control the pulse width of the laser emitting from the laser emitting unit 100. Also, the processor 400 may control the cycle of the laser emitting from the laser emitting unit 100. Also, when the laser emitting unit 100 includes a plurality of laser emitting elements, the processor 400 may control the laser emitting unit 100 to operate some of the plurality of laser emitting elements.

Also, the processor 400 according to an embodiment may control the operation of the optic unit 200.

For example, the processor 400 may control the operating speed of the optic unit 200. In detail, the optic unit 200 may control the rotational speed of a rotating mirror when including the rotating mirror and may control the repetition cycle of a MEMS mirror when including the MEMS mirror, but the present disclosure is not limited thereto.

Also, for example, the processor 400 may control the operation status of the optic unit 200. In detail, the optic unit 200 may control the operation angle of a MEMS mirror when including the MEMS mirror, but the present disclosure is not limited thereto.

Also, the processor 400 according to an embodiment may control the operation of the detecting unit 300.

For example, the processor 400 may control the sensitivity of the detecting unit 300. In detail, the processor 400 may control the sensitivity of the detecting unit 300 by adjusting a predetermined threshold, but the present disclosure is not limited thereto.

Also, for example, the processor 400 may control the operation of the detecting unit 300. In detail, the processor 400 may control the turn-on and -off of the detecting unit 300, and when including a plurality of detecting elements, the processor 400 may control the operation of the detecting unit 300 to operate some of the plurality of detecting elements.

Also, the processor 400 according to an embodiment may determine a distance from the LiDAR device 1000 to an object located in a scanning region based on a laser beam detected by the detecting unit 300.

For example, the processor 400 may determine the distance to the object located in the scanning region based on a time point at which the laser beam is emitted from the laser emitting unit 100 and a time point at which the laser beam is detected by the detecting unit 300. Also, for example, the processor 400 may determine the distance to the object located in the scanning region based on a time point at which a laser beam emitted from the laser beam is detected by the detecting unit 300 immediately without reaching the object and a time point at which a laser beam reflected by the object is sensed by the detecting unit 300.

There may be a difference between a time point at which the LiDAR device 1000 transmits a trigger signal for emitting a laser beam using a processor 400 and an actual emission time point, which is a time when the laser beam is actually emitted from a laser emitting element. Actually, no laser beam is emitted in a period between the time point of the trigger signal and the actual emission time point. Thus, when the period is included in the ToF of the laser beam, precision may be decreased.

The actual emission time point of the laser beam may be used to improve the precision of the measurement of the TOF of the laser beam. However, it may be difficult to determine the actual emission time point of the laser beam. Therefore, a laser beam should be detected to the detecting unit 300 as soon as or immediately after the laser beam is emitted from a laser emitting element without reaching an object.

For example, an optic may be disposed on an upper portion of the laser emitting element, and thus the optic may enable a laser beam emitted from the laser emitting element to be detected by the detecting unit 300 directly without reaching an object. The optic may be a mirror, a lens, a prism, a metasurface, or the like, but the present disclosure is not limited thereto. The optic may include one optic or a plurality of optics.

Also, for example, the detecting unit 300 may be disposed on an upper portion of the laser emitting element, and thus a laser beam emitted from the laser emitting element may be detected by the detecting unit 300 directly without reaching an object. The detecting unit 300 may be spaced a distance of 1 mm, 1 μm, 1 nm, or the like from the laser emitting element, but the present disclosure is not limited thereto. Alternatively, the detecting unit 300 may be adjacent to the laser emitting element with no interval therebetween. An optic may be present between the detecting unit 300 and the laser emitting element, but the present disclosure is not limited thereto.

In detail, the laser emitting unit 100 may emit a laser beam, and the processor 400 may acquire a time point at which the laser beam is emitted from the laser emitting unit 100. When the laser beam emitted from the laser emitting unit 100 is reflected by an object located in the scanning region, the detecting unit 300 may detect a laser beam reflected by the object, and the processor 400 may acquire a time point at which the laser beam is detected by the detecting unit 300 and may determine a distance to the object located in the scan region based on the emission time point and the detection time point of the laser beam.

Also, in detail, the laser beam may be emitted from the laser emitting unit 100, and the laser beam emitted from the laser emitting unit 100 may be detected by the detecting unit 300 directly without reaching the object located in the scanning region. In this case, the processor 400 may acquire a time point at which the laser beam is detected without reaching the object. When the laser beam emitted from the laser emitting unit 100 is reflected by the object located in the scanning region, the detecting unit 300 may detect the laser beam reflected by the object, and the processor 400 may acquire the time point at which the laser beam is detected by the detecting unit 300. In this case, the processor 400 may determine the distance to the object located in the scanning region based on the detection time point of the laser beam that does not reach the object and the detection time point of the laser beam that is reflected by the object.

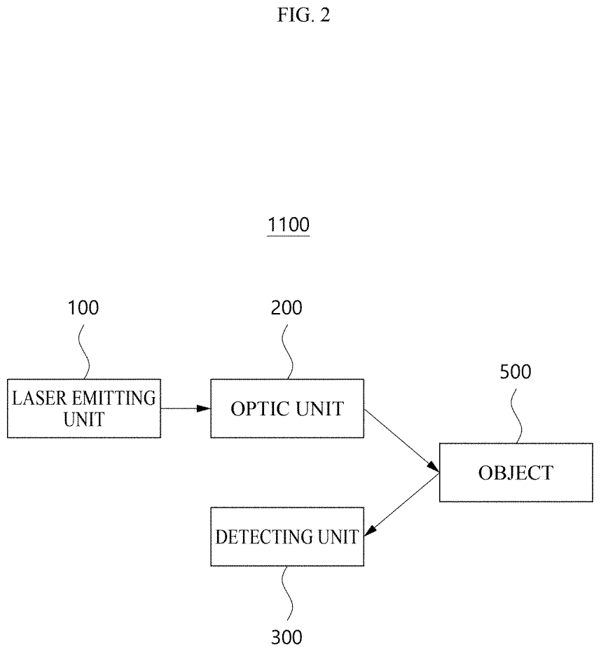

FIG. 2 is a diagram showing a LiDAR device according to an embodiment.

Referring to FIG. 2, a LiDAR device 1100 according to an embodiment may include a laser emitting unit 100, an optic unit 200, and a detecting unit 300.

The laser emitting unit 100, the optic unit 200, and the detecting unit 300 have been described with reference to FIG. 1, and thus a detailed description thereof will be omitted.

A laser beam emitted from the laser emitting unit 100 may pass through the optic unit 200. In addition, the laser beam passing through the optic unit 200 may be irradiated toward an object 500. Further, the laser beam reflected from the object 500 may be received by the detecting unit 300.

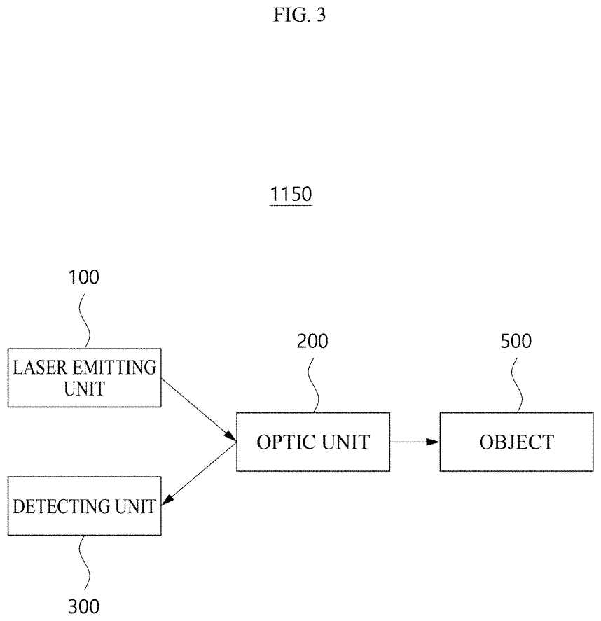

FIG. 3 is a diagram illustrating a LiDAR device according to another embodiment.

Referring to FIG. 3, a LiDAR device 1150 according to another embodiment may include a laser emitting unit 100, an optic unit 200, and a detecting unit 300.

The laser emitting unit 100, the optic unit 200, and the detecting unit 300 have been described with reference to FIG. 1, and thus detailed descriptions thereof will be omitted.

A laser beam emitted from the laser emitting unit 100 may pass through the optic unit 200. In addition, the laser beam passing through the optic unit 200 may be irradiated toward an object 500. In addition, the laser beam reflected from the object 500 may pass through the optic unit 200 again.

At this point, the optic unit, through which the laser beam before being irradiated to the object has passed, and the optic unit, through which the laser beam that is reflected from the object has passed, may be physically the same optic unit, but may be physically different optic units.

The laser beam passing through the optic unit 200 may be received by the detecting unit 300.

Hereinafter, various embodiments of a laser emitting unit including a vertical-cavity-surface-emitting laser (VCSEL) will be described in detail.

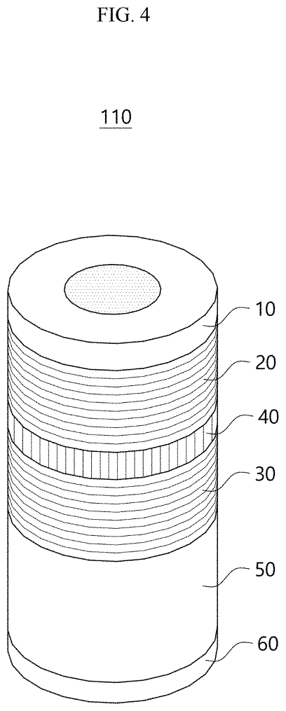

FIG. 4 is a diagram showing a laser beam output unit according to an embodiment.

Referring to FIG. 4, a laser emitting unit 100 according to an embodiment may include a VCSEL emitter 110.

The VCSEL emitter 110 according to an embodiment may include an upper metal contact 10, an upper distributed Bragg reflector (DBR) layer 20, an active layer 40 (quantum well), a lower DBR layer 30, a substrate 50, and a lower metal contact 60.

Also, the VCSEL emitter 110 according to an embodiment may emit a laser beam perpendicularly to an upper surface. For example, the VCSEL emitter 110 may emit a laser beam perpendicularly to the surface of the upper metal contact 10. Also, for example, the VCSEL emitter 110 may emit a laser beam perpendicularly to the active layer 40.

The VCSEL emitter 110 according to an embodiment may include the upper DBR layer 20 and the lower DBR layer 30.

The upper DBR layer 20 and the lower DBR layer 30 according to an embodiment may include a plurality of reflective layers. For example, the plurality of reflective layers may be arranged such that a reflective layer with high reflectance alternates with a reflective layer with low reflectance. In this case, the thickness of the plurality of reflective layers may be a quarter of the wavelength of the laser beam emitted from the VCSEL emitter 110.

Also, the upper DBR layer 20 and the lower DBR layer 30 according to an embodiment may be doped in n-type or p-type. For example, the upper DBR layer 20 may be doped in p-type, and the lower DBR layer 30 may be doped in n-type. Alternatively, for example, the upper DBR layer 20 may be doped in n-type, and the lower DBR layer 30 may be doped in p-type.

Also, according to an embodiment, the substrate 50 may be disposed between the lower DBR layer 30 and the lower metal contact 60. The substrate 50 may be a p-type substrate when the lower DBR layer 30 is doped in p-type, and the substrate 50 may be an n-type substrate when the lower DBR layer 30 is doped in n-type.

The VCSEL emitter 110 according to an embodiment may include the active layer 40.

The active layer 40 according to an embodiment may be disposed between the upper DBR layer 20 and the lower DBR layer 30.

The active layer 40 according to an embodiment may include a plurality of quantum wells that generate laser beams. The active layer 40 may emit laser beams.

The VCSEL emitter 110 according to an embodiment may include a metal contact for electrical connection to a power source or the like. For example, the VCSEL emitter 110 may include the upper metal contact 10 and the lower metal contact 60.

Also, the VCSEL emitter 110 according to an embodiment may be electrically connected to the upper DBR layer 20 and the lower DBR layer 30 through the metal contact.

For example, when the upper DBR layer 20 is doped in p-type and the lower DBR layer 30 is doped in n-type, p-type power may be supplied to the upper metal contact 10 to electrically connect the VCSEL emitter 110 to the upper DBR layer 20, and n-type power may be supplied to the lower metal contact 60 to electrically connect the VCSEL emitter 110 to the lower DBR layer 30.

Also, for example, when the upper DBR layer 20 is doped in n-type and the lower DBR layer 30 is doped in p-type, n-type power may be supplied to the upper metal contact 10 to electrically connect the VCSEL emitter 110 to the upper DBR layer 20, and p-type power may be supplied to the lower metal contact 60 to electrically connect the VCSEL emitter 110 to the lower DBR layer 30.

The VCSEL emitter 110 according to an embodiment may include an oxidation area. The oxidation area may be disposed on an upper portion of the active layer.

The oxidation area according to an embodiment may have electrical insulation. For example, an electrical flow to the oxidation area may be restricted. For example, an electrical connection to the oxidation area may be restricted.

Also, the oxidation area according to an embodiment may serve as an aperture. In detail, since the oxidation area has electrical insulation, a beam generated from the active layer 40 may be emitted to only areas other than the oxidation area.

The laser emitting unit according to an embodiment may include a plurality of VCSEL emitters 110.

Also, the laser emitting unit according to an embodiment may turn on the plurality of VCSEL emitters 110 at once or individually.

The laser emitting unit according to an embodiment may emit laser beams of various wavelengths. For example, the laser emitting unit may emit a laser beam with a wavelength of 905 nm. Also, for example, the laser emitting unit may emit a laser beam with a wavelength of 1550 nm.

Also, the wavelength of the laser beam emitted from the laser emitting unit according to an embodiment may vary depending on the surrounding environment. For example, as the temperature of the surrounding environment increases, the wavelength of the laser beam emitted from the laser emitting unit may increase. Alternatively, for example, as the temperature of the surrounding environment decreases, the wavelength of the laser beam emitted from the laser emitting unit may decrease. The surrounding environment may include temperature, humidity, pressure, dust concentration, ambient light amount, altitude, gravity, acceleration, and the like, but the present disclosure is not limited thereto.

The laser emitting unit may emit a laser beam perpendicularly to a support surface. Alternatively, the laser emitting unit may emit a laser beam perpendicularly to an emission surface.

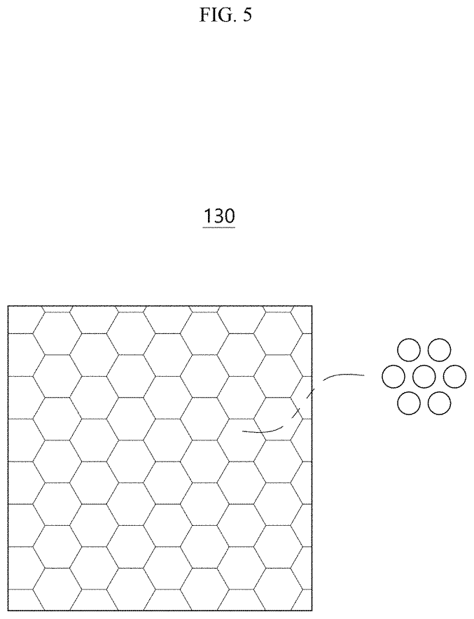

FIG. 5 is a diagram showing a VCSEL unit according to an embodiment.

Referring to FIG. 5, a laser emitting unit 100 according to an embodiment may include a VCSEL unit 130.

The VCSEL unit 130 according to an embodiment may include a plurality of VCSEL emitters 110. For example, the plurality of VCSEL emitters 110 may be arranged in a honeycomb structure, but the present disclosure is not limited thereto. In this case, one honeycomb structure may include seven VCSEL emitters 110, but the present disclosure is not limited thereto.

Also, the VCSEL emitters 110 included in the VCSEL unit 130 according to an embodiment may be oriented in the same direction. For example, 400 VCSEL emitters 110 included in one VCSEL unit 130 may be oriented in the same direction.

Also, the VCSEL unit 130 may be distinguished by the direction in which the laser beam is emitted. For example, when N VCSEL emitters 110 emit laser beams in a first direction and M VCSEL emitters 110 emit laser beams in a second direction, the N VCSEL emitters 110 may be distinguished as first VCSEL units, and the M VCSEL emitters 110 may be distinguished as second VCSEL units.

Also, the VCSEL unit 130 according to an embodiment may include a metal contact. For example, the VCSEL unit 130 may include a p-type metal and an n-type metal. Also, for example, a plurality of VCSEL emitters 110 included in the VCSEL unit 130 share the metal contact.

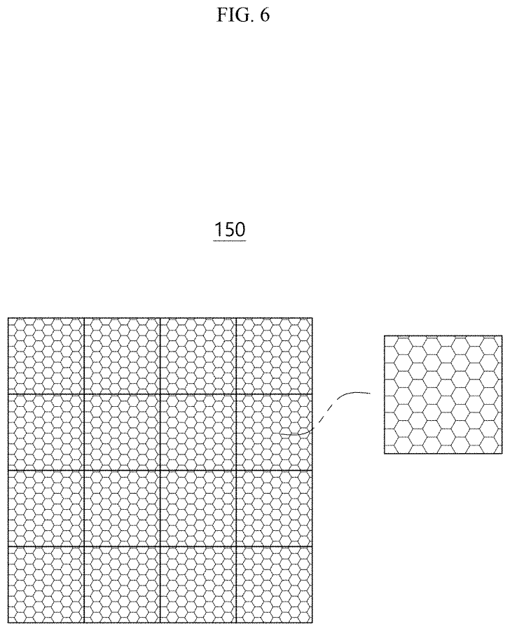

FIG. 6 is a diagram showing a VCSEL array according to an embodiment.

Referring to FIG. 6, a laser emitting unit 100 according to an embodiment may include a VCSEL array 150. FIG. 6 shows 8×8 VCSEL arrays, but the present disclosure is not limited thereto.

The VCSEL array 150 according to an embodiment may include a plurality of VCSEL units 130. For example, the plurality of VCSEL units 130 may be arranged in a matrix structure, but the present disclosure is not limited thereto.

For example, the plurality of VCSEL units 130 may be an N×N matrix, but the present disclosure is not limited thereto. Also, for example, the plurality of VCSEL units 130 may be an N×M matrix, but the present disclosure is not limited thereto.

Also, the VCSEL array 150 according to an embodiment may include a metal contact. For example, the VCSEL array 150 may include a p-type metal and an n-type metal. In this case, the plurality of VCSEL units 130 may share the metal contacts or may have respective metal contacts rather than sharing the metal contacts.

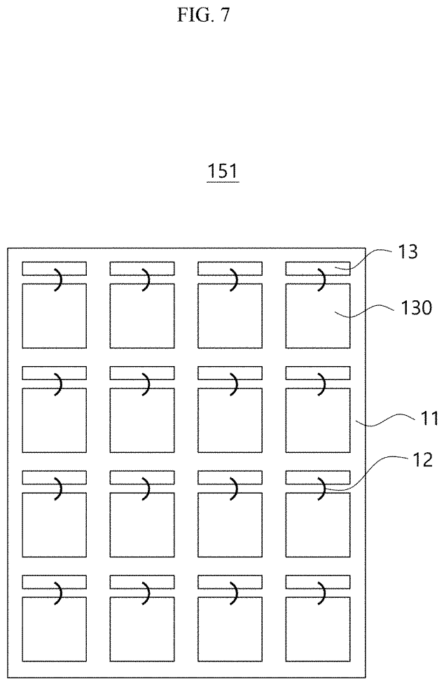

FIG. 7 is a diagram showing a VCSEL array and a metal contact according to an embodiment.

Referring to FIG. 7, a laser emitting unit 100 according to an embodiment may include a VCSEL array 151. FIG. 7 shows 4×4 VCSEL arrays, but the present disclosure is not limited thereto. The VCSEL array 151 may include a first metal contact 11, a wire 12, a second metal contact 13, and a VCSEL unit 130.

The VCSEL array 151 according to an embodiment may include a plurality of VCSEL units 130 arranged in a matrix structure. In this case, the plurality of VCSEL units 130 may be connected to the metal contacts independently. For example, the plurality of VCSEL units 130 may be connected to the first metal contact 11 together because the VCSEL units 130 share the first metal contact 11. However, the plurality of VCSEL units 130 may be connected to the second metal contact independently because the VCSEL units 130 do not share the second metal contact 13. Also, for example, the plurality of VCSEL units 130 may be connected to the first metal contact 11 directly and may be connected to the second metal contact 13 through wires 12. In this case, the number of wires 12 required may be equal to the number of VCSEL units 130. For example, when the VCSEL array 151 includes a plurality of VCSEL units 130 arranged in an N×M matrix structure, the number of wires 12 may be N*M.

Also, the first metal contact 11 and the second metal contact 13 according to an embodiment may be different from each other. For example, the first metal contact 11 may be an n-type metal, and the second metal contact 13 may be a p-type metal. On the contrary, the first metal contact 11 may be a p-type metal, and the second metal contact 13 may be an n-type metal.

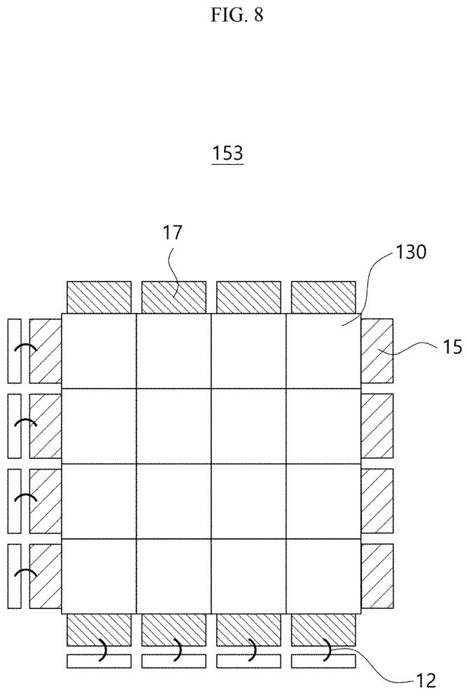

FIG. 8 is a diagram showing a VCSEL array according to an embodiment.

Referring to FIG. 8, a laser emitting unit 100 according to an embodiment may include a VCSEL array 153. FIG. 8 shows 4×4 VCSEL arrays, but the present disclosure is not limited thereto.

The VCSEL array 153 according to an embodiment may include a plurality of VCSEL units 130 arranged in a matrix structure. In this case, the plurality of VCSEL units 130 may share a metal contact or may have respective metal contacts rather than sharing a metal contact. For example, the plurality of VCSEL units 130 may share a first metal contact 15 in units of rows. Also, for example, the plurality of VCSEL units 130 may share a second metal contact 17 in units of columns.

Also, the first metal contact 15 and the second metal contact 17 according to an embodiment may be different from each other. For example, the first metal contact 15 may be an n-type metal, and the second metal contact 17 may be a p-type metal. On the contrary, the first metal contact 15 may be a p-type metal, and the second metal contact 17 may be an n-type metal.

Also, the VCSEL unit 130 according to an embodiment may be electrically connected to the first metal contact 15 and the second metal contact 17 through wires 12.

The VCSEL array 153 according to one embodiment may operate to be addressable. For example, the plurality of VCSEL units 130 included in the VCSEL array 153 may operate independently of the other VCSEL units.

For example, when power is supplied to the first metal contact 15 in a first row and the second metal contact 17 in a first column, the VCSEL unit in a first row and first column may operate. In addition, for example, when power is supplied to the first metal contact 15 in the first row and the second metal contacts 17 in the first and third columns, the VCSEL unit in the first row and first column and the VCSEL unit in the first row and third column may operate.

According to one embodiment, the VCSEL units 130 included in the VCSEL array 153 may operate with a predetermined pattern.

For example, the VCSEL units 130 may operate with a predetermined pattern, such as, after the VCSEL unit in the first row and first column operates, the VCSEL unit in a first row and second column, the VCSEL unit in the first row and third column, the VCSEL unit in a first row and fourth column, the VCSEL unit in a second row and first column, the VCSEL unit in a second row and second column, and the like operate in this order, and the VCSEL unit in a fourth row and fourth column operates at the last.

Further, for example, the VCSEL units 130 may operate with a predetermined pattern, such as, after the VCSEL unit in the first row and first column operates, the VCSEL unit in the second row and first column, the VCSEL unit in a third row and first column, the VCSEL unit in a fourth row and first column, the VCSEL unit in the first row and second column, the VCSEL unit in the second row and second column, and the like operate in this order, and the VCSEL unit in the fourth row and fourth column operates at the last.

According to another embodiment, the VCSEL units 130 included in the VCSEL array 153 may operate with an irregular pattern. Alternatively, the VCSEL units 130 included in the VCSEL array 153 may operate without having a pattern.

For example, VCSEL units 130 may operate randomly. When the VCSEL units 130 operate randomly, interference between the VCSEL units 130 may be prevented.

There may be various methods of directing a laser beam emitted from a laser emitting unit to an object. Among the methods, a flash scheme uses a laser beam spreading toward an object through the divergence of the laser beam. In order to direct a laser beam to an object located at a remote distance, the flash scheme requires a high-power laser beam. The high-power laser beam requires a high voltage to be applied, thereby increasing power. Also, the high-power laser beam may damage human eyes, and thus there is a limit to the distance that can be measured by a LiDAR device using the flash scheme.

A scanning scheme is a scheme for directing a laser beam emitted from a laser emitting unit in a specific direction. The scanning scheme can reduce laser power loss by causing a laser beam to travel in a specific direction. Since the laser power loss can be reduced, the scanning scheme may have a longer distance that can be measured by a LiDAR device than the flash scheme even when the same laser power is used. Also, since the scanning scheme has lower laser power required to measure the same distance than the flash scheme, it is possible to improve safety for human eyes.

Laser beam scanning may include collimation and steering. For example, the laser beam scanning may collimate a laser beam and then steer the collimated laser beam. Also, for example, the laser beam scanning may steer a laser beam and then collmate the steered laser beam.

Various embodiments of an optic unit including a Beam Collimation and Steering Component (BCSC) will be described in detail below.

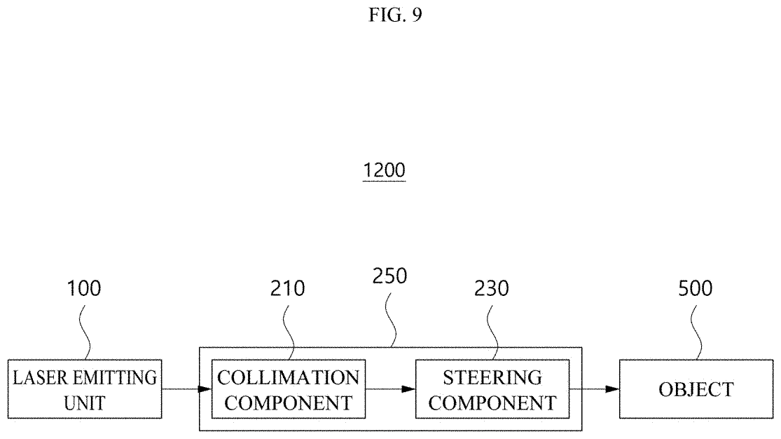

FIG. 9 is a diagram illustrating a LiDAR device according to an embodiment.

Referring to FIG. 9, a LiDAR device 1200 according to an embodiment may include a laser emitting unit 100 and an optic unit. In this case, the optic unit may include a BCSC 250. Also, the BCSC 250 may include a collimation component 210 and a steering component 230.

The BCSC 250 according to an embodiment may be configured as follows. The collimation component 210 may collimate a laser beam first, and then the collimated laser beam may be steered through the steering component 230. Alternatively, the steering component 230 may steer a laser beam first, and then the steered laser beam may be collimated through the collimation component 210.

Also, an optical path of the LiDAR device 1200 according to an embodiment is as follows. A laser beam emitted from the laser emitting unit 100 may be directed to the BCSC 250. The laser beam directed to the BCSC 250 may be collimated by the collimation component 210 and directed to the steering component 230. The laser beam directed to the steering component 230 may be steered and directed to an object. The laser beam directed to the object 500 may be reflected by the object 500 and directed to the detecting unit.

Even though laser beams emitted from the laser emitting unit have directivity, there may be some degree of divergence as the laser beams go straight. Due to the divergence, the laser beams emitted from the laser emitting unit may not be incident on the object, or even if the laser beams are incident, a very small number of laser beams may be incident.

When the degree of divergence of the laser beams is large, the amount of laser beam incident on the object decreases, and the amount of laser beam reflected by the object and directed to the detecting unit becomes very small due to the divergence. Thus, a desired measurement result may not be obtained. Alternatively, when the degree of divergence of the laser beams is large, a distance that can be measured by a LiDAR device may decrease, and thus a distant object may not be subjected to measurement.

Accordingly, by reducing the degree of divergence of a laser beam emitted from a laser emitting unit before the laser beam is incident on an object, it is possible to improve the efficiency of a LiDAR device. A collimation component of the present disclosure can reduce the degree of divergence of a laser beam. A laser beam having passed through the collimation component may become parallel light. Alternatively, a laser beam having passed through the collimation component may have a degree of divergence ranging from 0.4 degrees to 1 degree.

When the degree of divergence of a laser beam is reduced, the amount of light incident on an object may be increased. When the amount of light incident on an object is increased, the amount of light reflected by the object may be increased and thus it is possible to efficiently receive the laser beam. Also, when the amount of light incident on an object is increased, it is possible to measure an object at a great distance with the same beam power compared to before the laser beam is collimated.

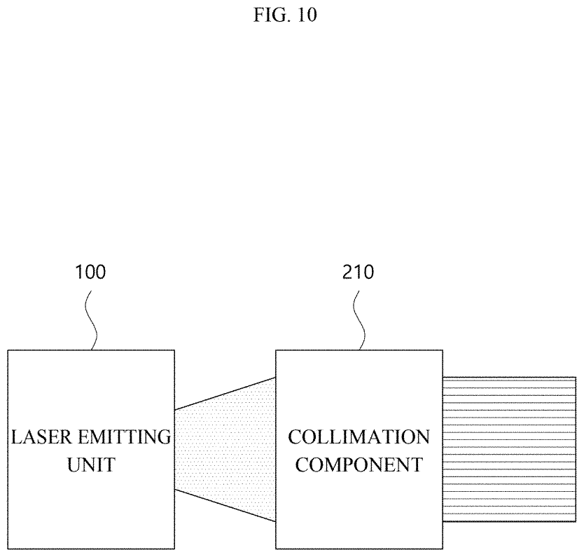

FIG. 10 is a diagram illustrating a collimation component according to an embodiment.

Referring to FIG. 10, a collimation component 210 according to an embodiment may be disposed in a direction in which a laser beam emitted from a laser emitting unit 100 emits. The collimation component 210 may adjust the degree of divergence of a laser beam. The collimation component 210 may reduce the degree of divergence of a laser beam.

For example, the angle of divergence of a laser beam emitted from the laser emitting unit 100 may range from 16 degrees to 30 degrees. In this case, after the laser beam emitted from the laser emitting unit 100 passes through the collimation component 210, the angle of divergence of the laser beam may range from 0.4 degrees to 1 degree.

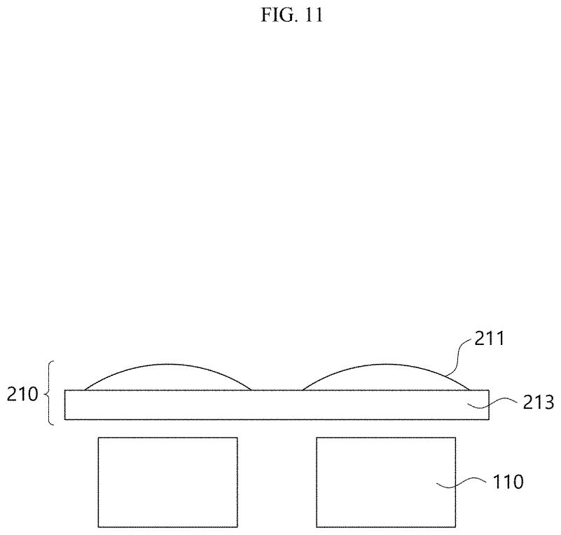

FIG. 11 is a diagram illustrating a collimation component according to an embodiment.

Referring to FIG. 11, a collimation component 210 according to an embodiment may include a plurality of microlenses 211 and a substrate 213.

The microlenses may have a diameter of millimeters (mm), micrometers (μm), nanometers (nm), picometers (pm), but the present disclosure is not limited thereto.

The plurality of microlenses 211 according to an embodiment may be disposed on the substrate 213. The plurality of microlenses 211 and the substrate 213 may be disposed above a plurality of VCSEL emitters 110. In this case, one of the plurality of microlenses 211 may correspond to one of the plurality of VCSEL emitters 110, but the present disclosure is not limited thereto.

Also, the plurality of microlenses 211 according to an embodiment may collimate a laser beams emitted from the plurality of VCSEL emitters 110. In this case, a laser beam emitted from one of the plurality of VCSEL emitters 110 may be collimated by one of the plurality of microlenses 211. For example, the angle of divergence of a laser beam emitted from one of the plurality of VCSEL emitters 110 may be decreased after the laser beam passes through one of the plurality of microlenses 211.

Also, the plurality of microlenses according to an embodiment may be a gradient index lens, a micro-curved lens, an array lens, a Fresnel lens, or the like.

Also, the plurality of microlenses according to an embodiment may be manufactured by a method such as molding, ion exchange, diffusion polymerization, sputtering, and etching.

Also, the plurality of microlenses according to an embodiment may have a diameter ranging from 130 μm to 150 μm. For example, the diameter of the plurality of lenses may be 140 μm. Also, the plurality of microlenses may have a thickness ranging from 400 μm to 600 μm. For example, the thickness of the plurality of microlenses may be 500 μm.

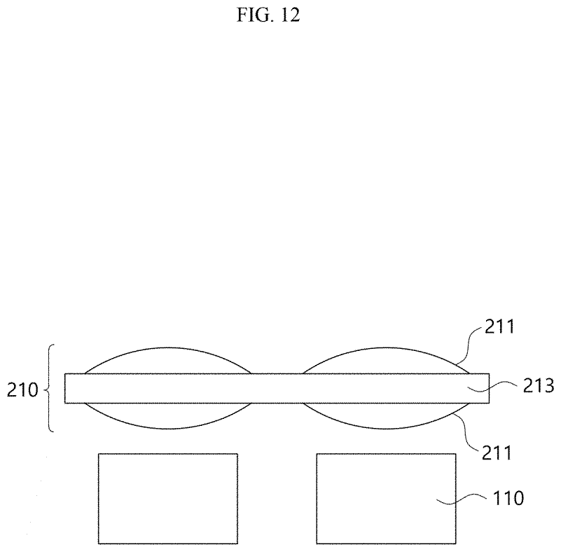

FIG. 12 is a diagram illustrating a collimation component according to an embodiment.

Referring to FIG. 12, a collimation component 210 according to an embodiment may include a plurality of microlenses 211 and a substrate 213.

The plurality of microlenses 211 according to an embodiment may be disposed on the substrate 213. For example, the plurality of microlenses 211 may be disposed on the front surface and the rear surface of the substrate 213. In this case, the optical axis of microlenses 211 disposed on the front surface of the substrate 213 may match the optical axis of microlenses 211 disposed on the rear surface of the substrate 213.

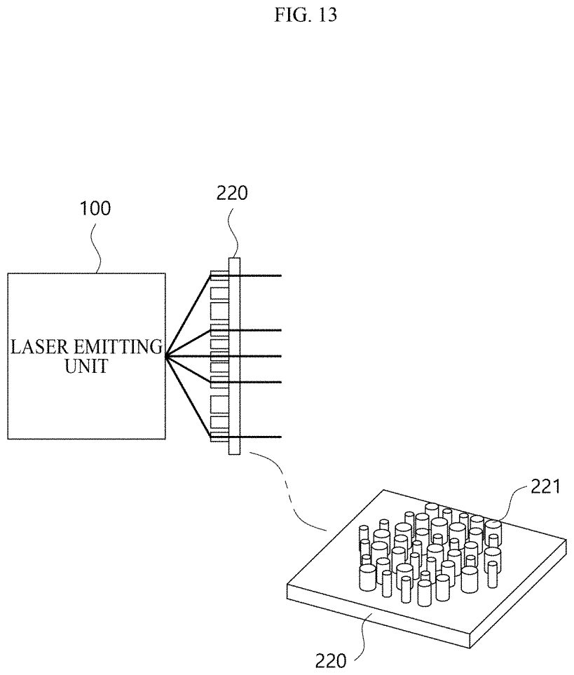

FIG. 13 is a diagram illustrating a collimation component according to an embodiment.

Referring to FIG. 13, the collimation component according to an embodiment may include a metasurface 220.

The metasurface 220 according to an embodiment may include a plurality of nanopillars 221. For example, the plurality of nanopillars 221 may be disposed on one side of the metasurface 220. Also, for example, the plurality of nanopillars 221 may be disposed on both sides of the metasurface 220.

The plurality of nanopillars 221 may have a subwavelength size. For example, a pitch between the plurality of nanopillars 221 may be less than the wavelength of a laser beam emitted from the laser emitting unit 100. Alternatively, the width, diameter, and height of the nanopillars 221 may be less than the size of the wavelength of the laser beam.

By adjusting the phase of a laser beam emitted from the laser emitting unit 100, the metasurface 220 may refract the laser beam. The metasurface 220 may refract laser beams emitted from the laser emitting unit 100 in various directions.

The metasurface 220 may collimate a laser beam emitted from the laser emitting unit 100. Also, the metasurface 220 may reduce the angle of divergence of a laser beam emitted from the laser emitting unit 100. For example, the angle of divergence of a laser beam emitted from the laser emitting unit 100 may range from 15 degrees to 30 degrees, and the angle of divergence of a laser beam having passed the metasurface 220 may range from 0.4 degrees to 1.8 degrees.

The metasurface 220 may be disposed on the laser emitting unit 100. For example, the metasurface 220 may be disposed to the side of the emission surface of the laser emitting unit 100.

Alternatively, the metasurface 220 may be deposited on the laser emitting unit 100. The plurality of nanopillars 221 may be formed on an upper portion of the laser emitting unit 100. The plurality of nanopillars 221 may form various nanopatterns on the laser emitting unit 100.

The nanopillars 221 may have various shapes. For example, the nanopillars 221 may have a cylindrical shape, a polygonal column shape, a conical shape, a polypyramid shape, or the like. Furthermore, the nanopillars 221 may have an irregular shape.

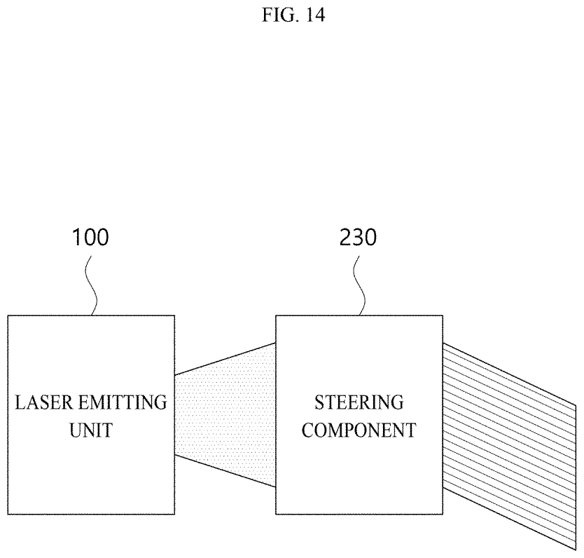

FIG. 14 is a diagram illustrating a steering component according to an embodiment.

Referring to FIG. 14, a steering component 230 according to an embodiment may be disposed in a direction in which a laser beam emitted from a laser emitting unit 100 travels. The steering component 230 may adjust the direction of a laser beam. The steering component 230 may adjust an angle between a laser beam and an optical axis of a laser light source.

For example, the steering component 230 may steer the laser beam such that the angle between the laser beam and the optical axis of the laser light source ranges from 0 degrees to 30 degrees. Alternatively, for example, the steering component 230 may steer the laser beam such that the angle between the laser beam and the optical axis of the laser light source ranges from −30 degrees to 0 degrees.

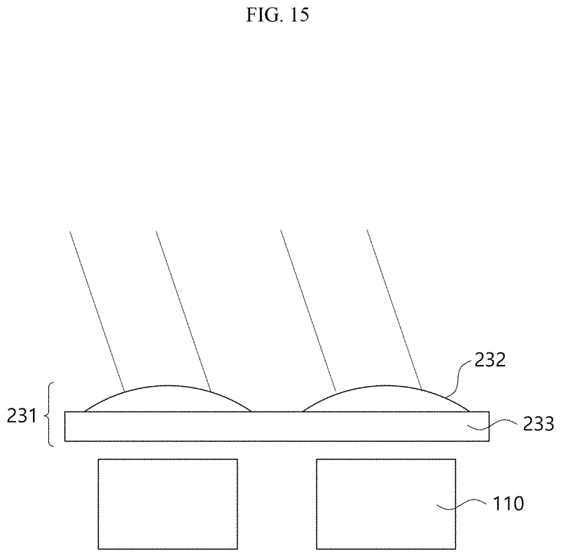

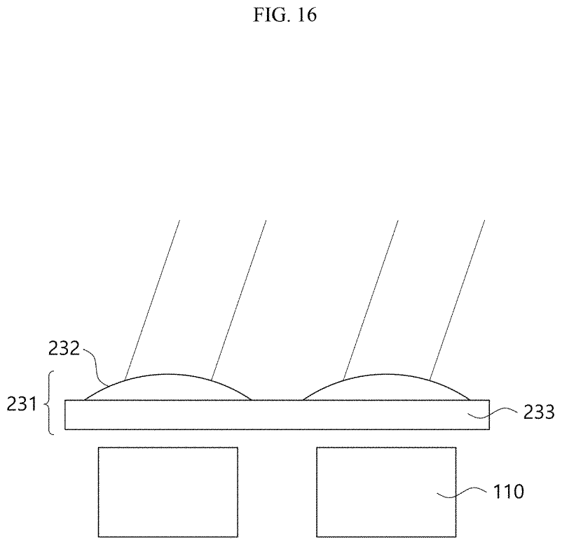

FIGS. 15 and 16 are diagrams illustrating a steering component according to an embodiment.

Referring to FIGS. 14 and 15, a steering component 231 according to an embodiment may include a plurality of microlenses 232 and a substrate 233.

The plurality of microlenses 232 according to an embodiment may be disposed on the substrate 233. The plurality of microlenses 232 and the substrate 233 may be disposed above a plurality of VCSEL emitters 110. In this case, one of the plurality of microlenses 232 may correspond to one of the plurality of VCSEL emitters 110, but the present disclosure is not limited thereto.

Also, the plurality of microlenses 232 according to an embodiment may steer laser beams emitted from the plurality of VCSEL emitters 110. In this case, a laser beam emitted from one of the plurality of VCSEL emitters 110 may be steered by one of the plurality of microlenses 232.

In this case, the optical axis of the microlens 232 may not match the optical axis of the VCSEL emitter 110. For example, referring to FIG. 14, when the optical axis of the VCSEL emitter 110 is inclined to the right with respect to the optical axis of the microlens 232, a laser beam emitted from the VCSEL emitter 110 through the microlens 232 may be directed to the left. Also, for example, referring to FIG. 15, when the optical axis of the VCSEL emitter 110 is inclined to the left with respect to the optical axis of the microlens 232, a laser beam emitted from the VCSEL emitter 110 through the microlens 232 may be directed to the right.

Also, as a distance between the optical axis of the microlens 232 and the optical axis of the VCSEL emitter 110 increases, the degree of steering of the laser beam may increase. For example, an angle between a laser beam and an optical axis of a laser light source may be larger when the distance between the optical axis of the microlens 232 and the optical axis of the VCSEL emitter 110 is 10 μm than when the distance is 1 μm.

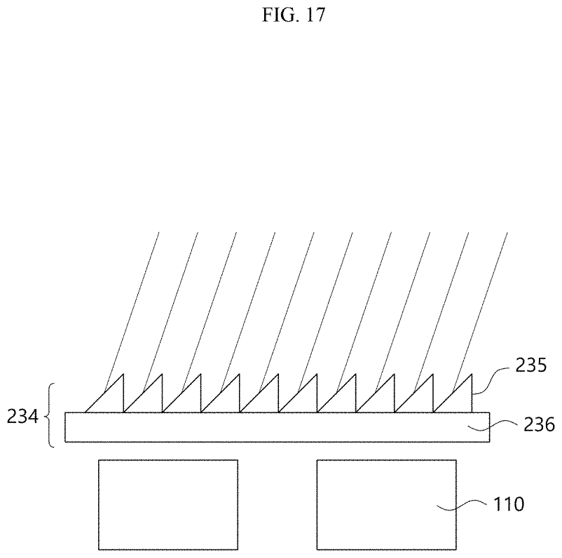

FIG. 17 is a diagram illustrating a steering component according to an embodiment.

Referring to FIG. 17, a steering component 234 according to an embodiment may include a plurality of microprisms 235 and a substrate 236.

The plurality of microprisms 235 according to an embodiment may be disposed on the substrate 236. The plurality of microprisms 235 and the substrate 236 may be disposed above a plurality of VCSEL emitters 110. In this case, one of the plurality of microprisms 235 may correspond to one of the plurality of VCSEL emitters 110, but the present disclosure is not limited thereto.

Also, the plurality of microprisms 235 according to an embodiment may steer laser beams emitted from the plurality of VCSEL emitters 110. For example, the plurality of microprisms 235 may change an angle between a laser beam and an optical axis of a laser light source.

In this case, as the angle of a microprism 235 decreases, the angle between the laser beam and the optical axis of the laser light source increases. For example, a laser beam may be steered 35 degrees when the angle of the microprism 235 is 0.05 degrees and may be steered by 15 degrees when the angle of the microprism 235 is 0.25 degrees.

Also, the plurality of microprisms 235 according to an embodiment may include a Porro prism, an Amici roof prism, a pentaprism, a Dove prism, a retroreflector prism, or the like. Also, the plurality of microprisms 235 may be formed of glass, plastic, or fluorspar. Also, the plurality of microprisms 235 may be manufactured by a method such as molding and etching.

At this point, a surface of the micro prism 235 may be polished by a polishing process so that diffused reflection due to surface roughness may be prevented.

According to one embodiment, the micro prisms 235 may be disposed on both surfaces of the substrate 236. For example, the micro prisms disposed on a first surface of the substrate 236 may steer the laser beam in a first axis, the micro prisms disposed on a second surface of the substrate 236 may steer the laser beam in a second axis.

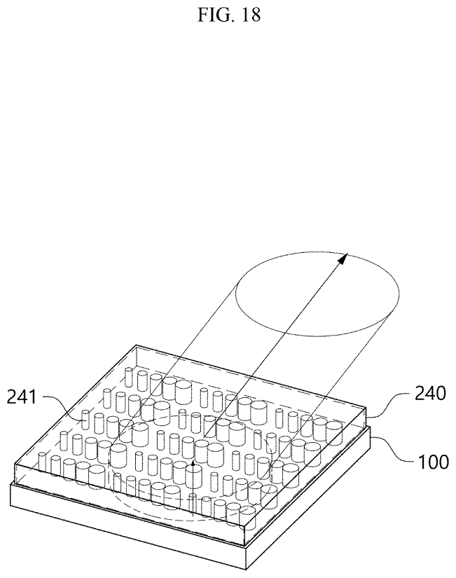

FIG. 18 is a diagram illustrating a steering component according to an embodiment.

Referring to FIG. 18, the steering component according to an embodiment may include a metasurface 240.

The metasurface 240 may include a plurality of nanopillars 241. For example, the plurality of nanopillars 241 may be disposed on one side of the metasurface 240. Also, for example, the plurality of nanopillars 241 may be disposed on both sides of the metasurface 240.

By adjusting the phase of a laser beam emitted from the laser emitting unit 100, the metasurface 240 may refract the laser beam.

The metasurface 240 may be disposed on the laser emitting unit 100. For example, the metasurface 240 may be disposed to the side of the emission surface of the laser emitting unit 100.

Alternatively, the metasurface 240 may be deposited on the laser emitting unit 100. The plurality of nanopillars 241 may be formed on an upper portion of the laser emitting unit 100. The plurality of nanopillars 241 may form various nanopatterns on the laser emitting unit 100.

The nanopillars 241 may have various shapes. For example, the nanopillars 241 may have a shape such as a circular column, a polygonal column, a circular pyramid, and a polygonal pyramid. In addition, the nanopillars 241 may have an irregular shape.

The nanopillars 241 may form various nanopatterns. The metasurface 240 may steer a laser beam emitted from the laser emitting unit 100 based on the nanopatterns.

The nanopillars 241 may form nanopatterns based on various features. The features may include the width (hereinafter referred to as W), pitch (hereinafter referred to as P), height (hereinafter referred to as H), and the number per unit length of nanopillars 241.

A nanopattern formed based on various features and a method of steering a laser beam according to the nanopattern will be described below.

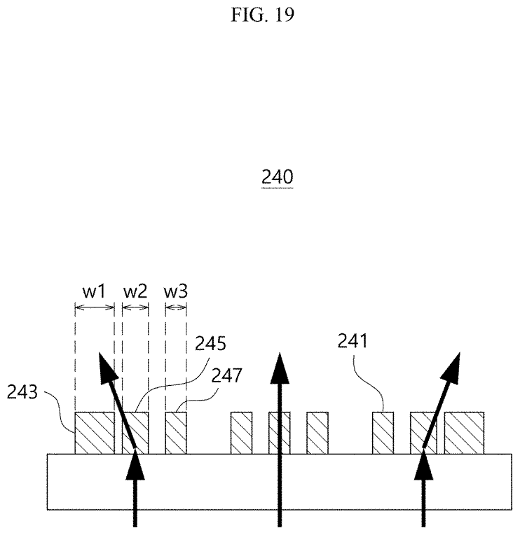

FIG. 19 is a diagram illustrating a metasurface according to an embodiment.

Referring to FIG. 19, a metasurface 240 according to an embodiment may include a plurality of nanopillars 241 with different widths W.

The plurality of nanopillars 241 may form nanopatterns based on the widths W. For example, the plurality of nanopillars 241 may be disposed to have widths increasing in one direction (W1, W2, and W3). In this case, a laser beam emitted from a laser emitting unit 100 may be steered in a direction in which the widths W of the nanopillars 241 increase. For example, the metasurface 240 may include a first nanopillar 243 with a first width W1, a second nanopillar 245 with a second width W2, and a third nanopillar 247 with a third width W3. The first width W1 may be greater than the second width W2 and the third width W3. The second width W2 may be greater than the third width W3. That is, the widths W of the nanopillars 241 may decrease from the first nanopillar 243 to the third nanopillar 247. In this case, when the laser beam emitted from the laser emitting unit 100 passes through the metasurface 240, the laser beam may be steered between a first direction in which the laser beam is emitted from the laser emitting unit 100 and a second direction which is a direction from the third nanopillar 247 to the first nanopillar 243.

Meanwhile, the steering angle θ of the laser beam may vary depending on a change rate of the widths W of the nanopillars 241. Here, the change rate of the widths W of the nanopillars 241 may refer to a numerical value indicating the average change of the widths W of the plurality of nanopillars 241.

The change rate of the widths W of the nanopillars 241 may be calculated based on the difference between the first width W1 and the second width W2 and the difference between the second width W2 and the third width W3.

The difference between the first width W1 and the second width W2 may be different from the difference between the second width W2 and the third width W3.

The steering angle θ of the laser beam may vary depending on the widths W of the nanopillars 241.

In detail, the steering angle θ may increase as the change rate of the widths W of the nanopillars 241 increases.

For example, the nanopillars 241 may form a first pattern with a first change rate on the basis of the widths W. Also, the nanopillars 241 may form a second pattern with a second change rate smaller than the first change rate on the basis of the widths W.

In this case, a first steering angle caused by the first pattern may be greater than a second steering angle caused by the second pattern.

Meanwhile, the steering angle θ may range from −90 degrees to 90 degrees.

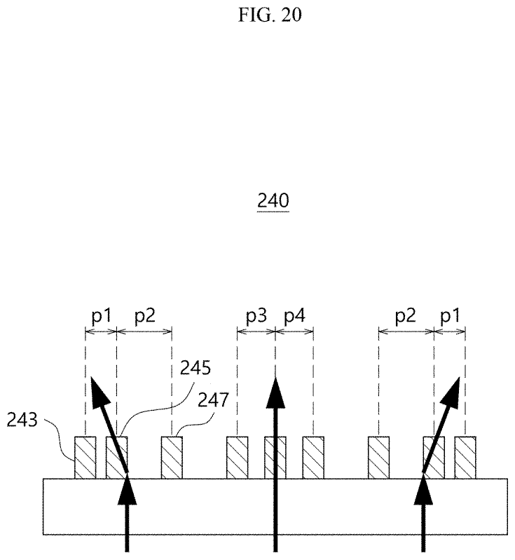

FIG. 20 is a diagram illustrating a metasurface according to an embodiment.

Referring to FIG. 20, a metasurface 240 according to an embodiment may include a plurality of nanopillars 241 with different pitches P between adjacent nanopillars 241.

The plurality of nanopillars 241 may form nanopatterns based on a change in the pitches P between the adjacent nanopillars 241. The metasurface 240 may steer a laser beam emitted from the laser emitting unit 100 based on the nanopatterns formed based on the change in the pitches P between the nanopillars 241.

According to an embodiment, the pitches P between the nanopillars 241 may decrease in one direction. Here, a pitch P may refer to a distance between the centers of two adjacent nanopillars 241. For example, a first pitch P may refer to a distance between the center of a first nanopillar 243 and the center of a second nanopillar 245. Alternatively, the first pitch P1 may be defined as the shortest distance between the first nanopillar 243 and the second nanopillar 245.

A laser beam emitted from a laser emitting unit 100 may be steered in a direction in which the pitches P between the nanopillars 241 decrease.

The metasurface 240 may include the first nanopillar 243, the second nanopillar 245, and the third nanopillar 247. In this case, the first pitch P1 may be acquired based on a distance between the first nanopillar 243 and the second nanopillar 245. Likewise, a second pitch P2 may be acquired based on a distance between the second nanopillar 245 and the third nanopillar 247. In this case, the first pitch P1 may be smaller than the second pitch P2. That is, the pitches P may increase from the first nanopillar 243 to the third nanopillar 247.

In this case, when the laser beam emitted from the laser emitting unit 100 passes through the metasurface 240, the laser beam may be steered between a first direction in which the laser beam is emitted from the laser emitting unit 100 and a second direction which is a direction from the third nanopillar 247 to the first nanopillar 243.

The steering angle θ of the laser beam may vary depending on the pitches P between the nanopillars 241.

In detail, the steering angle θ of the laser beam may vary depending on a change rate of the pitches P between the nanopillars 241. Here, the change rate of the pitches P between the nanopillars 241 may refer to a numerical value indicating the average change of the pitches P between adjacent nanopillars 241.

The steering angle θ of the laser beam may increase as the change rate of the pitches P between the nanopillars 241 increases.

For example, the nanopillars 241 may form a first pattern with a first change rate based on the pitches P. Also, the nanopillars 241 may form a second pattern with a second change rate based on the pitches P.

In this case, a first steering angle caused by the first pattern may be greater than a second steering angle caused by the second pattern.

Meanwhile, the above-described principle of steering a laser beam according to a change in the pitches P between the nanopillars 241 is similarly applicable even to a case in which the number per unit length of nanopillars 241 changes.

For example, when the number per unit length of nanopillars 241 changes, the laser beam emitted from the laser emitting unit 100 may be steered between the first direction in which the laser beam is emitted from the laser emitting unit 100 and the second direction in which the number per unit length of nanopillars 241 increases.

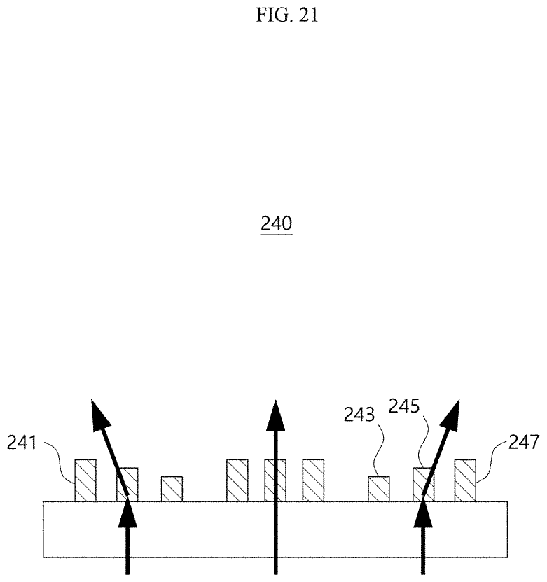

FIG. 21 is a diagram illustrating a metasurface according to an embodiment.

Referring to FIG. 21, a metasurface 240 according to an embodiment may include a plurality of nanopillars 241 with different heights H.

The plurality of nanopillars 241 may form nanopatterns on the basis of a change in the heights H of the nanopillars 241.

According to an embodiment, the heights H1, H2, and H3 of the plurality of nanopillars 241 may increase in one direction. A laser beam emitted from a laser emitting unit 100 may be steered in a direction in which the heights H of the nanopillars 241 increase.

For example, the metasurface 240 may include a first nanopillar 243 with a first height H1, a second nanopillar 245 with a second height H2, and a third nanopillar 247 with a third height H3. The third height H3 may be greater than the first height H1 and the second height H2. The second height H2 may be greater than the first height H1. That is, the heights H of the nanopillars 241 may increase from the first nanopillar 243 to the third nanopillar 247. In this case, when the laser beam emitted from the laser emitting unit 100 passes through the metasurface 240, the laser beam may be steered between the first direction in which the laser beam is emitted from the laser emitting unit 100 and the second direction which is a direction from the first nanopillar 243 to the third nanopillar 247.

The steering angle θ of the laser beam may vary depending on the heights H of the nanopillars 241.

In detail, the steering angle θ of the laser beam may vary depending on a change rate of the heights H of the nanopillars 241. Here, the change rate of the heights H of the nanopillars 241 may refer to a numerical value indicating the average change of the heights H of adjacent nanopillars 241.

The change rate of the heights H of the nanopillars 241 may be calculated based on the difference between the first height H1 and the second height H2 and the difference between the second height H2 and the third height H3. The difference between the first height H1 and the second height H2 may be different from the difference between the second height H2 and the third height H3.

The steering angle θ of the laser beam may increase as the change rate of the heights H2 of the nanopillars 241 increases.

For example, the nanopillars 241 may form a first pattern with a first change rate on the basis of the heights H. Also, the nanopillars 241 may form a second pattern with a second change rate on the basis of the heights H.

In this case, a first steering angle caused by the first pattern may be greater than a second steering angle caused by the second pattern.

According to one embodiment, the steering component 230 may include a mirror that reflects the laser beam. For example, the steering component 230 may include a planar mirror, a polygonal mirror, a resonant mirror, a MEMS mirror, and a galvano mirror.

Alternatively, the steering component 230 may include a polygonal mirror that rotates 360 degrees about one axis, and a nodding mirror that is repeatedly driven in a predetermined range about one axis.

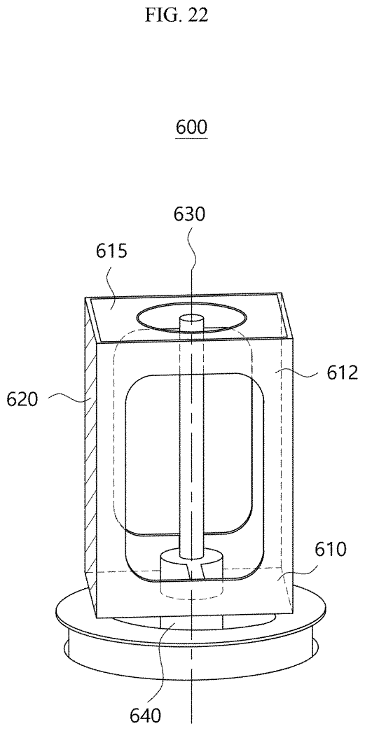

FIG. 22 is a diagram for describing a polygonal mirror that is a steering component according to one embodiment.

Referring to FIG. 22, a rotating polygonal mirror 600 according to one embodiment may include reflective surfaces 620 and a body and may rotate about a rotation axis 630 vertically passing through a center of each of an upper portion 615 and a lower portion 610 of the body. However, the rotating polygonal mirror 600 may be configured with only some of the above-described components and may include more components. For example, the rotating polygonal mirror 600 may include the reflective surfaces 620 and the body, and the body may be configured with only the lower portion 610. At this point, the reflective surfaces 620 may be supported by the lower portion 610 of the body.

The reflective surfaces 620 are surfaces for reflecting the received laser, and may each include a reflective mirror, a reflective plastic, or the like, but the present disclosure is not limited thereto.

Further, the reflective surfaces 620 may be installed on side surfaces of the body except for the upper portion 615 and the lower portion 610 and may be installed such that a normal line of each thereof is orthogonal to the rotation axis 630. This may be for repetitive scanning of the same scan region by making the scan region of the laser irradiated from each of the reflective surfaces 620 the same.

Further, the reflective surfaces 620 may be installed on the side surfaces of the body except for the upper portion 615 and the lower portion 610 and may be installed such that a normal line of each thereof has a different angle from the rotation axis 630. This may be for expanding the scan region of the LiDAR device by making the scan region of the laser irradiated from each of the reflective surfaces 620 to be different.

Further, each of the reflective surfaces 620 may be formed in a rectangular shape, but is not limited thereto, and may have various shapes such as a triangular shape, a trapezoidal shape, and the like.

Further, the body is for supporting the reflective surfaces 620, and may include the upper portion 615, the lower portion 610, and a column 612 connecting the upper portion 615 and the lower portion 610. In this case, the column 612 may be installed to connect the centers of the upper portion 615 and the lower portion 610 of the body, may be installed to connect each vertex of the upper portion 615 and the lower portion 610 of the body, or may be installed to connect each corner of the upper portion 615 and the lower portion 610 of the body, but is limited to a structure for connecting and supporting the upper portion 615 and the lower portion 610 of the body.

Further, the body may be fastened to a driving unit 640 to receive a driving force for rotating, may be fastened to the driving unit 640 through the lower portion 610 of the body, or may be fastened to the driving unit 640 through the upper portion 615 of the body.

In addition, a shape of each of the upper portion 615 and the lower portion 610 of the body may be a polygonal shape. In this case, the shapes of the upper portion 615 and the lower portion 610 of the body may be identical, but are not limited thereto, and may be different from each other.

Further, a size of each of the upper portion 615 and the lower portion 610 of the body may be the same. However, the present disclosure is not limited thereto, and the sizes of the upper portion 615 and the lower portion 610 of the body may be different from each other.

Further, the upper portion 615 and/or the lower portion 610 of the body may include an empty space through which air may pass.

In FIG. 22, the rotating polygonal mirror 600 is illustrated as being a hexahedron in a shape of a tetragonal column including four reflective surfaces 620, but the number of the reflective surfaces 620 of the rotating polygonal mirror 600 is not necessarily four, and the rotating polygonal mirror 600 is not necessarily a hexahedron in the shape of a tetragonal column.

Further, in order to detect a rotation angle of the rotating polygonal mirror 600, the LiDAR device may further include an encoder unit. In addition, the LiDAR device may control the operation of the rotating polygonal mirror 600 using the detected rotation angle. In this case, the encoder unit may be included in the rotating polygonal mirror 600 and may be disposed to be spaced apart from the rotating polygonal mirror 600.

A required field of view (FOV) of the LiDAR device may be different depending on the application. For example, in a case of a fixed LiDAR device for three-dimensional (3D) mapping, the widest viewing angle may be required in vertical and horizontal directions, and in a case of a LiDAR device disposed in a vehicle, a relatively narrow viewing angle may be required in the vertical direction while a relatively wide viewing angle is required in the horizontal direction. In addition, in a case of a LiDAR device disposed in a drone, the widest viewing angle may be required in the vertical and horizontal directions.

Further, the scan region of the LiDAR device may be determined on the basis of the number of reflective surfaces of the rotating polygonal mirror, and the viewing angle of the LiDAR device may be determined accordingly. Thus, the number of reflective surfaces of the rotating polygonal mirror may be determined on the basis of the required viewing angle of the LiDAR device.

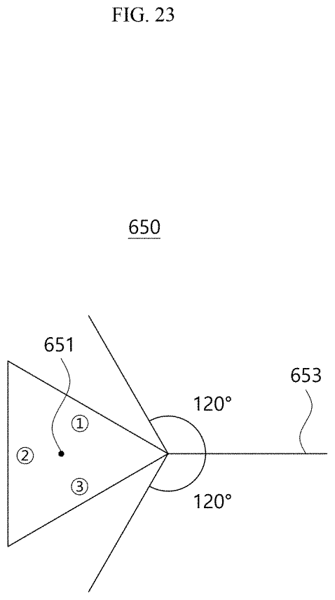

FIGS. 23 to 25 are diagrams illustrating the relationship between the number of reflective surfaces and the viewing angle.

Cases of three, four, and five reflective surfaces are respectively illustrated in FIGS. 23 to 25, but the number of reflective surfaces is not determined, and when the number of reflective surfaces is different from the above, it may be easily calculated by analogizing the following description. Further, in FIGS. 22 to 24, a case in which the upper and lower portions of the body have a regular polygonal shape is described, but even when the upper and lower portions of the body do not have the regular polygonal shape, it may be easily calculated by analogizing the following description.

FIG. 23 is a top view for describing a viewing angle of a rotating polygonal mirror 650 in which the number of reflective surfaces is three and the shape of each of the upper and lower portions of the body is an equilateral triangle shape.

Referring to FIG. 23, a laser 653 may be incident in a direction consistent with a rotation axis 651 of the rotating polygonal mirror 650. Here, since the upper portion of the rotating polygonal mirror 650 has an equilateral triangle shape, an angle formed by the three reflective surfaces may be 60 degrees. In addition, referring to FIG. 23, when the rotating polygonal mirror 650 is positioned to slightly rotate in a clockwise direction, the laser may be reflected upward in the drawing, and when the rotating polygonal mirror 650 is positioned to slightly rotate in a counterclockwise direction, the laser is reflected downward in the drawing. Thus, when a path of the reflected laser is calculated with reference to FIG. 23, the maximum viewing angle of the rotating polygonal mirror may be obtained.

For example, when the laser is reflected through a first reflective surface of the rotating polygonal mirror 650, the reflected laser may be reflected upward at an angle of 120 degrees with respect to the incident laser 653. In addition, when the laser is reflected through a third reflective surface of the rotating polygonal mirror 650, the reflected laser may be reflected downward at an angle of 120 degrees with respect to the incident laser 653.

Thus, when the number of the reflective surfaces of the rotating polygonal mirror 650 is three, and the shape of each of the upper and lower portions of the body is an equilateral triangle shape, the maximum viewing angle of the rotating polygonal mirror may be 240 degrees.

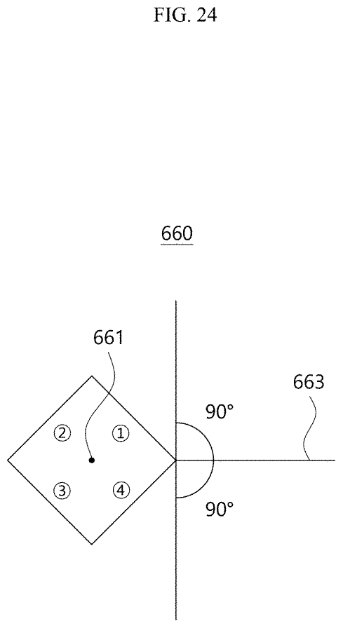

FIG. 24 is a top view for describing a viewing angle of a rotating polygonal mirror 660 in which the number of reflective surfaces is four and the shape of each of the upper and lower portions of the body is a square shape.

Referring to FIG. 24, a laser 663 may be incident in a direction consistent with a rotation axis 661 of the rotating polygonal mirror 660. Here, since the upper portion of the rotating polygonal mirror 660 has a square shape, an angle formed by the four reflective surfaces may each be 90 degrees. In addition, referring to FIG. 24, when the rotating polygonal mirror 660 is positioned to slightly rotate in a clockwise direction, the laser may be reflected upward in the drawing, and, when the rotating polygonal mirror 660 is positioned to slightly rotate in a counterclockwise direction, the laser is reflected downward in the drawing. Thus, when a path of the reflected laser is calculated with reference to FIG. 24, the maximum viewing angle of the rotating polygonal mirror 660 may be obtained.

For example, when the laser is reflected through a first reflective surface of the rotating polygonal mirror 660, the reflected laser may be reflected upward at an angle of 90 degrees with respect to the incident laser 663. In addition, when the laser is reflected through a fourth reflective surface of the rotating polygonal mirror 660, the reflected laser may be reflected downward at an angle of 90 degrees with respect to the incident laser 663.

Thus, when the number of the reflective surfaces of the rotating polygonal mirror 660 is four, and the shape of each of the upper and lower portions of the body is a square shape, the maximum viewing angle of the rotating polygonal mirror 660 may be 180 degrees.

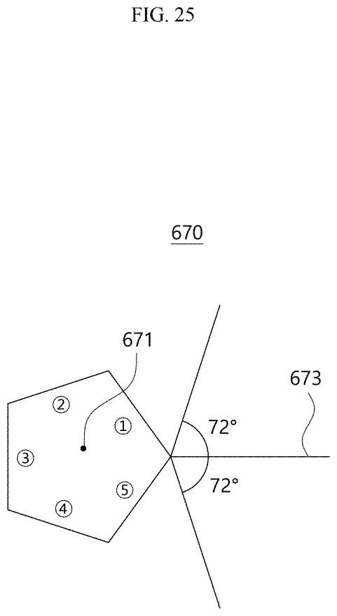

FIG. 25 is a top view for describing a viewing angle of a rotating polygonal mirror 670 in which the number of reflective surfaces is five and the shape of each of the upper and lower portions of the body is a regular pentagonal shape.

Referring to FIG. 25, a laser 673 may be incident in a direction consistent with a rotation axis 671 of the rotating polygonal mirror 670. Here, since the upper portion of the rotating polygonal mirror 670 has a regular pentagonal shape, an angle formed by the five reflective surfaces may each be 108 degrees. In addition, referring to FIG. 25, when the rotating polygonal mirror 670 is positioned to slightly rotate in a clockwise direction, the laser may be reflected upward in the drawing, and, when the rotating polygonal mirror 670 is positioned to slightly rotate in a counterclockwise direction, the laser is reflected downward in the drawing. Thus, when a path of the reflected laser is calculated with reference to FIG. 25, the maximum viewing angle of the rotating polygonal mirror may be obtained.

For example, when the laser is reflected through a first reflective surface of the rotating polygonal mirror 670, the reflected laser may be reflected upward at an angle of 72 degrees with respect to the incident laser 673. In addition, when the laser is reflected through a fifth reflective surface of the rotating polygonal mirror 670, the reflected laser may be reflected downward at an angle of 72 degrees with respect to the incident laser 673.

Thus, when the number of the reflective surfaces of the rotating polygonal mirror 670 is five, and the shape of each of the upper and lower portions of the body is a regular pentagonal shape, the maximum viewing angle of the rotating polygonal mirror may be 144 degrees.

As a result, referring to FIGS. 23 to 25 described above, in a case in which the number of reflective surfaces of the rotating polygonal mirror is N, and each of the upper and lower portions of the body has an N-polygon, when an inner angle of the N-polygon is referred to as a theta, the maximum viewing angle of the rotating polygonal mirror may be 360 degrees-2theta.

However, the above-described viewing angle of the rotating polygonal mirror is only the calculated maximum value, and thus, a viewing angle determined by the rotating polygonal mirror in the LiDAR device may be less than the calculated maximum value. Further, in this case, the LiDAR device may use only a portion of each of the reflective surfaces of the rotating polygonal mirror for scanning.

When a scanning unit of the LiDAR device includes a rotating polygonal mirror, the rotating polygonal mirror may be used to irradiate a laser emitted from a laser emitting unit toward a scan region of the LiDAR device, and may also be used for a detecting unit to receive the laser reflected from an object existing on the scan region.

Here, a portion of each of the reflective surfaces of the rotating polygonal mirror, which is used to irradiate the emitted laser to the scan region of the LiDAR device, will be referred to as an irradiated portion. In addition, a portion of each of the reflective surfaces of the rotating polygonal mirror, which is used for the detecting unit to receive the laser reflected from the object existing on the scan region, will be referred to as a light-receiving portion.

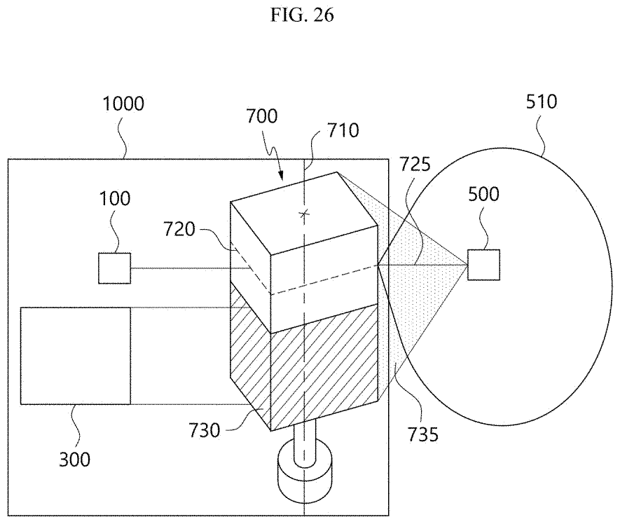

FIG. 26 is a diagram for describing an irradiated portion and a light-receiving portion of a rotating polygonal mirror according to one embodiment.

Referring to FIG. 26, a laser emitted from the laser emitting unit 100 may have a point-shaped irradiation region and may be incident on each of reflective surfaces of a rotating polygonal mirror 700. However, although not illustrated in FIG. 26, the laser emitted from the laser emitting unit 100 may have a line- or planar-shaped irradiation region.

When the laser emitted from the laser emitting unit 100 has a point-shaped irradiation region, in the rotating polygonal mirror 700, an irradiated portion 720 may have a linear shape formed by connecting a point, at which the emitted laser meets the rotating polygonal mirror, in a rotational direction of the rotating polygonal mirror. Thus, in this case, the irradiated portion 720 of the rotating polygonal mirror 700 may be positioned on each of the reflective surfaces in a linear shape in a direction perpendicular to a rotation axis 710 of the rotating polygonal mirror 700.

Further, a laser 725, which is irradiated from the irradiated portion 720 of the rotating polygonal mirror 700 and irradiated to a scan region 510 of the LiDAR device 1000, may be reflected from an object 500 existing on a scan region 510, and a laser 735 reflected from the object 500 may be reflected in a larger range than an irradiated laser 725. Thus, the laser 735 reflected from the object 500 may be parallel to the irradiated laser 725 and may be received by the LiDAR device 1000 in a wider range.

At this point, the laser 735 reflected from the object 500 may be transmitted in a larger size than the reflective surface of the rotating polygonal mirror 700. Meanwhile, a light-receiving portion 730 of the rotating polygonal mirror 700 is a portion that used for the detecting unit 300 to receive the laser 735 reflected from the object 500 and may be a portion of the reflective surface that is less in size than the reflective surface of the rotating polygonal mirror 700.

For example, as illustrated in FIG. 26, when the laser 735 reflected from the object 500 is transmitted toward the detecting unit 300 through the rotating polygonal mirror 700, a portion of the reflective surface of the rotating polygonal mirror 700, which reflects the reflected laser 735 so as to be transmitted toward the detecting unit 300, may be the light-receiving portion 730. Thus, the light-receiving portion 730 of the rotating polygonal mirror 700 may be a portion formed by extending the portion of the reflective surface, which reflects the laser 735 so as to be transmitted toward the detecting unit 300, in a rotational direction of the rotating polygonal mirror 700.

Further, when a light condensing lens is further included between the rotating polygonal mirror 700 and the detecting unit 300, the light-receiving portion 730 of the rotating polygonal mirror 700 may be a portion formed by extending the portion of the reflective surface, which reflects the laser 735 so as to be transmitted toward the light condensing lens, in the rotational direction of the rotating polygonal mirror 700.

Although it is illustrated in FIG. 26 that the irradiated portion 720 and the light-receiving portion 730 of the rotating polygonal mirror 700 are spaced apart from each other, the irradiated portion 720 and the light-receiving portion 730 of the rotating polygonal mirror 700 may partially overlap each other, and the irradiated portion 720 may be included in the light-receiving portion 730.

Further, according to one embodiment, the steering component 230 may include an optical phased array (OPA) or the like in order to change a phase of an emitted laser, and change an irradiation direction accordingly, but the present disclosure is not limited thereto.

A LiDAR device according to an embodiment may include an optic unit configured to direct a laser beam emitted from a laser emitting unit to an object.

The optic unit may include a beam collimation and steering component (BCSC) configured to collimate and steer a laser beam emitted from a laser beam output unit. The BCSC may include one component or a plurality of components.

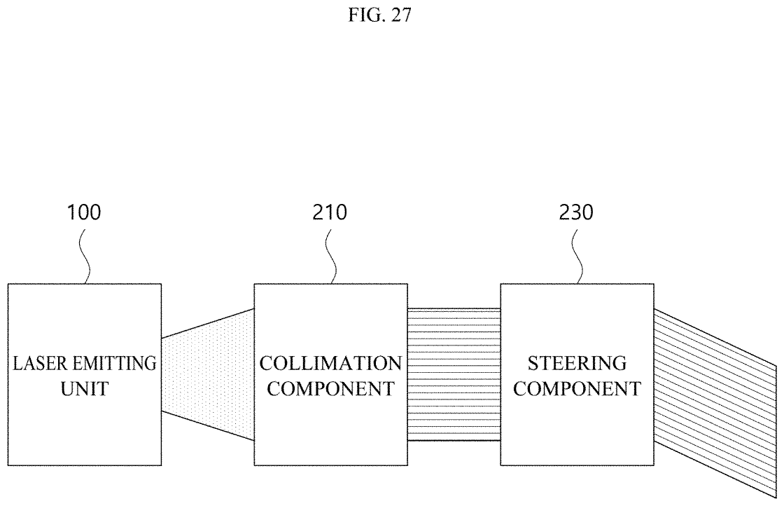

FIG. 27 is a diagram illustrating an optic unit according to an embodiment.

Referring to FIG. 27, the optic unit according to an embodiment may include a plurality of components. For example, the optic unit may include a collimation component 210 and a steering component 230.

According to an embodiment, the collimation component 210 may serve to collimate a beam emitted from a laser emitting unit 100, and the steering component 230 may serve to steer a collimated beam emitted from the collimation component 210. As a result, the laser beam emitted from the optic unit may travel in a predetermined direction.

The collimation component 210 may be a microlens or a metasurface.

When the collimation component 210 is a microlens, a microlens array may be disposed on one side of a substrate or on both sides of a substrate.

When the collimation component 210 is a metasurface, a laser beam may be collimated by a nanopattern formed by a plurality of nanopillars included in the metasurface.

The steering component 230 may be a microlens, a microprism, or a metasurface.

When the steering component 230 is a microlens, a microlens array may be disposed on one side of a substrate or on both sides of a substrate.

When the steering component 230 is a microprism, a laser beam may be steered by the angle of the microprism.

When the steering component 230 is a metasurface, a laser beam may be steered by a nanopattern formed by a plurality of nanopillars included in the metasurface.

According to one embodiment, when the optic unit includes a plurality of components, it may be necessary to correctly arrange the plurality of components. At this point, the collimation component and the steering component may be properly disposed using an alignment mark. Further, a printed circuit board (PCB), the VCSEL array, the collimation component, and the steering component may be correctly disposed using the alignment mark.

For example, the VCSEL array and the collimation component may be correctly disposed by inserting the alignment mark into an edge portion of the VCSEL array or between the VCSEL units included in the VCSEL array.

Further, for example, the collimation component and the steering component may be correctly disposed by inserting the alignment mark into an edge portion of the collimation component or between the collimation component and the steering component.

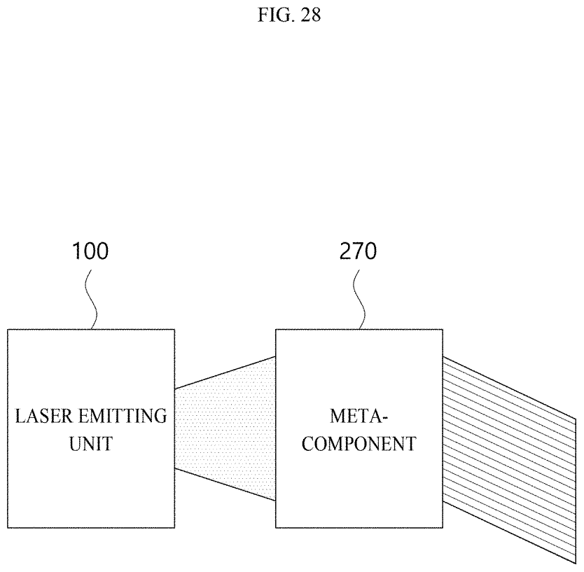

FIG. 28 is a diagram illustrating an optic unit according to an embodiment.

Referring to FIG. 28, the optic unit according to an embodiment may include one single component. For example, the optic unit may include a meta-component 270.

According to an embodiment, the meta-component 270 may collimate or steer a laser beam emitted from a laser emitting unit 100.

For example, the meta-component 270 may include a plurality of metasurfaces. One metasurface may collimate a laser beam emitted from the laser emitting unit 100, and another metasurface may steer a collimated laser beam. This will be described in detail below with reference to FIG. 23.

Alternatively, for example, the meta-component 270 may include one metasurface, which may collimate and steer a laser beam emitted from the laser emitting unit 100. This will be described in detail below with reference to FIG. 24.

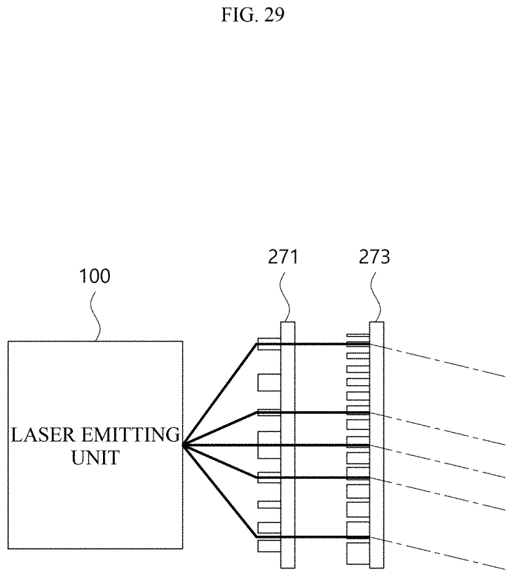

FIG. 29 is a diagram illustrating a meta-component according to an embodiment.

Referring to FIG. 29, a meta-component 270 according to an embodiment may include a plurality of metasurfaces 271 and 273. For example, the meta-component 270 may include a first metasurface 271 and a second metasurface 273.

The first metasurface 271 may be disposed in a direction in which a laser beam is emitted from a laser emitting unit 100. The first metasurface 271 may include a plurality of nanopillars. The first metasurface 271 may form a nanopattern using the plurality of nanopillars. The first metasurface 271 may utilize the formed nanopattern to collimate a laser beam emitted from the laser emitting unit 100.

The second metasurface 273 may be disposed in a direction in which a laser beam is emitted from the first metasurface 271. The second metasurface 273 may include a plurality of nanopillars. The second metasurface 273 may form a nanopattern using the plurality of nanopillars. The second metasurface 273 may steer a laser beam emitted from the laser emitting unit 100 according to the formed nanopattern. For example, as shown in FIG. 23, the second metasurface 273 may steer the laser beam in a specific direction according to a change rate of the widths W of the plurality of nanopillars. Also, the second metasurface 273 may steer the laser beam in a specific direction according to the pitches P, the heights H, and the number per unit length of nanopillars.

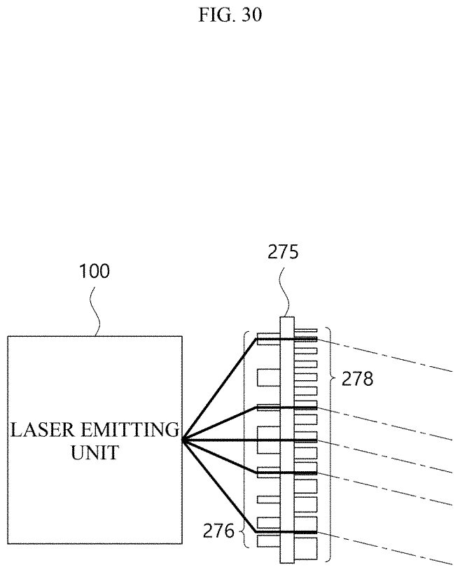

FIG. 30 is a diagram illustrating a meta-component according to another embodiment.

Referring to FIG. 30, a meta-component 270 according to an embodiment may include one metasurface 274.

The metasurface 275 may include a plurality of nanopillars on both sides. For example, the metasurface 275 may include a first nanopillar set 276 on a first side and a second nanopillar set 278 on a second side.

The metasurface 275 may collimate a laser beam emitted from a laser emitting unit 100 and then steer the collimated laser beam using a plurality of nanopillars forming a nanopattern on each of the sides.

For example, the first nanopillar set 276 disposed on one side of the metasurface 275 may form a nanopattern. A laser beam emitted from the laser emitting unit 100 may be collimated by the nanopattern formed by the first nanopillar set 276. The second nanopillar set 278 disposed on the other side of the metasurface 275 may form a nanopattern. A laser beam having passed through the first nanopillar set 276 may be steered in a specific direction by the nanopattern formed by the second nanopillar set 278.

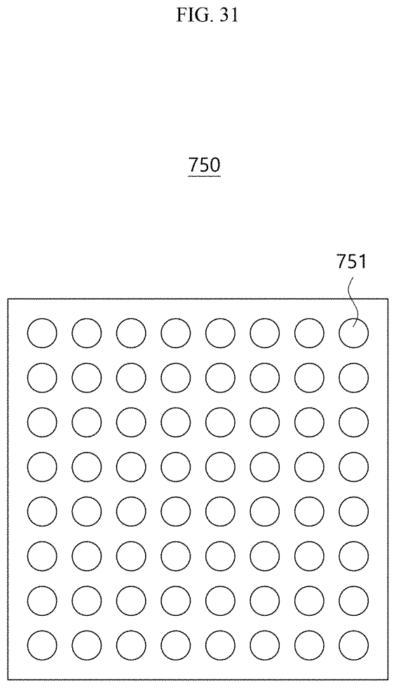

FIG. 31 is a diagram for describing a SPAD array according to one embodiment.

Referring to FIG. 31, the detecting unit 300 according to one embodiment may include a SPAD array 750. FIG. 31 illustrates a SPAD array in an 8×8 matrix, but the present disclosure is not limited thereto, and the SPAD array in a 10×10 matrix, a 12×12 matrix, a 24×24 matrix, a 64×64 matrix, and the like may be used.

The SPAD array 750 according to one embodiment may include a plurality of SPADs 751. For example, the plurality of SPADs 751 may be disposed in a matrix structure, but is not limited thereto, and may be disposed in a circular structure, an elliptical structure, a honeycomb structure, or the like.

When a laser beam is incident on the SPAD array 750, photons may be detected due to an avalanche phenomenon. According to one embodiment, results from the SPAD array 750 may be accumulated in the form of a histogram.

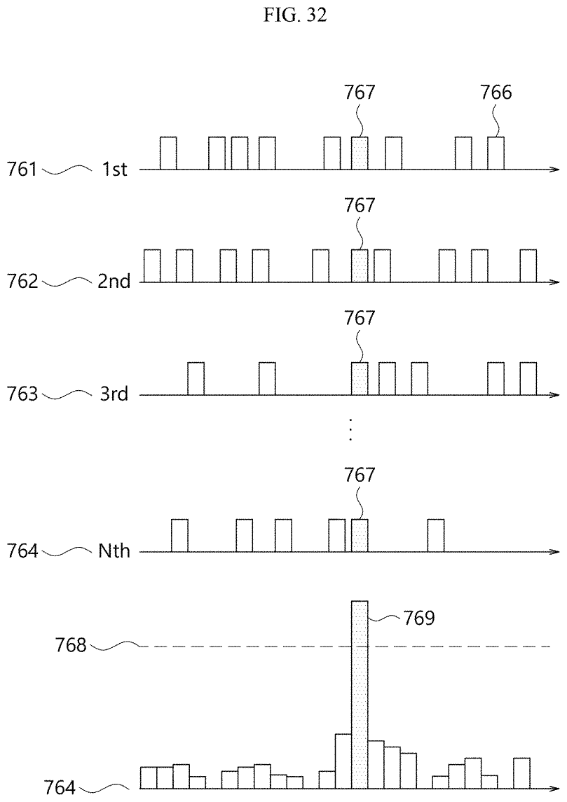

FIG. 32 is a diagram for describing a histogram for a SPAD according to one embodiment.

Referring to FIG. 32, the SPAD 751 according to one embodiment may detect photons. When the SPAD 751 detects photons, signals 766 and 767 may be generated.

A recovery time may be required for the SPAD 751 to return to a state capable of detecting photons again after detecting photons. When the SPAD 751 detects photons and the recovery time has not elapsed, even when photons are incident on the SPAD 751 at this time, the SPAD 751 is unable to detect the photons. Accordingly, a resolution of the SPAD 751 may be determined by the recovery time.

According to one embodiment, the SPAD 751 may detect photons for a predetermined period of time after a laser beam is emitted from a laser emitting unit. At this point, the SPAD 751 may detect photons for a cycle of predetermined time. For example, the SPAD 751 may detect photons several times according to a time resolution of the SPAD 751 during the cycle. At this point, the time resolution of the SPAD 751 may be determined by the recovery time of the SPAD 751.

According to one embodiment, the SPAD 751 may detect photons reflected from an object and other photons. For example, the SPAD 751 may generate the signal 767 when detecting the photons reflected from the object.

Further, for example, the SPAD 751 may generate the signal 766 when detecting photons other than the photons reflected from the object. In this case, the photons other than the photons reflected from the object may be sunlight, a laser beam reflected from a window, and the like.

According to one embodiment, the SPAD 751 may detect photons for a cycle of predetermined time after the laser beam is emitted from the laser emitting unit.

For example, the SPAD 751 may detect photons for a first cycle after a first laser beam is emitted from the laser emitting unit. At this point, the SPAD 751 may generate a first detection signal 761 after detecting the photons.

Further, for example, the SPAD 751 may detect photons for a second cycle after a second laser beam is emitted from the laser emitting unit. At this point, the SPAD 751 may generate a second detection signal 762 after detecting the photons.

Further, for example, the SPAD 751 may detect photons for a third cycle after a third laser beam is emitted from the laser emitting unit. At this point, the SPAD 751 may generate a third detection signal 763 after detecting the photons.

Further, for example, the SPAD 751 may detect photons for an Nth cycle after an Nth laser beam is emitted from the laser emitting unit. At this point, the SPAD 751 may generate an Nth detection signal 764 after detecting the photons.

Here, each of the first detection signal 761, the second detection signal 762, the third detection signal 763, . . . , and the Nth detection signal 764 may include the signal 767 generated by detecting photons reflected from the object or the signal 766 generated by detecting photons other than the photon reflected by the object.

In this case, the Nth detection signal 764 may be a photon detection signal generated for the Nth cycle after the Nth laser beam is emitted. For example, N may be 5, 10, 20, 30, 40, 50, 60, 70, 80, 90, 100, 200, 300, or the like.

The signals generated by the SPAD 751 may be accumulated in the form of a histogram. The histogram may have a plurality of histogram bins. The signals generated by the SPAD 751 may be accumulated in the form of a histogram to respectively correspond to the histogram bins.

For example, the histogram may be formed by accumulating signals generated by one SPAD 751, or may be formed by accumulating signals generated by the plurality of SPADs 751.

For example, a histogram 765 may be formed by accumulating the first detection signal 761, the second detection signal 762, the third detection signal 763, . . . , and the Nth detection signal 764. In this case, the histogram 765 may include a signal generated due to photons reflected from the object or a signal generated due to the other photons.

In order to obtain distance information of the object, it is necessary to extract a signal generated due to photons reflected from the object from the histogram 765. The signal generated due to the photons reflected from the object may be greater in amount and more regular than the signal generated due to the other photons.

At this point, the signal generated due to the photons reflected from the object may be regularly present at a specific time within the cycle. On the other hand, the signal generated due to sunlight may be small in amount and irregularly present.

There is a high possibility that a signal having a large accumulation amount of the histogram at a specific time is a signal generated due to photons reflected from the object. Accordingly, of the accumulated histogram 765, a signal having a large accumulation amount may be extracted as a signal generated due to photons reflected from the object.

For example, of the histogram 765, a signal having the highest value may be simply extracted as a signal generated due to photons reflected from the object. Further, for example, of the histogram 765, a signal having a value greater than or equal to a predetermined amount 768 may be extracted as a signal generated due to photons reflected from the object.

In addition to the method described above, there may be various algorithms that may extract as a signal, which is generated due to photons reflected from the object, from the histogram 765.

The signal generated due to photons reflected from the object is extracted from the histogram 765, and then, based on a generation time of the corresponding signal, a reception time of the photons, or the like, the distance information of the object may be calculated.

For example, the signal extracted from the histogram 765 may be a signal at one scan point. At this point, one scan point may correspond to one SPAD.

For another example, the signals extracted from the plurality of histograms may be signals at one scan point. At this point, one scan point may correspond to the plurality of SPADs.

According to another embodiment, the signals extracted from the plurality of histograms may be calculated as a signal at one scan point by applying weights thereto. At this point, the weights may be determined by a distance between the SPADs.

For example, a signal at a first scan point may be calculated by applying a weight of 0.8 to a signal by a first SPAD, applying a weight of 0.6 to a signal by a second SPAD, applying a weight of 0.4 to a signal by a third SPAD, and applying a weight of 0.2 to a signal by a fourth SPAD.

When the signals extracted from the plurality of histograms are calculated as a signal at one scan point by applying weights thereto, it is possible to obtain an effect of accumulating the histogram multiple times with one accumulation of the histogram. Thus, a scan time may be reduced, and an effect of reducing the time to obtain the entire image may be derived.

According to still another embodiment, the laser emitting unit may emit a laser beam to be addressable. Alternatively, the laser emitting unit may emit a laser beam to be addressable for each VCSEL unit.

For example, the laser emitting unit may emit a laser beam from a VCSEL unit in a first row and first column one time, and then emit a laser beam from a VCSEL unit in a first row and third column one time, and then emit a laser beam from a VCSEL unit in a second row and fourth column one time. As described above, the laser emitting unit may emit a laser beam from a VCSEL unit in an Ath row and Bth column N times, and then emit a laser beam from a VCSEL unit of a Cth row and Dth column M times.

At this point, the SPAD array may receive, among the laser beam emitted from the corresponding VCSEL unit, the laser beam reflected from the object.

For example, when the VCSEL unit in the first row and first column emits the laser beam N times in a sequence of emitting the laser beam by the laser emitting unit, a SPAD unit in a first row and first column corresponding to the first row and first column may receive the laser beam reflected from the object up to N times.

Further, for example, when the reflected laser beam should be accumulated N times in the histogram of the SPAD, and there are M VCSEL units in the laser emitting unit, it is possible to operate the M VCSEL units N times at once. Alternatively, it is possible to operate M VCSEL units one by one M*N times, and it is also possible to operate M VCSEL units for every five VCSEL units M*N/5 times.

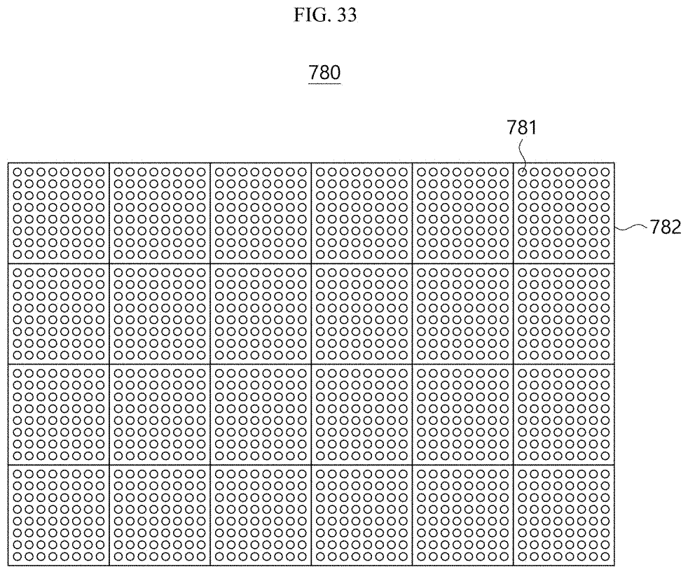

FIG. 33 is a diagram for describing a SiPM according to one embodiment.

Referring to FIG. 33, the detecting unit 300 according to one embodiment may include a SiPM 780. The SiPM 780 according to one embodiment may include a plurality of microcells 781 and a plurality of microcell units 782. For example, each of the microcells may be a SPAD. For example, each of the microcell units 782 may be a SPAD array, which is a set of a plurality of SPADs.

The SiPM 780 according to one embodiment may include the plurality of microcell units 782. In FIG. 33, the SiPM 780 is illustrated as being formed by the microcell units 782 disposed in a 4×6 matrix, but is not limited thereto, and may be formed by the microcell units 782 disposed in a 10×10, 12×12, 24×24, or 64×64 matrix. Further, although the microcell units 782 may be disposed in a matrix structure, the present disclosure is not limited thereto, and the microcell units 782 may be disposed in a circular structure, an elliptical structure, a honeycomb structure, or the like.

When a laser beam is incident on the SiPM 780, photons may be detected due to an avalanche phenomenon. According to one embodiment, results from the SiPM 780 may be accumulated in the form of a histogram.

There are several differences between the histogram by the SiPM 780 and the histogram by the SPAD 751.

As described above, the histogram by the SPAD 751 may be formed by accumulating N detection signals formed by receiving the laser beam N times by one SPAD 751. In addition, the histogram by the SPAD 751 may be formed by accumulating X*Y detection signals formed by receiving the laser beam Y times by X SPADs 751.

On the other hand, the histogram by the SiPM 780 may be formed by accumulating signals generated by one microcell units 782, or may be formed by accumulating signals generated by the plurality of microcell units 782.

According to one embodiment, one microcell unit 782 may form a histogram by detecting photons reflected from the object after a first laser beam is emitted from the laser emitting unit.

For example, the histogram by the SiPM 780 may be formed by accumulating signals generated by detecting photons, which are reflected from the object, by the plurality of microcells included in one microcell unit 782.

According to another embodiment, the plurality of microcell units 782 may form a histogram by detecting photons reflected from the object after a first laser beam is emitted from the laser emitting unit.

For example, the histogram by the SiPM 780 may be formed by accumulating signals generated by detecting photons, which are reflected from the object, by the plurality of microcells included in the plurality of microcell units 782.

In the histogram by the SPAD 751, one SPAD 751 or a plurality of SPADs 751 requires that the laser emitting unit emits the laser beam N times. However, in the histogram formed by the SiPM 780, one microcell unit 782 or the plurality of microcell units 782 require that the laser emitting unit emits the laser beam only one time.

Accordingly, the time to accumulate the histogram may take longer in the histogram by the SPAD 751 than in the histogram by the SiPM 780. The histogram by the SiPM 780 is advantageous in that the histogram may be quickly formed with only one laser beam emission.

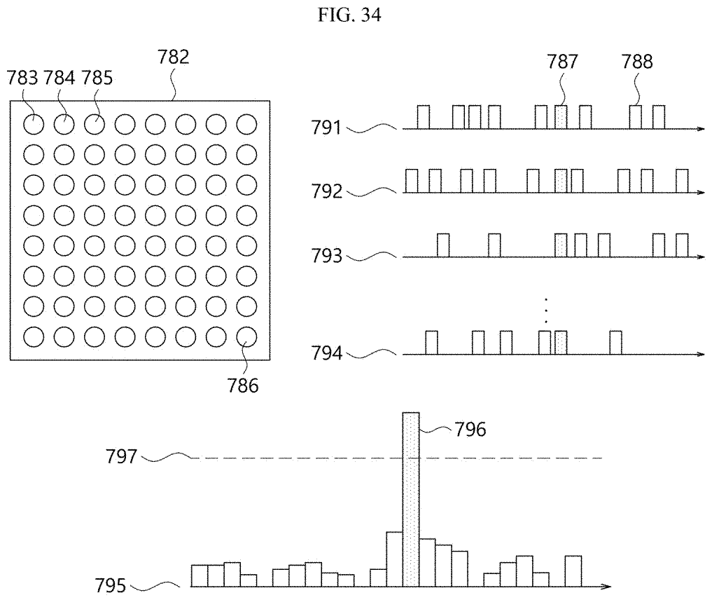

FIG. 34 is a diagram for describing a histogram of a SiPM according to one embodiment.

Referring to FIG. 34, the SiPM 780 according to one embodiment may detect photons. For example, the microcell unit 782 may detect photons. When the microcell unit 782 detects photons, signals 787 and 788 may be generated.

A recovery time may be required for the microcell unit 782 to return to a state capable of detecting photons again after detecting photons. When the microcell unit 782 detects photons and the recovery time has not elapsed, even when photons are incident on the microcell unit 782 at this time, the microcell unit 782 is unable to detect photons. Accordingly, a resolution of the microcell unit 782 may be determined by the recovery time.

According to one embodiment, the microcell unit 782 may detect photons for a predetermined period of time after the laser beam is emitted from the laser emitting unit. At this point, the microcell unit 782 may detect photons for a cycle of predetermined time. For example, the microcell unit 782 may detect photons several times according to a time resolution of the microcell unit 782 during the cycle. At this point, the time resolution of the microcell unit 782 may be determined by the recovery time of the microcell unit 782.

According to one embodiment, the microcell unit 782 may detect photons reflected from an object and other photons. For example, the microcell unit 782 may generate the signal 787 when detecting the photons reflected from the object.

Further, for example, the microcell unit 782 may generate the signal 788 when detecting photons other than the photons reflected from the object. In this case, the photons other than the photons reflected from the object may be sunlight, a laser beam reflected from a window, and the like.

According to one embodiment, the microcell unit 782 may detect photons for a cycle of predetermined time after the laser beam is emitted from the laser emitting unit.

For example, a first microcell 783 included in the microcell unit 782 may detect photons for a first cycle after a laser beam is emitted from the laser emitting unit. At this point, the first microcell 783 may generate a first detection signal 791 after detecting the photons.

Further, for example, a second microcell 784 included in the microcell unit 782 may detect photons for a first cycle after a laser beam is emitted from the laser emitting unit. At this point, the second microcell 784 may generate a second detection signal 792 after detecting the photons.

Further, for example, a third microcell 785 included in the microcell unit 782 may detect photons for a first cycle after a laser beam is emitted from the laser emitting unit. At this point, the third microcell 785 may generate a third detection signal 793 after detecting the photons.

Further, for example, an Nth microcell 786 included in the microcell unit 782 may detect photons for a first cycle after a laser beam is emitted from the laser emitting unit. At this point, the Nth microcell 786 may generate an Nth detection signal 794 after detecting the photons.

Here, each of the first detection signal 791, the second detection signal 792, the third detection signal 793, . . . , and the Nth detection signal 794 may include the signal 787 generated by detecting photons reflected from the object or the signal 788 generated by detecting photons other than the photon reflected by the object.

Here, the Nth detection signal 764 may be a photon detection signal of the Nth microcell included in the microcell unit 782. For example, N may be 5, 10, 20, 30, 40, 50, 60, 70, 80, 90, 100, 200, 300, or the like.

The signals generated by the microcells may be accumulated in the form of a histogram. The histogram may have a plurality of histogram bins. The signals generated by the microcells may be accumulated in the form of a histogram to respectively correspond to the histogram bins.

For example, the histogram may be formed by accumulating signals generated by one microcell units 782, or may be formed by accumulating signals generated by the plurality of microcell units 782.

For example, a histogram 795 may be formed by accumulating the first detection signal 791, the second detection signal 792, the third detection signal 793, . . . , and the Nth detection signal 794. In this case, the histogram 795 may include a signal generated due to photons reflected from the object or a signal generated due to the other photons.

In order to obtain distance information of the object, it is necessary to extract a signal generated due to photons reflected from the object from the histogram 795. The signal generated due to the photons reflected from the object may be greater in amount and more regular than the signal generated due to the other photons.

At this point, the signal generated due to the photons reflected from the object may be regularly present at a specific time within the cycle. On the other hand, the signal generated due to sunlight may be small in amount and irregularly present.

There is a high possibility that a signal having a large accumulation amount of the histogram at a specific time is a signal generated due to photons reflected from the object. Accordingly, of the accumulated histogram 795, a signal having a large accumulation amount may be extracted as a signal generated due to photons reflected from the object.

For example, of the histogram 795, a signal having the highest value may be simply extracted as a signal generated due to photons reflected from the object. Further, for example, of the histogram 795, a signal having a value greater than or equal to a predetermined amount 797 may be extracted as a signal generated due to photons reflected from the object.

In addition to the method described above, there may be various algorithms that may extract signals generated due to photons reflected from the object from the histogram 795.

The signal generated due to photons reflected from the object is extracted from the histogram 795, and then, based on a generation time of the corresponding signal, a reception time of the photons, or the like, the distance information of the object may be calculated.

According to still another embodiment, the laser emitting unit may emit a laser beam to be addressable. Alternatively, the laser emitting unit may emit a laser beam to be addressable for each VCSEL unit.

For example, the laser emitting unit may emit a laser beam from a VCSEL unit in a first row and first column one time, and then emit a laser beam from a VCSEL unit in a first row and third column one time, and then emit a laser beam from a VCSEL unit in a second row and fourth column one time. As described above, the laser emitting unit may emit a laser beam from a VCSEL unit in an Ath row and Bth column N times, and then emit a laser beam from a VCSEL unit of a Cth row and Dth column M times.

At this point, the SiPM may receive, among the laser beam emitted from the corresponding VCSEL unit, the laser beam reflected from the object.

For example, when the VCSEL unit in the first row and first column emits the laser beam N times in a sequence of emitting the laser beam by the laser emitting unit, a microcell unit in a first row and first column corresponding to the first row and first column of the VCSEL unit may receive the laser beam reflected from the object up to N times.

Further, for example, when the reflected laser beam should be accumulated N times in the histogram for the SiPM, and there are M VCSEL units in the laser emitting unit, it is possible to operate the M VCSEL units N times at once. Alternatively, it is possible to operate M VCSEL units one by one M*N times, and it is also possible to operate M VCSEL units for every five VCSEL units M*N/5 times.

The LiDAR may be implemented in various methods. For example, the LiDAR may be implemented using a flash method and a scanning method.

As described above, the flash method is a method using a laser beam that spreads toward an object through the divergence of the laser beam. In the flash method, since distance information of the object may be collected by illuminating a single laser pulse on an FOV, a resolution of a flash LiDAR may be determined by a detecting unit or a reception unit.

Further, as described above, the scanning method is a method of directing a laser beam emitted from a laser emitting unit in a specific direction. In the scanning method, since a laser beam is illuminated on a FOV using a scanner or a steering unit, a resolution of a scanning LiDAR may be determined by the scanner or the steering unit.

According to one embodiment, the LiDAR may be implemented in a mixed method of the flash method and the scanning method. In this case, the mixed method of the flash method and the scanning method may be a semi-flash method or a semi-scanning method. Alternatively, the mixed method of the flash method and the scanning method may be a quasi-flash method or a quasi-scanning method.

The semi-flash LiDAR or the quasi-flash LiDAR may refer to a similar-flash LiDAR rather than a full-flash LiDAR. For example, one unit of the laser emitting unit and one unit of the reception unit may operate in a flash LiDAR, but a plurality of units of the laser emitting unit and a plurality of units of the reception unit may be combined to operate as a similar-flash LiDAR rather than a full-flash LiDAR.

Further, for example, since a laser beam emitted from the laser emitting unit of either the semi-flash LiDAR or the quasi-flash LiDAR may pass through the steering unit, the semi-flash LiDAR or the quasi-flash LiDAR may be a similar-flash LiDAR rather than a full-flash LiDAR.

The semi-flash LiDAR or the quasi-flash LiDAR may overcome the disadvantage of the flash LiDAR. For example, there are problems in the flash LiDAR, such as, it is susceptible to an interference phenomenon between laser beams, a strong flash may be required to detect an object, and a detection range may not be limited.

However, since the laser beams pass through the steering unit, the semi-flash LiDAR or the quasi-flash LiDAR may overcome the interference phenomenon between the laser beams and control each laser emitting unit, so that the detection range may be controlled and the strong flash may not be required.

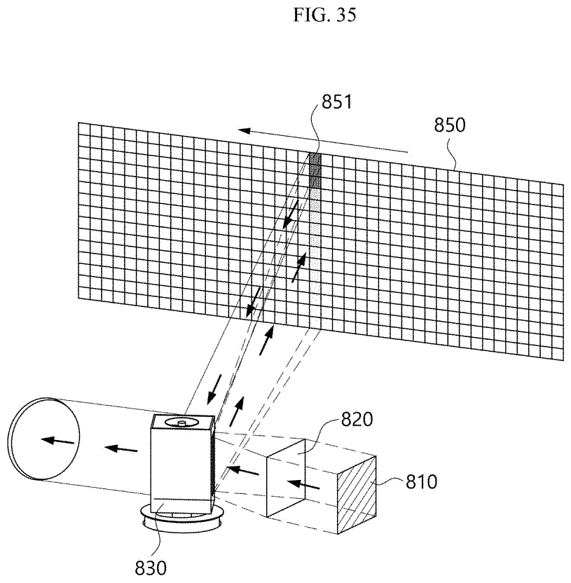

FIG. 35 is a diagram for describing a semi-flash LiDAR according to one embodiment.

Referring to FIG. 35, a semi-flash LiDAR 800 according to one embodiment may include a laser emitting unit 810, a BCSC 820, a scanning unit 830, and a reception unit 840.

The semi-flash LiDAR 800 according to one embodiment may include the laser emitting unit 810. For example, the laser emitting unit 810 may include a VCSEL array. At this point, the laser emitting unit 810 may include a VCSEL array composed of units each including a plurality of VCSEL emitters.

The semi-flash LiDAR 800 according to one embodiment may include the BCSC 820. For example, the BCSC 820 may include a collimation component 210 and a steering component 230.

According to one embodiment, a laser beam emitted from the laser emitting unit 810 is collimated by the collimation component 210 of the BCSC 820, and the collimated laser beam may be steered through the steering component 230 of the BCSC 820.

For example, a laser beam emitted from a first VCSEL unit included in the laser emitting unit 810 may be collimated by a first collimation component and may be steered in a first direction by a first steering component.

For example, a laser beam emitted from a second VCSEL unit included in the laser emitting unit 810 may be collimated by a second collimation component, and may be steered in a second direction by a second steering component.

At this point, the VCSEL units included in the laser emitting unit 810 may be steered in different directions. Accordingly, unlike the flash method using the divergence of a single pulse, the laser beam of the laser emitting unit of the semi-flash LiDAR may be steered in a specific direction by the BCSC. Thus, the laser beam emitted from the laser emitting unit of the semi-flash LiDAR may have directionality due to the BCSC.

The semi-flash LiDAR 800 according to one embodiment may include the scanning unit 830. For example, the scanning unit 830 may include an optic unit 200. For example, the scanning unit 830 may include a mirror that reflects a laser beam.

For example, the scanning unit 830 may include a planar mirror, a polygonal mirror, a resonant mirror, a MEMS mirror, and a galvano mirror. Further, for example, the scanning unit 830 may include a polygonal mirror that rotates 360 degrees about one axis, and a nodding mirror that is repeatedly driven in a predetermined range about one axis.

The semi-flash LiDAR may include a scanning unit. Thus, unlike the flash method in which the entire image is obtained at once due to the divergence of a single pulse, the semi-flash LiDAR may scan an image of an object using the scanning unit.

In addition, the object may be randomly scanned by the laser emitted from the laser emitting unit of the semi-flash LiDAR. Thus, of the entire FOV, the semi-flash LiDAR may intensively scan only a desired region of interest.

The semi-flash LiDAR 800 according to one embodiment may include the reception unit 840. For example, the reception unit 840 may include a detecting unit 300. Further, for example, the reception unit 840 may be the SPAD array 750. Also, for example, the reception unit 840 may be the SiPM 780.

The reception unit 840 may include various sensor elements. For example, the reception unit 840 may include a PN photodiode, a phototransistor, a PIN photodiode, an avalanche photodiode (APD), a single-photon avalanche diode (SPAD), silicon photomultipliers (SiPM), a time-to-digital converter (TDC), a complementary metal-oxide-semiconductor (CMOS), a charge-coupled device (CCD), or the like, but the present disclosure is not limited thereto. At this point, the reception unit 840 may cause a histogram to be accumulated. For example, the reception unit 840 may detect a time point, at which a laser beam reflected from an object 850 is received, using the histogram.

The reception unit 840 according to one embodiment may include one or more optical elements. For example, the reception unit 840 may include an aperture, a microlens, a converging lens, a diffuser, or the like, but the present disclosure is not limited thereto.

Further, the reception unit 840 according to one embodiment may include one or more optical filters. The reception unit 840 may receive a laser reflected from an object through the optical filter. For example, the reception unit 840 may include a band-pass filter, a dichroic filter, a guided-mode resonance filter, a polarizer, a wedge filter, or the like, but the present disclosure is not limited thereto.

According to one embodiment, the semi-flash LiDAR 800 may have a predetermined light path between the components.

For example, light emitted from the laser emitting unit 810 may be incident on the scanning unit 830 through the BCSC 820. Further, the light incident on the scanning unit 830 may be reflected from the scanning unit 830 and incident on the object 850. Further, the light incident on the object 850 may be reflected from the object 850 and incident on the scanning unit 830 again. Further, the light incident on the scanning unit 830 may be reflected from scanning unit 830 and received by the reception unit 840. A lens for increasing light-transmitting/receiving efficiency may be additionally inserted into the above-described light path.

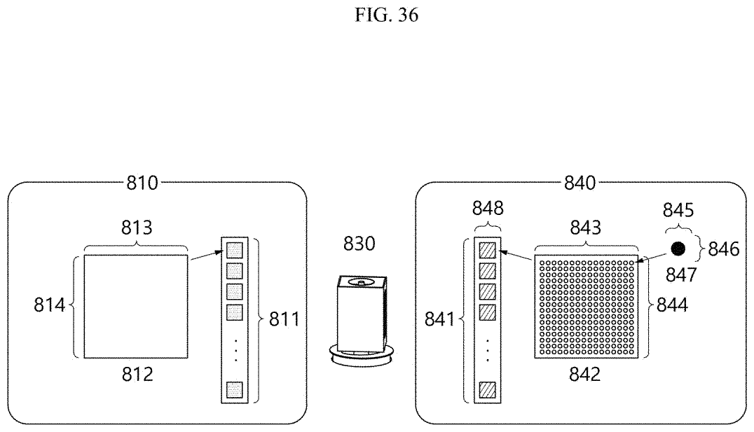

FIG. 36 is a diagram for describing a configuration of the semi-flash LiDAR according to one embodiment.

Referring to FIG. 36, the semi-flash LiDAR 800 according to one embodiment may include the laser emitting unit 810, the scanning unit 830, and the reception unit 840.

According to one embodiment, the laser emitting unit 810 may include a VCSEL array 811. Only one column of the VCSEL array 811 is shown in FIG. 36, but the present disclosure is not limited thereto, and the VCSEL array 811 may be formed in an N*M matrix structure.

According to one embodiment, the VCSEL array 811 may include a plurality of VCSEL units 812. Here, each of the VCSEL units 812 may include a plurality of VCSEL emitters. For example, the VCSEL array 811 may include 25 VCSEL units 812. In this case, the 25 VCSEL units 812 may be arranged in one column, but the present disclosure is not limited thereto.

According to one embodiment, each of the VCSEL units 812 may have a divergence angle. For example, the VCSEL unit 812 may have a horizontal divergence angle 813 and a vertical divergence angle 814. For example, the VCSEL unit 812 may have the horizontal divergence angle 813 of 1.2 degrees and the vertical divergence angle 814 of 1.2 degrees, but the present disclosure is not limited thereto.

According to one embodiment, the scanning unit 830 may receive a laser beam emitted from the laser emitting unit 810. At this point, the scanning unit 830 may reflect the laser beam toward an object. In addition, the scanning unit 830 may receive a laser beam reflected from the object. At this point, the scanning unit 830 may transmit the laser beam reflected from the object to the reception unit 840.

In this case, a region from which the laser beam is reflected toward the object and a region to which the laser beam reflected from the object is received may be the same or different. For example, the region from which the laser beam is reflected toward the object and the region to which the laser beam reflected from the object is received may be in the same reflective surface. In this case, the regions may be divided into upper and lower portions or left and right portions within the same reflective surface.

Further, for example, the region from which the laser beam is reflected toward the object and the region to which the laser beam reflected from the object is received may be different reflective surfaces. For example, the region from which the laser beam is reflected toward the object may be a first reflective surface of the scanning unit 830, and the region to which the laser beam reflected from the object is received may be a second reflective surface of the scanning unit 830.

According to one embodiment, the scanning unit 830 may reflect a 2D laser beam emitted from the laser emitting unit 810 toward the object. At this point, as the scanning unit 830 rotates or scans, the LiDAR device may three-dimensionally scan the object.

According to one embodiment, the reception unit 840 may include a SPAD array 841. Only one column of the SPAD array 841 is shown in FIG. 36, but the present disclosure is not limited thereto, and the SPAD array 841 may be formed in an N*M matrix structure.

According to one embodiment, the SPAD array 841 may include a plurality of SPAD units 842. At this point, each of the SPAD units 842 may include a plurality of SPAD pixels 847. For example, each of the SPAD units 842 may include 12×12 SPAD pixels 847. In this case, each of the SPAD pixels 847 may refer to one SPAD element, but the present disclosure is not limited thereto.

Further, for example, the SPAD array 841 may include 25 SPAD units 842. In this case, the 25 SPAD units 842 may be arranged in one column, but the present disclosure is not limited thereto. Further, in this case, the arrangement of the SPAD units 842 may correspond to the arrangement of the VCSEL units 812.

According to one embodiment, each of the SPAD units 842 may have an FOV at which light may be received. For example, the SPAD unit 842 may have a horizontal FOV 843 and a vertical FOV 844. For example, the SPAD unit 842 may have the horizontal FOV 843 of 1.2 degrees and the vertical FOV 844 of 1.2 degrees.

At this point, the FOV of the SPAD unit 842 may be proportional to the number of SPAD pixels 847 included in the SPAD unit 842. Alternatively, an FOV of the individual SPAD pixel 847 included in the SPAD unit 842 may be determined by the FOV of the SPAD unit 842.

For example, in a case in which each of a horizontal FOV 845 and a vertical FOV 846 of the individual SPAD pixel 847 is 0.1 degrees, when the SPAD unit 842 includes N*M SPAD pixels 847, the horizontal FOV 843 and the vertical FOV 844 of the SPAD unit 842 may be 0.1*N and 0.1*M, respectively.

Further, for example, in a case in which each of the horizontal FOV 843 and the vertical FOV 844 of the SPAD unit 842 is 1.2 degrees, when the SPAD unit 842 includes 12×12 SPAD pixels 847, the horizontal FOV 845 and the vertical FOV 846 of the individual SPAD pixel 847 may each be 0.1 degrees (=1.2/12).

According to another embodiment, the reception unit 840 may include a SiPM array 841. Only one column of the SiPM array 841 is shown in FIG. 36, but the present disclosure is not limited thereto, and the SiPM array 841 may be formed in an N*M matrix structure.

According to one embodiment, the SiPM array 841 may include a plurality of microcell units 842. Here, each of the microcell units 842 may include a plurality of microcells 847. For example, each of the microcell units 842 may include 12×12 microcells 847.

Further, for example, the SiPM array 841 may include 25 microcell units 842. In this case, the 25 microcell units 842 may be arranged in one column, but the present disclosure is not limited thereto. Further, in this case, the arrangement of the microcell units 842 may correspond to the arrangement of the VCSEL units 812.

According to one embodiment, each of the microcell units 842 may have an FOV at which light may be received. For example, the microcell unit 842 may have the horizontal FOV 843 and the vertical FOV 844. For example, the microcell unit 842 may have the horizontal FOV 843 of 1.2 degrees and the vertical FOV 844 of 1.2 degrees.

Here, the FOV of the microcell unit 842 may be proportional to the number of microcells included in the microcell unit 842. Alternatively, an FOV of the individual microcell 847 included in the microcell unit 842 may be determined by the FOV of the microcell unit 842.

For example, in a case in which each of the horizontal FOV 845 and the vertical FOV 846 of the individual microcell 847 is 0.1 degrees, when the microcell unit 842 includes N*M microcells 847, the horizontal FOV 843 and the vertical FOV 844 of the microcell unit 842 may be 0.1*N and 0.1*M, respectively.

Further, for example, in a case in which each of the horizontal FOV 843 and the vertical FOV 844 of the microcell unit 842 is 1.2 degrees, when the microcell unit 842 includes 12×12 microcells 847, the horizontal FOV 845 and the vertical FOV 846 of the individual microcell 847 may each be 0.1 degrees (=1.2/12).

According to another embodiment, one VCSEL unit 812 may correspond to the plurality of SPAD units or microcell units 842. For example, a laser beam emitted from the VCSEL unit 812 in a first row and first column may be reflected from the scanning unit 830 and the object 850 and received by the SPAD units or microcell units 842 in the first row and first column and a first row and second column.

According to still another embodiment, the plurality of VCSEL units 812 may correspond to one SPAD unit or microcell unit 842. For example, a laser beam emitted from the VCSEL unit 812 in the first row and first column may be reflected from the scanning unit 830 and the object 850 and received by the SPAD unit or microcell unit 842 in the first row and first column.

According to one embodiment, the VCSEL unit 812 of the laser emitting unit 810 may correspond to the SPAD unit or microcell unit 842 of the reception unit 840.

For example, the horizontal divergence angle and the vertical divergence angle of the VCSEL units 812 may be respectively identical to the horizontal FOV 845 and the vertical FOV 846 of the SPAD unit or microcell unit 842.

For example, the laser beam emitted from the VCSEL unit 812 in the first row and first column may be reflected from the scanning unit 830 and the object 850 and received by the SPAD unit or microcell unit 842 in the first row and first column.

Further, for example, a laser beam emitted from the VCSEL unit 812 in an Nth row and Mth column may be reflected from the scanning unit 830 and the object 850 and received by the SPAD unit or microcell unit 842 in the Nth row and Mth column.

At this point, the laser, which is emitted from the VCSEL unit 812 in the Nth row and Mth column and reflected from the scanning unit 830 and the object 850, may be received by the SPAD unit or microcell unit 842 in the Nth row and Mth column, and the LiDAR device 800 may have a resolution by the SPAD unit or microcell unit 842.

For example, when the SPAD unit or microcell unit 842 includes SPAD pixels or microcells 847 of N rows*M columns, the VCSEL unit 812 may recognize distance information of the object by dividing the FOV, at which light is irradiated, into N*M regions. According to another embodiment, one VCSEL unit 812 may correspond to the plurality of SPAD units or microcell units 842. For example, a laser beam emitted from the VCSEL unit 812 in a first row and first column may be reflected from the scanning unit 830 and the object 850 and received by the SPAD units or microcell units 842 in the first row and first column and a first row and second column.

According to still another embodiment, the plurality of VCSEL units 812 may correspond to one SPAD unit or microcell unit 842. For example, the laser beam emitted from the VCSEL unit 812 in the first row and first column may be reflected from the scanning unit 830 and the object 850 and received by the SPAD unit or microcell unit 842 in the first row and first column.

According to one embodiment, the plurality of VCSEL units 812 included in the laser emitting unit 810 may operate according to a predetermined sequence or may operate randomly. At this point, the SPAD unit or microcell unit 842 of the reception unit 840 may also operate corresponding to the operation of the VCSEL unit 812.

For example, in the VCSEL array 811, the VCSEL unit in a third row may operate after the VCSEL unit in a first row operates. Thereafter, the VCSEL unit in a fifth row may operate, and then the VCSEL unit in a seventh row may operate.

In this case, in the reception unit 840, the SPAD unit or microcell unit 842 in a third row may operate after the SPAD unit or microcell unit 842 in a first row operates. Thereafter, the SPAD unit or microcell unit 842 in a fifth row may operate, and then the SPAD unit or microcell unit 842 in a seventh row may operate.

Further, for example, the VCSEL units of the VCSEL array 811 may operate randomly. At this point, the SPAD unit or microcell unit 842 of the reception unit, which is present at a position corresponding to the position of the randomly operating VCSEL unit 812, may operate.

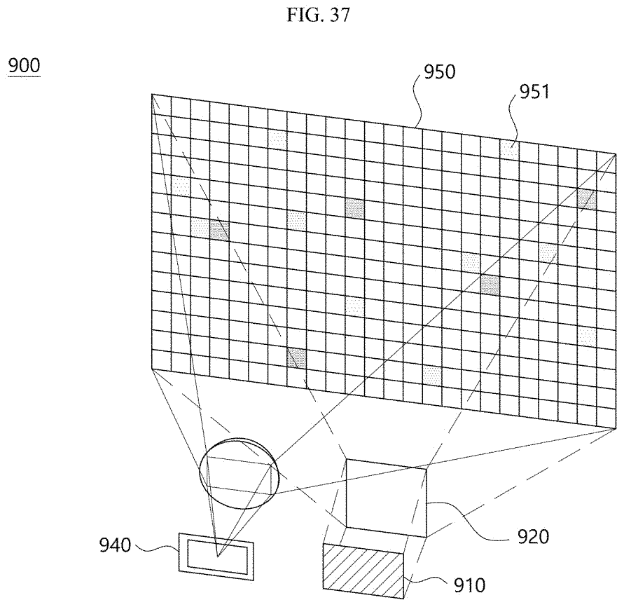

FIG. 37 is a diagram for describing a semi-flash LiDAR according to another embodiment.

Referring to FIG. 37, a semi-flash LiDAR 900 according to another embodiment may include a laser emitting unit 910, a BCSC 920, and a reception unit 940.

The semi-flash LiDAR 900 according to one embodiment may include the laser emitting unit 910. A description of the laser emitting unit 910 may be duplicated with that of the laser emitting unit 810 of FIG. 35, and thus a detailed description thereof will be omitted.

The semi-flash LiDAR 900 according to one embodiment may include the BCSC 920. A description of the BCSC 920 may be duplicated with that of the BCSC 820 of FIG. 35, and thus a detailed description thereof will be omitted.

The semi-flash LiDAR 900 according to one embodiment may include the reception unit 940. A description of the reception unit 940 may be duplicated with that of the reception unit 840 of FIG. 35, and thus a detailed description thereof will be omitted.

According to one embodiment, the semi-flash LiDAR 900 may have a predetermined light path between the components.

For example, light emitted from the laser emitting unit 910 may be incident on an object 950 through the BCSC 920. Further, the light incident on the object 950 may be reflected from the object 950 and received by the reception unit 940. A lens for increasing light-transmitting/receiving efficiency may be additionally inserted into the above-described light path.

When the semi-flash LiDAR 900 of FIG. 37 is compared with the semi-flash LiDAR 800 of FIG. 35, the semi-flash LiDAR 900 of FIG. 37 may not include a scanning unit. A scanning function of the scanning unit may be realized with the laser emitting unit 910 and the BCSC 920.

For example, the laser emitting unit 910 may include an addressable VCSEL array and partially emit a laser beam to a region of interest by an addressable operation.

Further, for example, the BCSC 920 may include a collimation component and a steering component to provide a particular orientation to a laser beam so that the laser beam is irradiated to a desired region of interest.

Further, the semi-flash LiDAR 900 of FIG. 37 may have a simplified light path as compared with the semi-flash LiDAR 800 of FIG. 35. By simplifying the light path, a light loss may be minimized and the possibility of occurring crosstalk may be reduced.

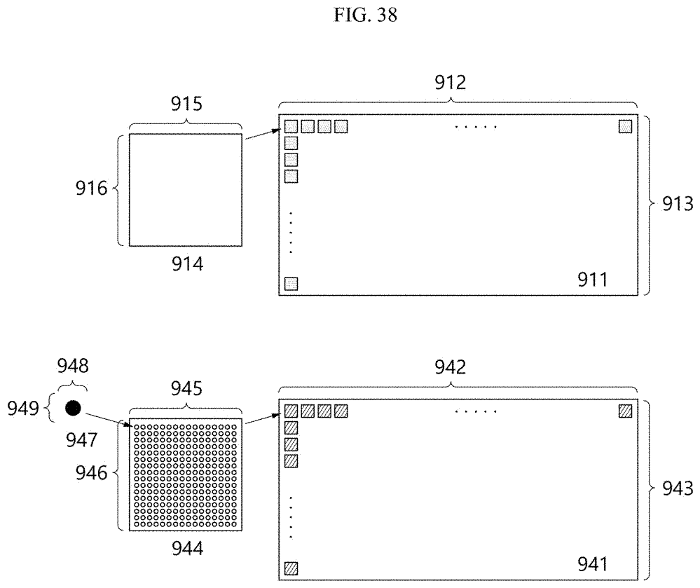

FIG. 38 is a diagram for describing a configuration of a semi-flash LiDAR according to another embodiment.

Referring to FIG. 38, a semi-flash LiDAR 900 according to one embodiment may include a laser emitting unit 910 and a reception unit 940.

According to one embodiment, the laser emitting unit 910 may include a VCSEL array 911. For example, the VCSEL array 911 may have an N*M matrix structure.

According to one embodiment, the VCSEL array 911 may include a plurality of VCSEL units 914. Here, each of the VCSEL units 914 may include a plurality of VCSEL emitters. For example, the VCSEL array 911 may include 1250 VCSEL units 914 having a 50×25 matrix structure, but the present disclosure is not limited thereto.

According to one embodiment, each of the VCSEL units 914 may have a divergence angle. For example, the VCSEL unit 914 may have a horizontal divergence angle 915 and a vertical divergence angle 916. For example, the VCSEL unit 914 may have the horizontal divergence angle 915 of 1.2 degrees and the vertical divergence angle 916 of 1.2 degrees, but the present disclosure is not limited thereto.

According to one embodiment, the reception unit 940 may include a SPAD array 941. For example, the SPAD array 941 may have an N*M matrix structure.

According to one embodiment, the SPAD array 941 may include a plurality of SPAD units 944. At this point, each of the SPAD units 944 may include a plurality of SPAD pixels 947. For example, the SPAD unit 944 may include 12×12 SPAD pixels 947.

Further, for example, the SPAD array 941 may include 1250 SPAD units 944 of a 50×25 matrix structure. In this case, the arrangement of the SPAD units 944 may correspond to the arrangement of the VCSEL units 914.

According to one embodiment, each the SPAD units 944 may have an FOV at which light may be received. For example, the SPAD unit 944 may have a horizontal FOV 945 and a vertical FOV 946. For example, the SPAD unit 944 may have the horizontal FOV 945 of 1.2 degrees and the vertical FOV 946 of 1.2 degrees.

At this point, the FOV of the SPAD unit 944 may be proportional to the number of SPAD pixels 947 included in the SPAD unit 944. Alternatively, an FOV of the individual SPAD pixel 947 included in the SPAD unit 944 may be determined by the FOV of the SPAD unit 944.

For example, in a case in which each of a horizontal FOV 948 and a vertical FOV 949 of the individual SPAD pixel 947 is 0.1 degrees, when the SPAD unit 944 includes N*M SPAD pixels 947, the horizontal FOV 945 and the vertical FOV 946 of the SPAD unit 944 may be 0.1*N and 0.1*M, respectively.

Further, for example, in a case in which each of the horizontal FOV 945 and the vertical FOV 946 of the SPAD unit 944 is 1.2 degrees, when the SPAD unit 944 includes 12×12 SPAD pixels 947, the horizontal FOV 948 and the vertical FOV 949 of the individual SPAD pixel 947 may each be 0.1 degrees (=1.2/12).

According to another embodiment, the reception unit 940 may include a SiPM array 941. For example, the SiPM array 941 may have an N*M matrix structure.

According to one embodiment, the SiPM array 941 may include a plurality of microcell units 944. Here, each of the microcell units 944 may include a plurality of microcells 947. For example, each of the microcell units 944 may include 12×12 microcells 947.

Further, for example, the SiPM array 941 may include 1250 microcell units 944 of a 50×25 matrix structure. In this case, the arrangement of the microcell units 944 may correspond to the arrangement of the VCSEL units 914.

According to one embodiment, each of the microcell units 944 may have an FOV at which light may be received. For example, the microcell unit 944 may have a horizontal FOV 945 and a vertical FOV 946. For example, the microcell unit 944 may have the horizontal FOV 945 of 1.2 degrees and the vertical FOV 946 of 1.2 degrees.

Here, the FOV of the microcell unit 944 may be proportional to the number of microcells 947 included in the microcell unit 944. Alternatively, an FOV of the individual microcell 947 included in the microcell unit 944 may be determined by the FOV of the microcell unit 944.

For example, in a case in which each of a horizontal FOV 948 and a vertical FOV 949 of the individual microcell 947 is 0.1 degrees, when the microcell unit 944 includes N*M microcells 947, the horizontal FOV 945 and the vertical FOV 946 of the microcell unit 944 may be 0.1*N and 0.1*M, respectively.

Further, for example, in a case in which each of the horizontal FOV 945 and the vertical FOV 946 of the microcell unit 944 is 1.2 degrees, when the microcell unit 944 includes 12×12 microcells 947, the horizontal FOV 948 and the vertical FOV 949 of the individual microcell 947 may each be 0.1 degrees (=1.2/12).

According to one embodiment, the VCSEL unit 914 of the laser emitting unit 910 may correspond to the SPAD unit or microcell unit 944 of the reception unit 940.

For example, the horizontal divergence angle and the vertical divergence angle of the VCSEL units 914 may be respectively identical to the horizontal FOV 945 and the vertical FOV 946 of the SPAD unit or microcell unit 944.

For example, a laser beam emitted from the VCSEL unit 914 in a first row and first column may be reflected from the object 850 and received by the SPAD unit or microcell unit 944 in the first row and first column.

Further, for example, a laser beam emitted from the VCSEL unit 914 in an Nth row and Mth column may be reflected from the object 850 and received by the SPAD unit or microcell unit 944 in the Nth row and Mth column.

At this point, the laser beam, which is emitted from the VCSEL unit 914 in the Nth row and Mth column and reflected from the object 850, may be received by the SPAD unit or microcell unit 944 in the Nth row and Mth column, and the LiDAR device 900 may have a resolution by the SPAD unit or microcell unit 944.

For example, when the SPAD unit or microcell unit 944 includes SPAD pixels or microcells 947 of N rows*M columns, the VCSEL unit 914 may recognize distance information of the object by dividing the FOV, at which light is irradiated, into N*M regions.

According to another embodiment, one VCSEL unit 914 may correspond to the plurality of SPAD units or microcell units 944. For example, the laser beam emitted from the VCSEL unit 914 in the first row and first column may be reflected from the object 850 and received by the SPAD units or microcell units 944 in the first row and first column and a first row and second column.

According to still another embodiment, the plurality of VCSEL units 914 may correspond to one SPAD unit or microcell unit 944. For example, a laser beam emitted from the VCSEL unit 914 in the first row and first column may be reflected from the object 850 and received by the SPAD unit or microcell unit 944 in the first row and first column.

According to one embodiment, the plurality of VCSEL units 914 included in the laser emitting unit 910 may operate according to a predetermined sequence or may operate randomly. At this point, the SPAD unit or microcell unit 944 of the reception unit 940 may also operate corresponding to the operation of the VCSEL unit 914.

For example, in the VCSEL array 911, the VCSEL unit in a first row and third column may operate after the VCSEL unit in a first row and first column operates. Thereafter, the VCSEL unit in a first row and fifth column may operate, and then the VCSEL unit in a first row and seventh column may operate.

In this case, in the reception unit 940, the SPAD unit or microcell unit 944 in a first row and third column may operate after the SPAD unit or microcell unit 944 in a first row and first column operates. Thereafter, the SPAD unit or microcell unit 944 in a first row and fifth column may operate, and then the SPAD unit or microcell unit 944 in a first row and seventh column may operate.

Further, for example, the VCSEL units of the VCSEL array 911 may operate randomly. At this point, the SPAD unit or microcell unit 944 of the reception unit, which is present at a position corresponding to the position of the randomly operating VCSEL unit 914, may operate.

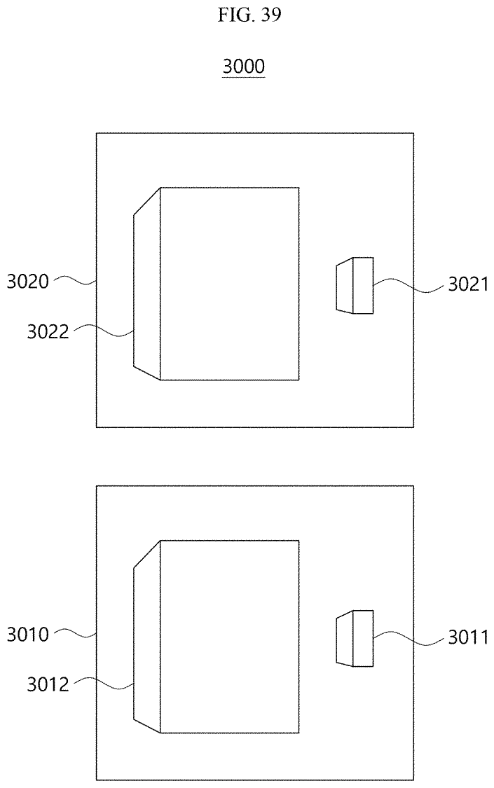

FIG. 39 is a diagram for describing a LiDAR device according to one embodiment.

Referring to FIG. 39, a LiDAR device 3000 according to one embodiment may include a transmission module 3010 and a reception module 3020.

Further, the transmission module 3010 may include a laser emitting array 3011 and a first lens assembly 3012, but the present disclosure is not limited thereto.

Here, the contents of the laser emitting unit or the like described above may be applied to the laser emitting array 3011, and thus redundant descriptions thereof will be omitted.

Further, the laser emitting array 3011 may emit at least one laser. For example, the laser emitting array 3011 may emit a plurality of lasers, but the present disclosure is not limited thereto.

Further, the laser emitting array 3011 may emit at least one laser at a first wavelength. For example, the laser emitting array 3011 may emit at least one laser at a wavelength of 940 nm, and may emit a plurality of lasers at a wavelength of 940 nm, but the present disclosure is not limited thereto.

In this case, the first wavelength may be a wavelength range including an error range. For example, the first wavelength may refer to a wavelength range of 935 nm to 945 nm as a wavelength of 940 nm in a 5 nm error range, but the present disclosure is not limited thereto.

Further, the laser emitting array 3011 may emit at least one laser at the same time point. For example, the laser emitting array 3011 may emit a first laser at a first time point, or may emit at least one laser at the same time point, such as, emitting first and second lasers at a second time point.

Further, the first lens assembly 3012 may include at least two lens layers. For example, the first lens assembly 3012 may include at least four lens layers, but the present disclosure is not limited thereto.

Further, the first lens assembly 3012 may steer the laser emitted from the laser emitting array 3011. For example, the first lens assembly 3012 may steer the first laser emitted from the laser emitting array 3011 in a first direction and steer the second laser emitted from the laser emitting array 3011 in a second direction, but the present disclosure is not limited thereto.

Further, the first lens assembly 3012 may steer a plurality of lasers, which are emitted from the laser emitting array 3011, in order to irradiate the plurality of lasers at different angles within a range of x degrees to y degrees. For example, the first lens assembly 3012 may steer the first laser emitted from the laser emitting array 3011 in the first direction in order to irradiate the first laser at the angle of x degrees, and steer the second laser emitted from the laser emitting array 3011 in the second direction in order to irradiate the second laser at the angle of y degrees, but the present disclosure is not limited thereto.

Further, the reception module 3020 may include a laser detecting array 3021 and a second lens assembly 3022, but the present disclosure is not limited thereto.

Here, the contents of the detecting unit or the like described above may be applied to the laser detecting array 3021, and thus redundant descriptions thereof will be omitted.

Further, the laser detecting array 3021 may detect at least one laser. For example, the laser detecting array 3021 may detect a plurality of lasers.

Further, the laser detecting array 3021 may include a plurality of detectors. For example, the laser detecting array 3021 may include a first detector and a second detector, but the present disclosure is not limited thereto.

Further, each of the plurality of detectors included in the laser detecting array 3021 may receive different lasers. For example, the first detector included in the laser detecting array 3021 may receive a first laser that is received in the first direction, and the second detector may receive a second laser that is received in the second direction, but the present disclosure is not limited thereto.

Further, the laser detecting array 3021 may detect at least a portion of the laser irradiated from the transmission module 3010. For example, the laser detecting array 3021 may detect at least a portion of the first laser irradiated from the transmission module 3010 and may detect at least a portion of the second laser, but the present disclosure is not limited thereto.

Further, the second lens assembly 3022 may transmit the laser, which irradiated from the transmission module 3010, to the laser detecting array 3021. For example, when the first laser, which is irradiated from the transmission module 3010 in the first direction, is reflected from the object positioned in the first direction, the second lens assembly 3022 may transmit the first laser to the laser detecting array 3021, and when the second laser, which is irradiated in the second direction, is reflected from the object positioned in the second direction, the second lens assembly 3022 may transmit the second laser to the laser detecting array 3021, but the present disclosure is not limited thereto.

Further, the second lens assembly 3022 may distribute the lasers irradiated from the transmission module 3010 to at least two different detectors. For example, when the first laser, which is irradiated from the transmission module 3010 in the first direction, is reflected from the object positioned in the first direction, the second lens assembly 3022 may distribute the first laser to the first detector included in the laser detecting array 3021, and when the second laser, which is irradiated in the second direction, is reflected from the object positioned in the second direction, the second lens assembly 3022 may distribute the second laser to the second detector included in the laser detecting array 3021, but the present disclosure is not limited thereto.

Further, at least a portion of each of the laser emitting array 3011 and the laser detecting array 3021 may match each other. For example, a first laser emitted from a first laser emitting element included in the laser emitting array 3011 may be detected by the first detector included in the laser detecting array 3021, and a second laser emitted from a second laser emitting element included in the laser emitting array 3011 may be detected by the second detector included in the laser detecting array 3021, but the present disclosure is not limited thereto.

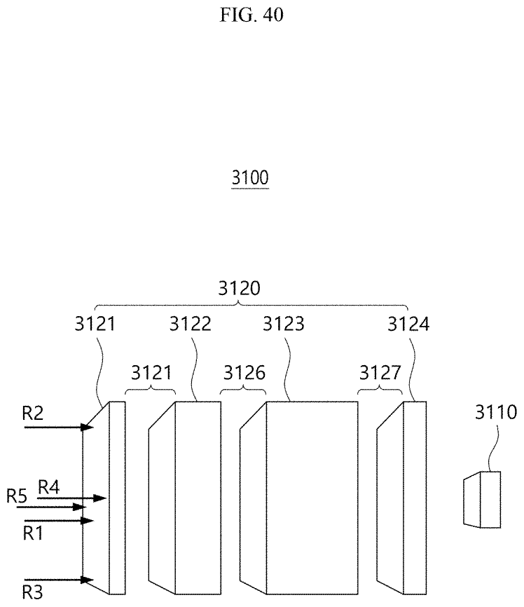

FIG. 40 is a diagram for describing a reception module according to one embodiment.

Referring to FIG. 40, a reception module 3100 according to one embodiment may include a laser detecting array 3110 and a lens assembly 3120.

Here, the contents of the laser detecting array described above may be equally applied to the laser detecting array 3110, and thus redundant descriptions thereof will be omitted.

Also, the contents of the lens assembly described above may be equally applied to the lens assembly 3120, and thus redundant descriptions thereof will be omitted.

Further, the lens assembly 3120 may include at least two lens layers. For example, as shown in FIG. 40, the lens assembly 3120 may include a first lens layer 3121, a second lens layer 3122, a third lens layer 3123, and a fourth lens layer 3124, but the present disclosure is not limited thereto.

In this case, each of the lens layers may be formed of the same material, but is not limited thereto, and may be formed of different materials.

Further, thicknesses of the lens layers may be different from each other, but are not limited thereto, and at least some thereof may be the same.

Further, the lens assembly 3120 may include at least two gap layers. For example, as shown in FIG. 40, the lens assembly 3120 may include a first gap layer 3125, a second gap layer 3126, and a third gap layer 3127, but the present disclosure is not limited thereto.

In this case, each of the gap layers may include a material different from that of each of the lens layers. For example, each of the gap layers may include air, but the present disclosure is not limited thereto.

In this case, each of the gap layers may include the same material, but it is not limited thereto, and may include different materials.

Further, each of the gap layers may refer to a space or material between the respective lens layers. For example, the first gap layer 3125 may refer to a space or material between the first lens layer 3121 and the second lens layer 3122, the second gap layer 3126 may refer to a space or material between the second lens layer 3122 and the third lens layer 3123, and the third gap layer 3127 may refer to a space or material between the third lens layer 3123 and the fourth lens layer 3124, but the present disclosure is not limited thereto.

Further, each of the gap layers may be positioned between the respective lens layers. For example, the first gap layer 3125 may be positioned between the first lens layer 3121 and the second lens layer 3122, the second gap layer 3126 may be positioned between the second lens layer 3122 and the third lens layer 3123, and the third gap layer 3127 may be positioned between the third lens layer 3123 and the fourth lens layer 3124, but the present disclosure is not limited thereto.

Further, light rays of parallel light incident on the lens assembly 3120 may be received by the laser detecting array 3110 along respective paths. For example, of parallel light incident on an entrance pupil of the lens assembly 3120 at 0 degrees, a first light ray R1 incident on a first portion of the entrance pupil may be received by a first detector included in the laser detecting array 3110 along a first light path, a second light ray R2 incident on a second portion of the entrance pupil may be received by the first detector along a second light path, a third light ray R3 incident on a third portion of the entrance pupil may be received by the first detector along a third light path, a fourth light ray R4 incident on a fourth portion of the entrance pupil may be received by the first detector along a fourth light path, and a fifth light ray R5 incident on a fifth portion of the entrance pupil may be received by the first detector along a fifth light path, but the present disclosure is not limited thereto.

In this case, the first portion may be a center portion of the entrance pupil, the second portion may be an end portion of the entrance pupil in a +Y-axis direction, the third portion may be an end portion of the entrance pupil in a −Y-axis direction, the fourth portion may be an end portion of the entrance pupil in a +X-axis direction, and the fifth portion may be an end portion of the entrance pupil in a −X-axis direction, but the present disclosure is not limited thereto.

Further, angles at which the light rays of the parallel light incident on the lens assembly 3120 are incident on a cross section of the first gap layer 3125 may be at least partially different. For example, of the parallel light incident on the entrance pupil of the lens assembly 3120 at 0 degrees, the first light ray R1 incident on the first portion of the entrance pupil may be incident on the cross section of the first gap layer 3125 at a first angle, the second light ray R2 incident on the second portion of the entrance pupil may be incident on the cross section of the first gap layer 3125 at a second angle, the third light ray R3 incident on the third portion of the entrance pupil may be incident on the cross section of the first gap layer 3125 at a third angle, the fourth light ray R4 incident on the fourth portion of the entrance pupil may be incident on the cross section of the first gap layer 3125 at a fourth angle, and the fifth light ray R5 incident on the fifth portion of the entrance pupil may be incident on the cross section of the first gap layer 3125 at a fifth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the first to fifth angles may be different from each other, but are not limited thereto, and may be at least partially the same.

Further, a difference between a minimum angle and a maximum angle of the first to fifth angles may have a first difference value.

Further, angles at which the light rays of the parallel light incident on the lens assembly 3120 are incident on a cross section of the second gap layer 3126 may be at least partially different. For example, of the parallel light incident on the entrance pupil of the lens assembly 3120 at 0 degrees, the first light ray R1 incident on the first portion of the entrance pupil may be incident on the cross section of the second gap layer 3126 at a sixth angle, the second light ray R2 incident on the second portion of the entrance pupil may be incident on the cross section of the second gap layer 3126 at a seventh angle, the third light ray R3 incident on the third portion of the entrance pupil may be incident on the cross section of the second gap layer 3126 at an eighth angle, the fourth light ray R4 incident on the fourth portion of the entrance pupil may be incident on the cross section of the second gap layer 3126 at a ninth angle, and the fifth light ray R5 incident on the fifth portion of the entrance pupil may be incident on the cross section of the second gap layer 3126 at a tenth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the sixth to tenth angles may be different from each other, but are not limited thereto, and may be at least partially the same.

Further, a difference between a minimum angle and a maximum angle of the sixth to tenth angles may have a second difference value.

Further, angles at which the light rays of the parallel light incident on the lens assembly 3120 are incident on a cross section of the third gap layer may be at least partially different. For example, of the parallel light incident on the entrance pupil of the lens assembly 3120 at 0 degrees, the first light ray R1 incident on the first portion of the entrance pupil may be incident on the cross section of the third gap layer at an eleventh angle, the second light ray R2 incident on the second portion of the entrance pupil may be incident on the cross section of the third gap layer at a twelfth angle, the third light ray R3 incident on the third portion of the entrance pupil may be incident on the cross section of the third gap layer at a thirteenth angle, the fourth light ray R4 incident on the fourth portion of the entrance pupil may be incident on the cross section of the third gap layer at a fourteenth angle, and the fifth light ray R5 incident on the fifth portion of the entrance pupil may be incident on the cross section of the third gap layer at a fifteenth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the eleventh to fifteenth angles may be different from each other, but are not limited thereto, and may be at least partially the same.

Further, a difference between a minimum angle and a maximum angle of the eleventh to fifteenth angles may have a third difference value.

Further, angles at which the light rays of the parallel light incident on the lens assembly 3120 are incident on a cross section between the laser detecting array 3110 and the lens assembly 3120 may be at least partially different. For example, of the parallel light incident on the entrance pupil of the lens assembly 3120 at 0 degrees, the first light ray R1 incident on the first portion of the entrance pupil may be incident on the cross section between the laser detecting array 3110 and the lens assembly 3120 at a sixteenth angle, the second light ray R2 incident on the second portion of the entrance pupil may be incident on the cross section between the laser detecting array 3110 and the lens assembly 3120 at a seventeenth angle, the third light ray R3 incident on the third portion of the entrance pupil may be incident on the cross section between the laser detecting array 3110 and the lens assembly 3120 at an eighteenth angle, the fourth light ray R4 incident on the fourth portion of the entrance pupil may be incident on the cross section between the laser detecting array 3110 and the lens assembly 3120 at a nineteenth angle, and the fifth light ray R5 incident on the fifth portion of the entrance pupil may be incident on the cross section between the laser detecting array 3110 and the lens assembly 3120 at a twentieth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the sixteenth to twentieth angles may be different from each other, but are not limited thereto, and may be at least partially the same.

Further, a difference between a minimum angle and a maximum angle of the sixteenth to twentieth angles may have a fourth difference value.

Further, the first to fourth difference values may be different from each other. For example, the second difference value may be the smallest among the first to fourth difference values, and the fourth difference value may be the largest among the first to fourth difference values, but the present disclosure is not limited thereto.

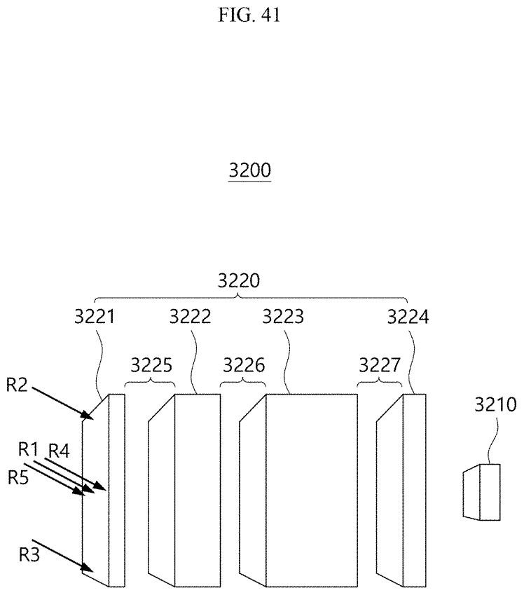

FIG. 41 is a diagram for describing a reception module according to one embodiment.

Referring to FIG. 41, a reception module 3200 according to one embodiment may include a laser detecting array 3210 and a lens assembly 3220.

Here, the contents of the laser detecting array described above may be equally applied to the laser detecting array 3210, and thus redundant descriptions thereof will be omitted. Further, the contents of the lens assembly described above may be equally applied to the lens assembly 3220, and thus redundant descriptions thereof will be omitted.

Further, the lens assembly 3220 may include at least two lens layers. For example, as shown in FIG. 41, the lens assembly 3220 may include a first lens layer 3221, a second lens layer 3222, a third lens layer 3223, and a fourth lens layer 3224, but the present disclosure is not limited thereto.

In this case, each of the lens layers may be formed of the same material, but is not limited thereto, and may be formed of different materials.

Further, thicknesses of the lens layers may be different from each other, but are not limited thereto, and at least some thereof may be the same.

Further, the lens assembly 3220 may include at least two gap layers. For example, as shown in FIG. 41, the lens assembly 3220 may include a first gap layer 3225, a second gap layer 3226, and a third gap layer 3227, but the present disclosure is not limited thereto.

In this case, each of the gap layers may include the same material, but it is not limited thereto, and may include different materials.

Further, each of the gap layers may refer to a space or material between the respective lens layers. For example, the first gap layer 3225 may refer to a space or material between the first lens layer 3221 and the second lens layer 3222, the second gap layer 3226 may refer to a space or material between the second lens layer 3222 and the third lens layer 3223, and the third gap layer 3227 may refer to a space or material between the third lens layer 3223 and the fourth lens layer 3224, but the present disclosure is not limited thereto.

Further, each of the gap layers may be positioned between the respective lens layers. For example, the first gap layer 3225 may be positioned between the first lens layer 3221 and the second lens layer 3222, the second gap layer 3226 may be positioned between the second lens layer 3222 and the third lens layer 3223, and the third gap layer 3227 may be positioned between the third lens layer 3223 and the fourth lens layer 3224, but the present disclosure is not limited thereto.

Further, light rays of parallel light incident on the lens assembly 3220 may be received by the laser detecting array 3210 along respective paths. For example, of parallel light incident on an entrance pupil of the lens assembly 3220 at 30 degrees, a first light ray R1 incident on a first portion of the entrance pupil may be received by a second detector included in the laser detecting array 3210 along a first light path, a second light ray R2 incident on a second portion of the entrance pupil may be received by the second detector along a second light path, a third light ray R3 incident on a third portion of the entrance pupil may be received by the second detector along a third light path, a fourth light ray R4 incident on a fourth portion of the entrance pupil may be received by the second detector along a fourth light path, and a fifth light ray R5 incident on a fifth portion of the entrance pupil may be received by the second detector along a fifth light path, but the present disclosure is not limited thereto.

In this case, the first portion may be a center portion of the entrance pupil, the second portion may be an end portion of the entrance pupil in a +Y-axis direction, a third portion may be an end portion of the entrance pupil in a −Y-axis direction, the fourth portion may be an end portion of the entrance pupil in a +X-axis direction, and the fifth portion may be an end portion of the entrance pupil in a −X-axis direction, but the present disclosure is not limited thereto.

Further, angles at which the light rays of the parallel light incident on the lens assembly 3220 are incident on a cross section of the first gap layer 3225 may be at least partially different. For example, of the parallel light incident on the entrance pupil of the lens assembly 3220 at 30 degrees, the first light ray R1 incident on the first portion of the entrance pupil may be incident on the cross section of the first gap layer 3225 at a first angle, the second light ray R2 incident on the second portion of the entrance pupil may be incident on the cross section of the first gap layer 3225 at a second angle, the third light ray R3 incident on the third portion of the entrance pupil may be incident on the cross section of the first gap layer 3225 at a third angle, the fourth light ray R4 incident on the fourth portion of the entrance pupil may be incident on the cross section of the first gap layer 3225 at a fourth angle, and the fifth light ray R5 incident on the fifth portion of the entrance pupil may be incident on the cross section of the first gap layer 3225 at a fifth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the first to fifth angles may be different from each other, but are not limited thereto, and may be at least partially the same.

Further, a difference between a minimum angle and a maximum angle of the first to fifth angles may have a first difference value.

Further, angles at which the light rays of the parallel light incident on the lens assembly 3220 are incident on a cross section of the second gap layer 3226 may be at least partially different. For example, of the parallel light incident on the entrance pupil of the lens assembly 3220 at 30 degrees, the first light ray R1 incident on the first portion of the entrance pupil may be incident on the cross section of the second gap layer 3226 at a sixth angle, the second light ray R2 incident on the second portion of the entrance pupil may be incident on the cross section of the second gap layer 3226 at a seventh angle, the third light ray R3 incident on the third portion of the entrance pupil may be incident on the cross section of the second gap layer 3226 at an eighth angle, the fourth light ray R4 incident on the fourth portion of the entrance pupil may be incident on the cross section of the second gap layer 3226 at a ninth angle, and the fifth light ray R5 incident on the fifth portion of the entrance pupil may be incident on the cross section of the second gap layer 3226 at a tenth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the sixth to tenth angles may be different from each other, but are not limited thereto, and may be at least partially the same.

Further, a difference between a minimum angle and a maximum angle of the sixth to tenth angles may have a second difference value.

Further, angles at which the light rays of the parallel light incident on the lens assembly 3220 are incident on a cross section of the third gap layer 3227 may be at least partially different. For example, of the parallel light incident on the entrance pupil of the lens assembly 3220 at 30 degrees, the first light ray R1 incident on the first portion of the entrance pupil may be incident on the cross section of the third gap layer 3227 at an eleventh angle, the second light ray R2 incident on the second portion of the entrance pupil may be incident on the cross section of the third gap layer 3227 at a twelfth angle, the third light ray R3 incident on the third portion of the entrance pupil may be incident on the cross section of the third gap layer 3227 at a thirteenth angle, the fourth light ray R4 incident on the fourth portion of the entrance pupil may be incident on the cross section of the third gap layer 3227 at a fourteenth angle, and the fifth light ray R5 incident on the fifth portion of the entrance pupil may be incident on the cross section of the third gap layer 3227 at a fifteenth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the eleventh to fifteenth angles may be different from each other, but are not limited thereto, and may be at least partially the same.

Further, a difference between a minimum angle and a maximum angle of the eleventh to fifteenth angles may have a third difference value.

Further, angles at which the light rays of the parallel light incident on the lens assembly 3220 are incident on a cross section between the laser detecting array 3210 and the lens assembly 3220 may be at least partially different. For example, of the parallel light incident on the entrance pupil of the lens assembly 3220 at 30 degrees, the first light ray R1 incident on the first portion of the entrance pupil may be incident on the cross section between the laser detecting array 3210 and the lens assembly 3220 at a sixteenth angle, the second light ray R2 incident on the second portion of the entrance pupil may be incident on the cross section between the laser detecting array 3210 and the lens assembly 3220 at a seventeenth angle, the third light ray R3 incident on the third portion of the entrance pupil may be incident on the cross section between the laser detecting array 3210 and the lens assembly 3220 at an eighteenth angle, the fourth light ray R4 incident on the fourth portion of the entrance pupil may be incident on the cross section between the laser detecting array 3210 and the lens assembly 3220 at a nineteenth angle, and the fifth light ray R5 incident on the fifth portion of the entrance pupil may be incident on the cross section between the laser detecting array 3210 and the lens assembly 3220 at a twentieth angle, but the present disclosure is not limited thereto.

In this case, the first portion may be the center portion of the entrance pupil, the second portion may be the end portion of the entrance pupil in the +Y-axis direction, the third portion may be the end portion of the entrance pupil in the −Y-axis direction, the fourth portion may be the end portion of the entrance pupil in the +X-axis direction, and the fifth portion may be the end portion of the entrance pupil in the −X-axis direction, but the present disclosure is not limited thereto.

Further, the sixteenth to twentieth angles may be different from each other, but are not limited thereto, and may be at least partially the same.

Further, a difference between a minimum angle and a maximum angle of the sixteenth to twentieth angles may have a fourth difference value.

Further, the first to fourth difference values may be different from each other. For example, the second difference value may be the smallest among the first to fourth difference values, and the fourth difference value may be the largest among the first to fourth difference values, but the present disclosure is not limited thereto.

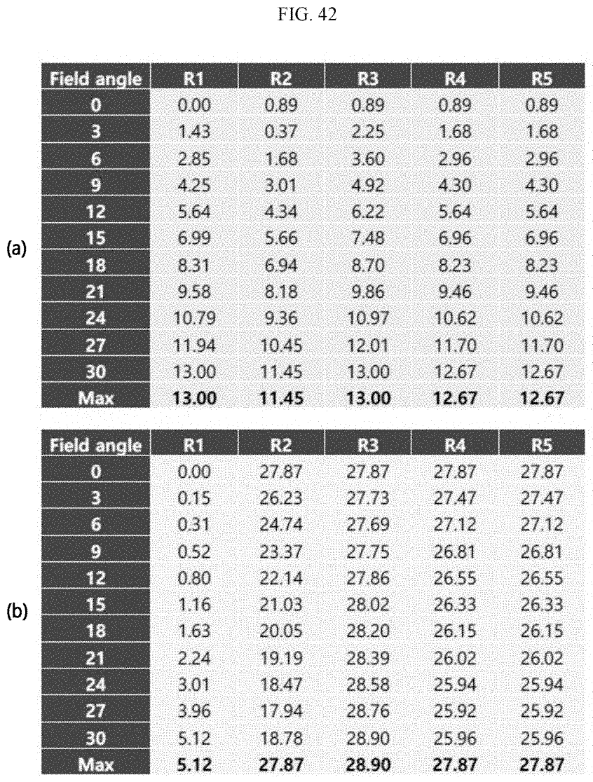

FIG. 42 is a diagram for describing incident angles of light rays of parallel light incident on a lens assembly according to one embodiment.

More specifically, FIG. 42A is an exemplary diagram illustrating an angle of each light ray incident on the cross section of each of the second gap layers 3126 and 3226, which are described above, and FIG. 42B is an exemplary diagram illustrating an angle of each light ray incident on the cross section between the laser detecting array and the lens assembly, which are described above.

Referring to FIG. 42A, it is possible to determine angles at which light rays of parallel light, which is incident on a lens assembly at a predetermined angle, are incident on a cross section of at least one gap layer included in the lens assembly. For example, of a parallel light incident on the lens assembly at an angle of 0 degrees, a first light ray R1 may be incident on the cross section of at least one gap layer included in the lens assembly at 0 degrees, a second light ray R2 may be incident on the cross section of at least one gap layer included in the lens assembly at 0.89 degrees, a third light ray R3 may be incident on the cross section of at least one gap layer included in the lens assembly at 0.89 degrees, a fourth light ray R4 may be incident on the cross section of at least one gap layer included in the lens assembly at 0.89 degrees, and a fifth light ray R5 may be incident on the cross section of at least one gap layer included in the lens assembly at 0.89 degrees, but the present disclosure is not limited thereto.

Further, referring to FIG. 42A, it is possible to determine angles at which light rays of parallel lights, which are incident on a lens assembly at various angles, are incident on a cross section of at least one gap layer included in the lens assembly. For example, the first light ray R1 of the parallel light, which is incident on the lens assembly at an angle of 0 degrees, may be incident on the cross section of at least one gap layer included in the lens assembly at 0 degrees, the first light ray R1 of parallel light, which is incident on the lens assembly at an angle of 15 degrees, may be incident on the cross section of at least one gap layer included in the lens assembly at 6.99 degrees, and the first light ray R1 of parallel light, which is incident on the lens assembly at an angle of 30 degrees, may be incident on the cross section of at least one gap layer included in the lens assembly at 13.0 degrees, but the present disclosure is not limited thereto.

Further, although not described, it is possible to determine angles at which the first to fifth light rays R1 to R5 of parallel lights, which are incident on the lens assembly at various angles such as 3 degrees, 6 degrees, 9 degrees, 12 degrees, 15 degrees, 18 degrees, 21 degrees, 24 degrees, 27 degrees, 30 degrees, and the like, are incident on the cross section of at least one gap layer included in the lens assembly.

Further, referring to FIG. 42A, it can be seen that at least some of light rays of a plurality of parallel lights, which are incident on the lens assembly at different angles in a range of x degrees to y degrees, may be incident on the cross section of at least one gap layer included in the lens assembly at angles in a range of a degrees to b degrees.

For example, at least some of light rays of a plurality of parallel lights, which are incident on the lens assembly at different angles in a range of 0 degrees to 30 degrees, may be incident on the cross section of at least one gap layer included in the lens assembly at angles in a range of 0 degrees to 13 degrees, but the present disclosure is not limited thereto.

Further, referring to FIG. 42B, it is possible to determine angles at which light rays of parallel light, which is incident on a lens assembly at a predetermined angle, are incident on a cross section between the lens assembly and the laser detecting array. For example, of a parallel light incident on the lens assembly at an angle of 0 degrees, a first light ray R1 may be incident on the cross section between the lens assembly and the laser detecting array at 0 degrees, a second light ray R2 may be incident on the cross section between the lens assembly and the laser detecting array at 27.87 degrees, a third light ray R3 may be incident on the cross section between the lens assembly and the laser detecting array at 27.87 degrees, a fourth light ray R4 may be incident on the cross section between the lens assembly and the laser detecting array at 27.87 degrees, and a fifth light ray R5 may be incident on the cross section between the lens assembly and the laser detecting array at 27.87 degrees, but the present disclosure is not limited thereto.

In this case, the cross section between the lens assembly and the laser detecting array may refer to a cross section parallel to the laser detecting array.

Further, referring to FIG. 42B, it is possible to determine angles at which light rays of parallel lights, which are incident on a lens assembly at various angles, are incident on the cross section between the lens assembly and the laser detecting array. For example, the first light ray R1 of the parallel light, which is incident on the lens assembly at an angle of 0 degrees, may be incident on the cross section between the lens assembly and the laser detecting array at 0 degrees, the first light ray R1 of parallel light, which is incident on the lens assembly at an angle of 15 degrees, may be incident on the cross section between the lens assembly and the laser detecting array at 1.16 degrees, and the first light ray R1 of parallel light, which is incident on the lens assembly at an angle of 30 degrees, may be incident on the cross section between the lens assembly and the laser detecting array at 5.12 degrees, but the present disclosure is not limited thereto.

Further, although not described, it is possible to determine angles at which the first to fifth light rays R1 to R5 of parallel lights, which are incident on the lens assembly at various angles such as 3 degrees, 6 degrees, 9 degrees, 12 degrees, 15 degrees, 18 degrees, 21 degrees, 24 degrees, 27 degrees, 30 degrees, and the like, are incident on the cross section between the lens assembly and the laser detecting array.

Further, referring to FIG. 42B, it can be seen that at least some of light rays of a plurality of parallel lights, which are incident on the lens assembly at different angles in a range of x degrees to y degrees, may be incident on the cross section between the lens assembly and the laser detecting array at angles in a range of a degrees to b degrees.

For example, at least some of light rays of a plurality of parallel lights, which are incident on the lens assembly at different angles in a range of 0 degrees to 30 degrees, may be incident on the cross section between the lens assembly and the laser detecting array at angles in a range of 0 degrees to 28.90 degrees, but the present disclosure is not limited thereto.

Further, when the filter layer is positioned in the second gap layer, an angular distribution of light rays incident on the filter layer may be smaller than when the filter layer is positioned between the laser detecting array and the lens assembly.

For example, the angular distribution of the light rays incident on the filter layer may range from 0 degrees to 13 degrees when the filter layer is positioned in the second gap layer, the angular distribution of the light rays incident on the filter layer may range from 0 degrees to 28.90 degrees when the filter layer is positioned between the laser detecting array and the lens assembly, but the present disclosure is not limited thereto.

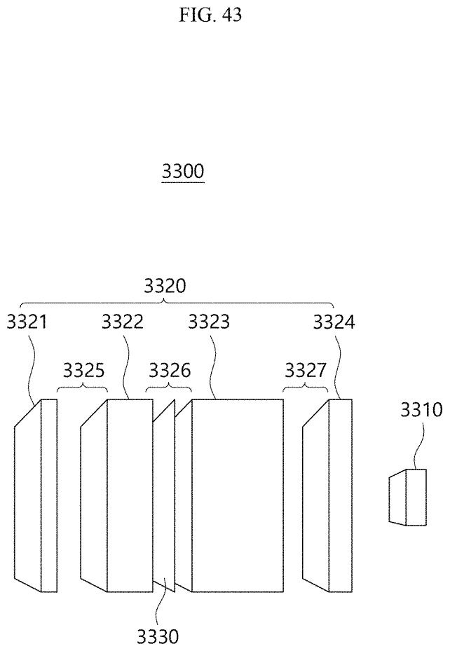

FIG. 43 is a diagram for describing a reception module according to one embodiment.

Referring to FIG. 43, a reception module 3300 according to one embodiment may include a laser detecting array 3310 and a lens assembly 3320.

Here, the contents of the laser detecting array described above may be equally applied to the laser detecting array 3310, and thus redundant descriptions thereof will be omitted.

Further, the contents of the lens assembly described above may be equally applied to the lens assembly 3320, and thus redundant descriptions thereof will be omitted.

Further, the lens assembly 3320 may include at least two lens layers. For example, as shown in FIG. 43, the lens assembly 3320 may include a first lens layer 3321, a second lens layer 3322, a third lens layer 3323, and a fourth lens layer 3324, but the present disclosure is not limited thereto.

In this case, each of the lens layers may be formed of the same material, but is not limited thereto, and may be formed of different materials.

Further, thicknesses of the lens layers may be different from each other, but are not limited thereto, and at least some thereof may be the same.

Further, the lens assembly 3320 may include at least two gap layers. For example, as shown in FIG. 43, the lens assembly 3320 may include a first gap layer 3325, a second gap layer 3326, and a third gap layer 3327, but the present disclosure is not limited thereto.

In this case, each of the gap layers may include a material different from that of each of the lens layers. For example, each of the gap layers may include air, but the present disclosure is not limited thereto.

Further, each of the gap layers may include the same material, but is not limited thereto, and may include different materials.

Further, each of the gap layers may refer to a space or material between the respective lens layers. For example, the first gap layer 3325 may refer to a space or material between the first lens layer 3321 and the second lens layer 3322, the second gap layer 3326 may refer to a space or material between the second lens layer 3322 and the third lens layer 3323, and the third gap layer 3327 may refer to a space or material between the third lens layer 3323 and the fourth lens layer 3324, but the present disclosure is not limited thereto.

Further, each of the gap layers may be positioned between the respective lens layers. For example, the first gap layer 3325 may be positioned between the first lens layer 3321 and the second lens layer 3322, the second gap layer 3326 may be positioned between the second lens layer 3322 and the third lens layer 3323, and the third gap layer 3327 may be positioned between the third lens layer 3323 and the fourth lens layer 3324, but the present disclosure is not limited thereto.

Further, the lens assembly 3320 may include at least one filter layer 3330.

Here, the contents of the optical filter described above may be equally applied to the at least one filter layer 3330, and thus redundant descriptions thereof will be omitted.

Further, the at least one filter layer 3330 may be positioned in at least one gap layer included in the lens assembly 3320. For example, the filter layer 3330 may be positioned in the second gap layer 3326 included in the lens assembly 3320, but the present disclosure is not limited thereto.

Further, the at least one filter layer 3330 may be positioned in the gap layer that has a small difference in angles at which light rays of parallel light, which is incident on the lens assembly 3320 in a viewing angle range, incident on a cross section.

For example, the at least one filter layer 3330 may be positioned in the second gap layer 3326 among the first to third gap layers 3325 to 3327, which has the cross section having the smallest difference between a maximum value and a minimum value at the angles at which the light rays of the parallel light, which is incident on the lens assembly 3320 in the viewing angle range, incident on the cross section, but the present disclosure is not limited thereto.

Further, an angular distribution of light rays of parallel lights, which are incident on the lens assembly 3320 at different angles in the viewing angle range, incident on the cross section of each the first to third gap layers 3325 to 3327 may be different for each gap layer.

For example, a plurality of light rays of a plurality of parallel lights, which are incident on the lens assembly 3320 at different angles in a range of x degrees to y degrees, may be incident on the cross section of the first gap layer 3325 at angles ranging from a degrees to b degrees, incident on the cross section of the second gap layer 3326 at angles ranging from c degrees to d degrees, and incident on the cross section of the third gap layer 3327 at angles ranging from e degrees to f degrees.

In this case, the difference between the c degrees and the d degrees may be smaller than the difference between the a degrees and the b degrees and the difference between the e degrees and the f degrees, but the present disclosure is not limited thereto.

Further, as shown in FIG. 43, the at least one filter layer 3330 may be positioned in the second gap layer 3326 and may be designed as a band-pass filter having a first central wavelength for light incident at 0 degrees and a second central wavelength for light incident at the d degrees.

Further, the at least one filter layer 3330 may be designed as a band-pass filter having a third central wavelength for light incident at the f degrees.

Hereinafter, the bandwidth and the central wavelength of the filter layer will be described in more detail.

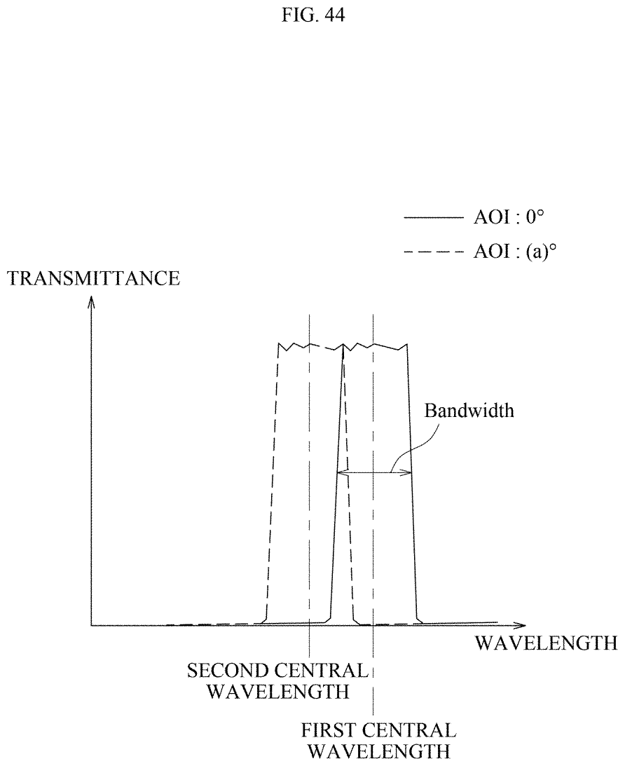

FIG. 44 is a diagram for describing a bandwidth and a central wavelength of a filter layer.

Referring to FIG. 44, a filter layer according to one embodiment may be designed as a band-pass filter that transmits at least a portion of light incident on the filter layer and blocks the remaining portion of the light.

In this case, the filter layer may have a bandwidth at which at least a portion of the light incident on the filter layer transmits, and the bandwidth may be understood as a full width at half maximum, but is not limited thereto, and may be generally understood as a bandwidth of the band-pass filter for light.

Further, for the light incident on the filter layer, the central wavelength of the filter layer may be understood as a central wavelength between wavelengths of 50% of the maximum transmittance, but is not limited thereto, and may be generally understood as a central wavelength of the band-pass filter for light.

Further, the central wavelength of the filter layer may be changed according to an angle of the light incident on the filter layer.

For example, as shown in FIG. 44, the central wavelength of the filter layer may be a first central wavelength for light that is incident on the filter layer at 0 degrees, and the central wavelength of the filter layer may be a second central wavelength for light that is incident on the filter layer at a degrees, but the present disclosure is not limited thereto.

Further, the first central wavelength may be a wavelength greater than the second central wavelength.

Further, when the filter layer is positioned in at least one gap layer of the lens assembly described above, the filter layer may be designed based on angles at which a plurality of light rays of a plurality of parallel lights, which are incident on a lens assembly in a viewing angle range, are incident on a cross section of the gap layer in which the filter layer is positioned.

For example, when the filter layer is positioned in the above-described second gap layer of the lens assembly, and angles at which the plurality of light rays of the plurality of parallel lights, which are incident on the lens assembly in the viewing angle range, are incident on the cross section of the second gap layer, in which the filter layer is positioned, range from 0 degrees to a degrees, the bandwidth of the filter layer may be designed to be greater than or equal to a difference value between the first central wavelength and the second central wavelength, but the present disclosure is not limited thereto.

Further, for example, when the filter layer is positioned in the above-described second gap layer of the lens assembly, and the angles at which the plurality of light rays of the plurality of parallel lights, which are incident on the lens assembly in the viewing angle range, are incident on the cross section of the second gap layer, in which the filter layer is positioned, range from 0 degrees to a degrees, the filter layer may be designed such that a transmission band for light incident at 0 degrees and a transmission band for light incident at a degrees are at least partially overlap each other, but the present disclosure is not limited thereto.

Further, for example, when the filter layer is positioned in the above-described second gap layer of the lens assembly, and the angles at which the plurality of light rays of the plurality of parallel lights, which are incident on the lens assembly in the viewing angle range, are incident on the cross section of the second gap layer, in which the filter layer is positioned, range from 0 degrees to a degrees, the filter layer may be designed such that the transmission band for light incident at 0 degrees and the transmission band for light incident at a degrees share at least one wavelength band, but the present disclosure is not limited thereto.

Thus, when the filter layer is positioned in at least one gap layer of the lens assembly, as the angular distribution of the plurality of light rays incident on the cross section of the gap layer, in which the filter layer is positioned, is reduced, the bandwidth of the filter layer may be designed to be narrow.

At this point, the angular distribution of the plurality of light rays may be defined by a difference between a maximum angle and a minimum angle at which at least some of the light rays included in the plurality of light rays are incident on the cross section of the gap layer, but the present disclosure is not limited thereto.

Further, when the bandwidth of the filter layer is designed to be narrow, noise caused by external light other than the laser emitted from the LiDAR device including the lens assembly may be reduced.

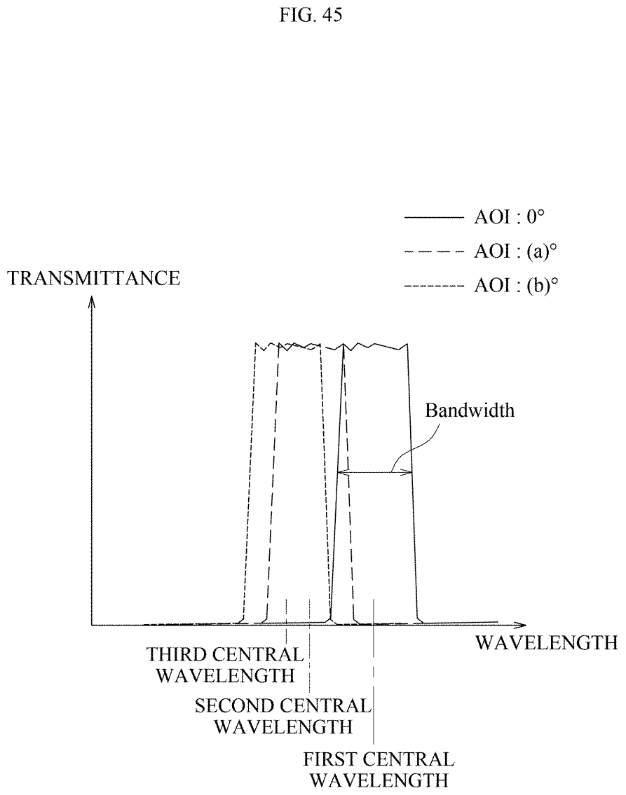

FIG. 45 is a diagram for describing a bandwidth and a central wavelength of a filter layer.

Referring to FIG. 45, the filter layer according to one embodiment may be designed as a band-pass filter that transmits at least a portion of light incident on a filter layer and blocks the remaining portion of the light.

Here, the contents of the filter layer described above may be equally applied, and thus redundant descriptions thereof will be omitted.

The central wavelength of the filter layer may be changed according to an angle of the light incident on the filter layer.

For example, as shown in FIG. 45, the central wavelength of the filter layer may be a first central wavelength for light that is incident on the filter layer at 0 degrees, the central wavelength of the filter layer may be a second central wavelength for light that is incident on the filter layer at a degrees, and the central wavelength of the filter layer may be a third central wavelength for light that is incident on the filter layer at b degrees, but the present disclosure is not limited thereto.

Further, the first central wavelength may be a wavelength greater than the second central wavelength, and the second central wavelength may be a wavelength greater than the third central wavelength.

Further, when the filter layer is positioned in at least one gap layer of the lens assembly described above, the filter layer may be designed based on angles at which a plurality of light rays of a plurality of parallel lights, which are incident on a lens assembly in a viewing angle range, are incident on a cross section of the gap layer in which the filter layer is positioned.

For example, when the filter layer is positioned in the above-described second gap layer of the lens assembly, and the angles at which the plurality of light rays of the plurality of parallel lights, which are incident on the lens assembly in the viewing angle range, are incident on the cross section of the second gap layer, in which the filter layer is positioned, range from 0 degrees to a degrees, the bandwidth of the filter layer may be designed to be greater than or equal to a difference value between the first central wavelength and the second central wavelength.

Further, for example, when the filter layer is positioned in the above-described second gap layer of the lens assembly, and the angles at which the plurality of light rays of the plurality of parallel lights, which are incident on the lens assembly in the viewing angle range, are incident on the cross section of the second gap layer, in which the filter layer is positioned, range from 0 degrees to a degrees, the filter layer may be designed such that a transmission band for light incident at 0 degrees and a transmission band for light incident at a degrees are at least partially overlap each other, but the present disclosure is not limited thereto.

Further, for example, when the filter layer is positioned in the above-described second gap layer of the lens assembly, and the angles at which the plurality of light rays of the plurality of parallel lights, which are incident on the lens assembly in the viewing angle range, are incident on the cross section of the second gap layer, in which the filter layer is positioned, range from 0 degrees to a degrees, the filter layer may be designed such that the transmission band for the light incident at 0 degrees and the transmission band for the light incident at a degrees share at least one wavelength band, but the present disclosure is not limited thereto.

Further, when the angles at which the plurality of light rays of the plurality of parallel lights, which are incident on the lens assembly in the viewing angle range, are incident on the cross section of the third gap layer, in which the filter layer is not positioned, range from 0 degrees to b degrees, the bandwidth of the filter layer may be designed to be less than or equal to a difference value between the first central wavelength and the third central wavelength, but the present disclosure is not limited thereto.

Further, when the angles at which the plurality of light rays of the plurality of parallel lights, which are incident on the lens assembly in the viewing angle range, are incident on the cross section of the third gap layer, in which the filter layer is not positioned, range from 0 degrees to b degrees, the filter layer may be designed such that the transmission band for the light incident at 0 degrees and the transmission band for the light incident at b degrees do not overlap each other, but the present disclosure is not limited thereto.

Further, when the angles at which the plurality of light rays of the plurality of parallel lights, which are incident on the lens assembly in the viewing angle range, are incident on the cross section of the third gap layer, in which the filter layer is not positioned, range from 0 degrees to b degrees, the filter layer may be designed such that the transmission band for the light incident at 0 degrees and the transmission band for the light incident at b degrees do not share at least one wavelength band, but the present disclosure is not limited thereto.

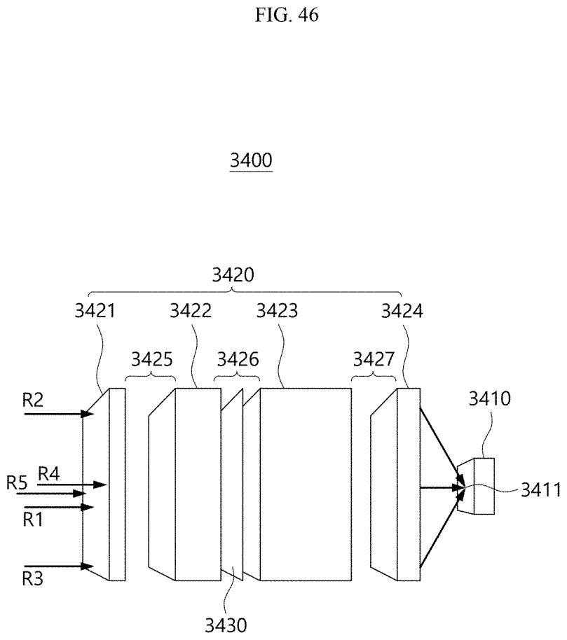

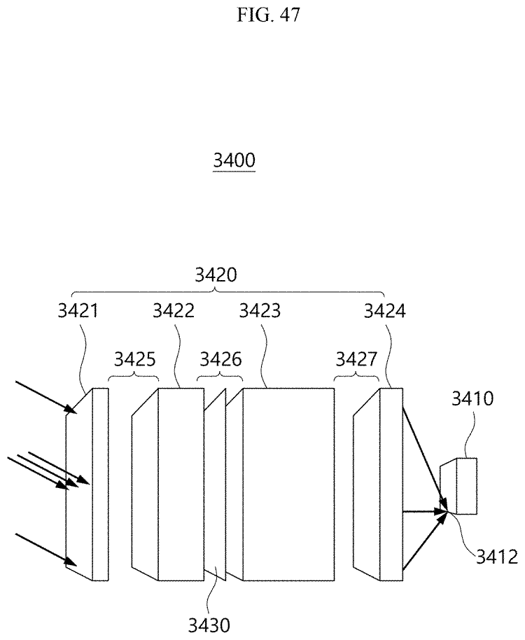

FIGS. 46 and 47 are diagrams for describing a reception module according to one embodiment.

Referring to FIGS. 46 and 47, a reception module 3400 according to one embodiment may include a laser detecting array 3410 and a lens assembly 3420.

Here, the contents of the laser detecting array described above may be equally applied to the laser detecting array 3410, and thus redundant descriptions thereof will be omitted.

Further, the contents of the lens assembly described above may be equally applied to the lens assembly 3420, and thus redundant descriptions thereof will be omitted.

The lens assembly 3420 may include at least two lens layers and at least one filter layer. For example, as shown in FIGS. 46 and 47, the lens assembly 3420 may include a first lens layer 3421, a second lens layer 3422, a third lens layer 3423, a fourth lens layer 3424, and a filter layer 3430, but the present disclosure is not limited thereto.

At this point, the filter layer 3430 may be positioned between the first to fourth lens layers 3421 to 3424. For example, as shown in FIGS. 46 and 47, the filter layer 3430 may be positioned between the second lens layer 3422 and the third lens layer 3423, but the present disclosure is not limited thereto.

Further, the contents of the lens layer and the filter layer described above may be equally applied to the first to fourth lens layers 3421 to 3424 and the filter layer 3430, and thus redundant descriptions thereof will be omitted.

The lens assembly 3420 may be configured by integrally forming at least two lens layers and at least one filter layer, but the present disclosure is not limited thereto.

Further, the lens assembly 3420 may be designed to reduce noise caused by external light while distributing a plurality of parallel lights, which are incident on the lens assembly 3420 at different angles in a viewing angle range, to different detectors.

For example, the lens assembly 3420 may distribute the parallel light incident on the lens assembly 3420 at 0 degrees to a first detector 3411 included in the laser detecting array 3410 as shown in FIG. 46, and may distribute the parallel light incident on the lens assembly 3420 at 30 degrees to a second detector 3412 included in the laser detecting array 3410 as shown in FIG. 47, but the present disclosure is not limited thereto.

Further, for example, as shown in FIG. 46, when angles at which the plurality of light rays of parallel light, which is incident on the lens assembly 3420 at 0 degrees, are incident on a cross section of a second gap layer 3426 in which the filter layer 3430 is positioned, range from a degrees to b degrees, the lens assembly 3420 may block light in a wavelength band other than a transmission band of the filter layer 3430 corresponding the angles in a range of a degrees to b degrees, but the present disclosure is not limited thereto.

Further, for example, as shown in FIG. 47, when angles at which the plurality of light rays of parallel light, which is incident on the lens assembly 3420 at 30 degrees, are incident on the cross section of the second gap layer 3426 in which the filter layer 3430 is positioned, range from c degrees to d degrees, the lens assembly 3420 may block light in a wavelength band other than the transmission band of the filter layer 3430 corresponding the angles in a range of c degrees to d degrees, but the present disclosure is not limited thereto.

Further, for example, as shown in FIGS. 46 and 47, the lens assembly 3420 may be designed to reduce noise caused by external light while distributing a plurality of parallel lights, which are incident on the lens assembly 3420 at different angles in a range of 0 degrees to 30 degrees, to different detectors, but the present disclosure is not limited thereto.

More specifically, as shown in FIGS. 46 and 47, the lens assembly 3420 may block noise in a wavelength band other than the transmission band of the filter layer 3430 corresponding to the angles in a range of a degrees to b degrees while distributing parallel light incident on the lens assembly 3420 at 0 degrees to the first detector, and may block noise in a wavelength band other than the transmission band of the filter layer 3430 corresponding to the angles in a range of c degrees to d degrees while distributing parallel light incident on the lens assembly 3420 at 30 degrees to the second detector, but the present disclosure is not limited thereto.

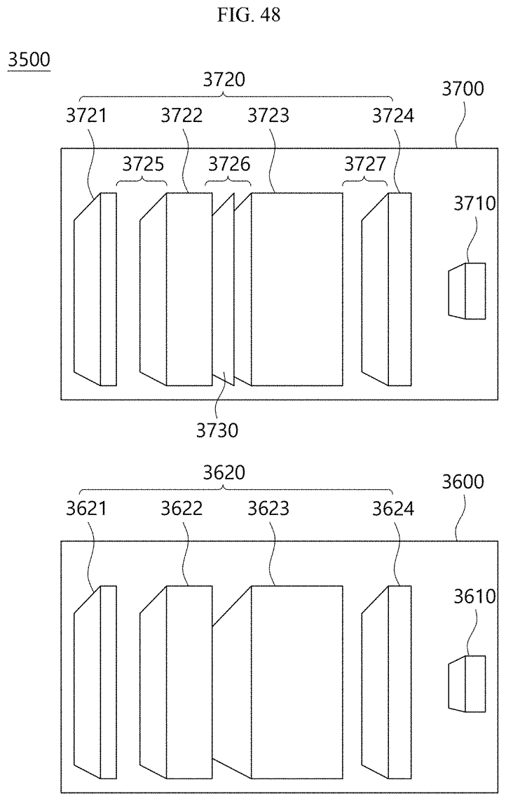

FIG. 48 is a diagram for describing a LiDAR device according to one embodiment.

Referring to FIG. 48, a LiDAR device 3500 according to one embodiment may include a transmission module 3600 and a reception module 3700.

Further, the transmission module 3600 may include a laser emitting array 3610 and a first lens assembly 3620, but the present disclosure is not limited thereto.

Here, the contents of the laser emitting unit or the like described above may be applied to the laser emitting array 3610, and thus redundant descriptions thereof will be omitted.

Further, the laser emitting array 3610 may emit at least one laser. For example, the laser emitting array 3610 may emit a plurality of lasers, but the present disclosure is not limited thereto.

Further, the laser emitting array 3610 may emit at least one laser at a first wavelength. For example, the laser emitting array 3610 may emit at least one laser at a wavelength of 940 nm, and may emit a plurality of lasers at a wavelength of 940 nm, but the present disclosure is not limited thereto.

In this case, the first wavelength may be a wavelength range including an error range. For example, the first wavelength may refer to a wavelength range of 935 nm to 945 nm as a wavelength of 940 nm in a 5 nm error range, but the present disclosure is not limited thereto.

Further, the first lens assembly 3620 may include at least two lens layers. For example, as shown in FIG. 48, the first lens assembly 3620 may include a first lens layer 3621, a second lens layer 3622, a third lens layer 3623, and a fourth lens layer 3624, but the present disclosure is not limited thereto.

Further, the first lens assembly 3620 may steer a laser emitted from the laser emitting array 3610. For example, the first lens assembly 3620 may steer the first laser emitted from the laser emitting array 3610 in a first direction and steer the second laser emitted from the laser emitting array 3610 in a second direction, but the present disclosure is not limited thereto.

Further, the first lens assembly 3620 may steer a plurality of lasers, which are emitted from the laser emitting array 3610, in order to irradiate the plurality of lasers at different angles within a range of x degrees to y degrees. For example, the first lens assembly 3620 may steer the first laser emitted from the laser emitting array 3610 in the first direction in order to irradiate the first laser at the angle of x degrees, and steer the second laser emitted from the laser emitting array 3610 in the second direction in order to irradiate the second laser at the angle of y degrees, but the present disclosure is not limited thereto.

Further, the reception module 3700 may include a laser detecting array 3710 and a second lens assembly 3720, but the present disclosure is not limited thereto.

Here, the contents of the detecting unit or the like described above may be applied to the laser detecting array 3710, and thus redundant descriptions thereof will be omitted.

Further, the laser detecting array 3710 may detect at least one laser. For example, the laser detecting array 3710 may detect a plurality of lasers.

Further, the laser detecting array 3710 may include a plurality of detectors. For example, the laser detecting array 3710 may include a first detector and a second detector, but the present disclosure is not limited thereto.

Further, each of the plurality of detectors included in the laser detecting array 3710 may receive different lasers. For example, the first detector included in the laser detecting array 3710 may receive a first laser that is received in the first direction, and the second detector may receive a second laser that is received in the second direction, but the present disclosure is not limited thereto.

Further, the second lens assembly 3720 may include at least two lens layers. For example, as shown in FIG. 48, the second lens assembly 3720 may include a fifth lens layer 3721, a sixth lens layer 3722, a seventh lens layer 3723, and an eighth lens layer 3724, but the present disclosure is not limited thereto.

Here, the contents of the lens layer described above may be equally applied, and thus redundant descriptions thereof will be omitted.

Further, the second lens assembly 3720 may include at least two gap layers. For example, as shown in FIG. 48, the second lens assembly 3720 may include a first gap layer 3725, a second gap layer 3726, and a third gap layer 3727, but the present disclosure is not limited thereto.

Here, the contents of the gap layer described above may be equally applied, and thus redundant descriptions thereof will be omitted.

Further, the second lens assembly 3720 may include at least one filter layer. For example, as shown in FIG. 48, the second lens assembly 3720 may include a filter layer 3730, but the present disclosure is not limited thereto.

Further, the second lens assembly 3720 may transmit the laser irradiated from the transmission module 3600 to the laser detecting array 3710. For example, when the first laser, which is irradiated from the transmission module 3600 in the first direction, is reflected from an object positioned in the first direction, the second lens assembly 3720 may transmit the first laser to the laser detecting array 3710, and when the second laser, which is irradiated in the second direction, is reflected from an object positioned in the second direction, the second lens assembly 3720 may transmit the second laser to the laser detecting array 3710, but the present disclosure is not limited thereto.

Further, the second lens assembly 3720 may distribute the lasers irradiated from the transmission module 3600 to at least two different detectors. For example, when the first laser, which is irradiated from the transmission module 3600 in the first direction, is reflected from the object positioned in the first direction, the second lens assembly 3720 may distribute the first laser to the first detector included in the laser detecting array 3710, and when the second laser, which is irradiated in the second direction, is reflected from the object positioned in the second direction, the second lens assembly 3720 may distribute the second laser to the second detector included in the laser detecting array 3710, but the present disclosure is not limited thereto.

Further, the transmission module 3600 may emit a laser at different angles in a viewing angle range, and the second lens assembly 3720 may be designed to reduce noise caused by external light while distributing a plurality of parallel lights, which are incident on the second lens assembly 3720 at different angles in a viewing angle range, to different detectors.

For example, the transmission module 3600) may emit a first laser of a first wavelength at 0 degrees and may emit a second laser of the first wavelength at 30 degrees, the second lens assembly 3720 may distribute the first laser, which is emitted from the transmission module 3600 at 0 degrees and reflected from the object, to the first detector included in the laser detecting array 3710, and the second lens assembly 3720 may distribute the second laser, which is emitted from the transmission module 3600 at 30 degrees and reflected from the object, to the second detector included in the laser detecting array 3710.

In this case, the second lens assembly 3720 may block light in a wavelength band other than a transmission band of the filter layer 3730, and the first wavelength may be included in the transmission band, thereby reducing noise caused by external light.

Hereinafter, a design of a filter layer and a wavelength design of a laser emitting array will be described.

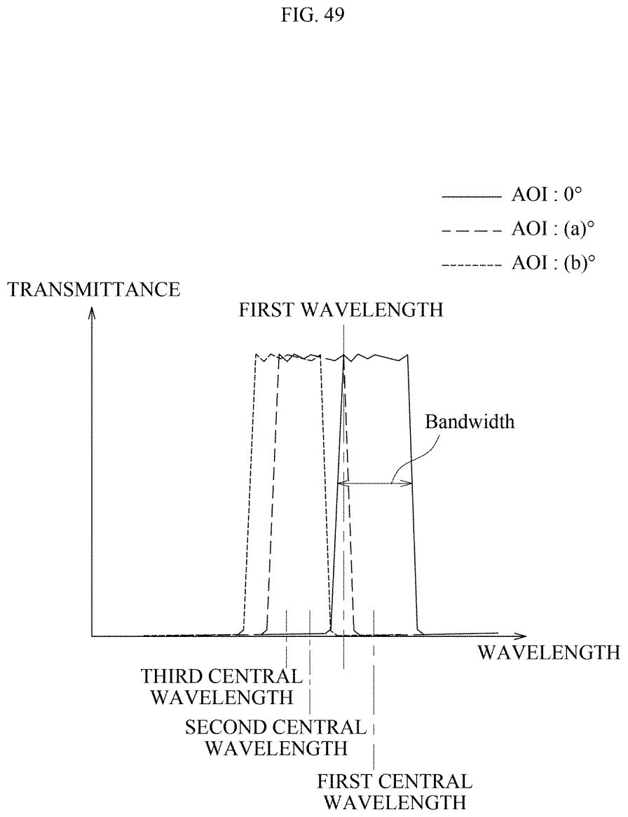

FIG. 49 is a diagram for describing a design of the filter layer 3730 and a wavelength design of the laser emitting array 3610, wherein the filter layer 3730 and the laser emitting array 3610 are included in the LiDAR device 3500 according to one embodiment described with reference to FIG. 48.

Here, for convenience of description, it may be assumed that the second lens assembly 3720 is designed so that angles at which at least some of a plurality of light rays of a plurality of parallel lights, which are incident on the second lens assembly 3720 in a viewing angle range, are incident on a cross section of the second gap layer 3726 of the second lens assembly 3720, in which the filter layer 3730 is positioned, range from 0 degrees to a degrees, and angles at which at least some of the plurality of light rays of the plurality of parallel lights, which are incident on the second lens assembly 3720 in a viewing angle range, are incident on a cross section of the third gap layer 3727 of the second lens assembly 3720, in which the filter layer 3730 is not positioned, range from 0 degrees to b degrees, but the present disclosure is not limited thereto, and the second lens assembly 3720 may be designed in various ways.

Referring to FIG. 49, the filter layer 3730 according to one embodiment may be designed as a band-pass filter that transmits at least a portion of light incident on the filter layer 3730 and blocks the remaining portion of the light.

In this case, the filter layer 3730 may have a bandwidth that transmits at least a portion of the light incident on the filter layer 3730, and the bandwidth may be understood as a full width at half maximum, but is not limited thereto, and may be generally understood as a bandwidth of the band-pass filter for light.

Further, for the light incident on the filter layer 3730, the central wavelength of the filter layer 3730 may be understood as a central wavelength between wavelengths of 50% of the maximum transmittance, but is not limited thereto, and may be generally understood as a central wavelength of the band-pass filter for light.

Further, the central wavelength of the filter layer 3730 may be changed according to an angle of the light incident on the filter layer 3730.

For example, as shown in FIG. 49, the filter layer 3730 may be designed to have a first central wavelength for light that is incident on the filter layer 3730 at 0 degrees, may be designed to have a second central wavelength for light incident on the filter layer 3730 at a degrees, and may be designed to have a third central wavelength for light incident on the filter layer 3730 at b degrees, but the present disclosure is not limited thereto.

Further, as shown in FIG. 49, the bandwidth of the filter layer 3730 may be designed to be greater than or equal to a difference value between the first central wavelength and the second central wavelength.

Further, as shown in FIG. 49, the filter layer 3730 may be designed such that a transmission band for light incident at 0 degrees and a transmission band for light incident at a degrees at least partially overlap each other, but the present disclosure is not limited thereto.

Further, as shown in FIG. 49, the filter layer 3730 may be designed such that the transmission band for the light incident at 0 degrees and the transmission band for the light incident at a degrees share at least one wavelength band, but the present disclosure is not limited thereto.

Further, as shown in FIG. 49, the bandwidth of the filter layer 3730 may be designed to be less than or equal to a difference value between the first central wavelength and the third central wavelength, but the present disclosure is not limited thereto.

Further, as shown in FIG. 49, the filter layer 3730 may be designed such that the transmission band for the light incident at 0 degrees and the transmission band for the light incident at b degrees do not overlap each other, but the present disclosure is not limited thereto.

Further, as shown in FIG. 49, an emitted wavelength of the laser emitting array 3610 may be designed to be a first wavelength, and the first wavelength may be positioned between the first central wavelength and the second central wavelength, but the present disclosure is not limited thereto.

Further, as shown in FIG. 49, the emitted wavelength of the laser emitting array 3610 may be designed to be a first wavelength, and the first wavelength may be designed to be included in a transmission band of the filter layer 3730 for light incident at 0 degrees, and to be included in the transmission band of the filter layer 3730 for the light incident at a degrees and not included in the filter layer 3730 for the light incident at b degrees, but the present disclosure is not limited thereto.

Further, the bandwidth of the filter layer 3730 may be designed to be at least twice a value obtained from (the first central wavelength-the first wavelength) nm, but the present disclosure is not limited thereto.

The above-described contents are merely one embodiment for the wavelength of the filter layer and the laser emitting array, but the present disclosure is not limited thereto, and the wavelength of the filter layer and the laser emitting array may be designed in various ways to reduce the bandwidth of the filter layer and receive the laser emitted from the laser emitting array without loss as much as possible.

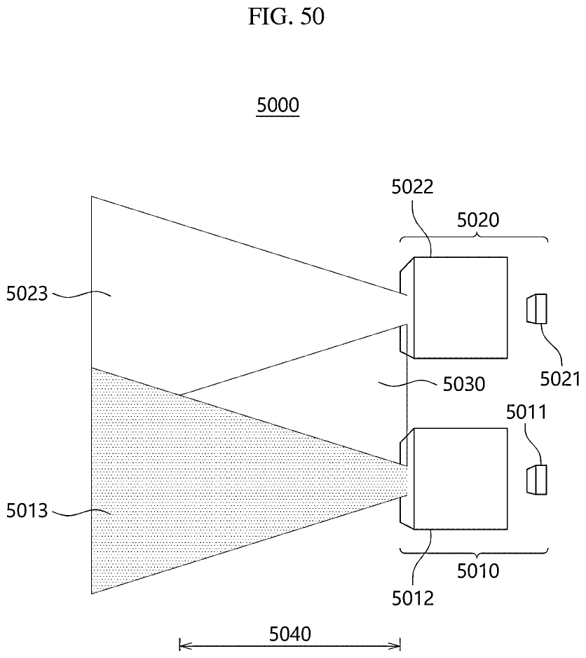

FIG. 50 is a diagram for describing a LiDAR device and a dead zone and a minimum measurement distance of the LiDAR device according to one embodiment.

Referring to FIG. 50, a LiDAR device 5000 according to one embodiment may include a transmission module 5010 and a reception module 5020.

In addition, the transmission module 5010 may include a laser emitting array 5011 and a first optic unit 5012, but the present invention is not limited thereto.

In this case, since the contents of the above-described laser emitting unit or laser emitting array may be applied to the laser emitting array 5011, repetitive descriptions will be omitted.

In addition, since the contents of the above-described lens assembly and the like may be applied to the first optic unit 5012, repetitive descriptions will be omitted.

Furthermore, the laser emitting array 5011 may emit one or more lasers. For example, the laser emitting array 5011 may emit a plurality of lasers, but the present invention is not limited thereto.

In addition, the laser emitting array 5011 may emit one or more lasers with a first wavelength. For example, the laser emitting array 5011 may emit one or more lasers in a wavelength band of 940 nm and may emit a plurality of lasers in a wavelength band of 940 nm, but the present invention is not limited thereto.

Furthermore, the wavelength bands of the plurality of lasers emitted from the laser emitting array 5011 may be partially different from each other but may be included in a certain wavelength band range.

For example, the wavelength bands of the plurality of lasers emitted from the laser emitting array 5011 may be included in a wavelength range of 935 nm to 945 nm, but the present invention is not limited thereto.

In addition, the wavelength bands of the plurality of lasers emitted from the laser emitting array 5011 may be included in a wavelength range of 930 nm to 940 nm, but the present invention is not limited thereto.

Furthermore, the first optic unit 5012 may steer a laser emitted from the laser emitting array 5011. For example, the first optic unit 5012 may steer a first laser emitted from the laser emitting array 5011 in a first direction and may steer a second laser emitted from the laser emitting array 5011 in second direction, but the present invention is not limited thereto.

In addition, the first optic unit 5012 may steer a plurality of lasers emitted from the laser emitting array 5011 so as to radiate the plurality of lasers at different angles within a range of x° to y°. For example, the first optic unit 5012 may steer the first laser in the first direction so as to radiate the first laser emitted from the laser emitting array 5011 at an angle of x° and may steer the second laser in the second direction so as to radiate the second laser emitted from the laser emitting array 5011 at an angle of y°, but the present invention is not limited thereto.

In addition, an irradiation area of lasers emitted from the laser emitting array 5011 and steered through the first optic unit 5012 may be defined as an emitting field of view (FoV). In FIG. 50, the irradiation area of the lasers emitted from the laser emitting array 5011 and steered through the first optic unit 5012 is schematized and expressed two-dimensionally.

Accordingly, the emitting FoV 5013 may be understood as an irradiation area of a plurality of lasers emitted from the laser emitting array 5011 and steered through the first optic unit 5012.

In addition, the reception module 5020 may include a laser detecting array 5021 and a second optic unit 5022, but the present invention is not limited thereto.

In this case, since the contents of the above-described detector unit and the like may be applied to the laser detecting array 5021, repetitive descriptions will be omitted.

In addition, the laser detecting array 5021 may detect one or more lasers. For example, the laser detecting array 5021 may detect a plurality of lasers.

In addition, the laser detecting array 5021 may include a plurality of detectors. For example, the laser detecting array 5021 may include a first detector and a second detector, but the present invention is not limited thereto.

Furthermore, the plurality of detectors included in the laser detecting array 5021 may receive different lasers. For example, the first detector included in the laser detecting array 5021 may receive the first laser received in the first direction, and the second detector may receive the second laser received in the second direction, but the present invention is not limited thereto.

In addition, the second optic unit 5022 may transmit a laser radiated from the transmission module 5010 to the laser detecting array 5021. For example, when the first laser in the first direction radiated from the transmission module 5010 is reflected from an object located in the first direction, the second optic unit 5022 may transmit the first laser to the laser detecting array 5021, and when the second laser radiated in the second direction is reflected from an object located in the second direction, the second optic unit 5022 may transmit the second laser to the laser detecting array 5021, but the present invention is not limited thereto.

In addition, the second optic unit 5022 may distribute lasers, which are radiated from the transmission module 5010 and are received from different directions, to two or more different detectors. For example, when the first laser radiated in the first direction from the transmission module 5010 is reflected from an object located in the first direction, the second optic unit 5022 may distribute the first laser to the first detector included in the laser detecting array 5021, and when the second laser radiated in the second direction is reflected from an object located in the second direction, the second optic unit 5022 may distribute the second laser to the second detector included in the laser detecting array 5021, but the present invention is not limited thereto.

In addition, an area in which the plurality of detectors included in the laser detecting array 5021 can obtain light may be defined as a detecting FoV. In FIG. 50, the area in which the plurality of detectors included in the laser detecting array 5021 can obtain light is schematized and expressed two-dimensionally.

Accordingly, the detecting FoV 5023 may be understood as an area in which the plurality of detectors included in the laser detecting array 5021 can obtain light through the second optic unit 5022.

In the LiDAR device 5000 according to the above-described embodiment, a dead zone may occur in which it is difficult to measure a distance to an object within a maximum measurement distance range.

Referring to FIG. 50, a dead zone 5030 occurring in the LiDAR device 5000 according to one embodiment may be an area in which the emitting FoV 5013 and the detecting FoV 5023 do not overlap each other.

For example, the dead zone 5030 occurring in the LiDAR device 5000 according to one embodiment may be an area in which a laser reflected in the emitting FoV 5013 is not received by the laser detecting array 5021 because the emitting FoV 5013 and the detecting FoV 5023 do not overlap each other, but the present invention is not limited thereto.

In addition, since the dead zone 5030 occurring in the LiDAR device 5000 according to one embodiment occurs in a short distance area, a concept of a minimum measurement distance may be applied to the LiDAR device 5000 according to one embodiment.

For example, the LiDAR device 5000 according to one embodiment may have a first minimum measurement distance 5040, and it may be difficult to acquire distance information about an object located within a range of the first minimum measurement distance 5040.

Accordingly, various embodiments capable of minimizing a minimum measurement distance and a dead zone of a LiDAR device according to one embodiment will be described in more detail below.

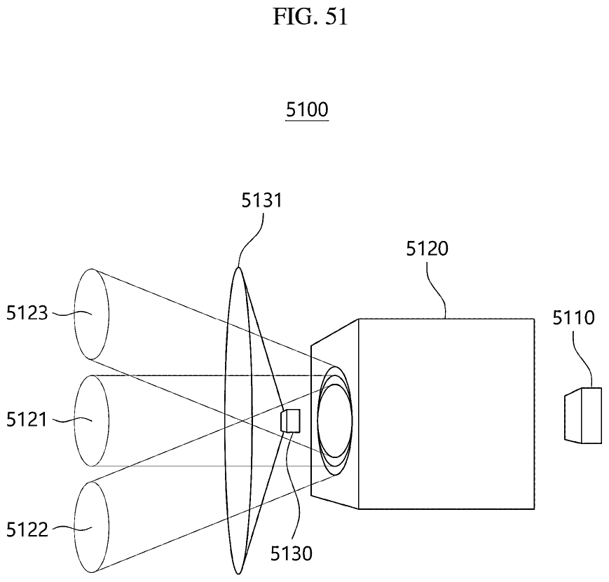

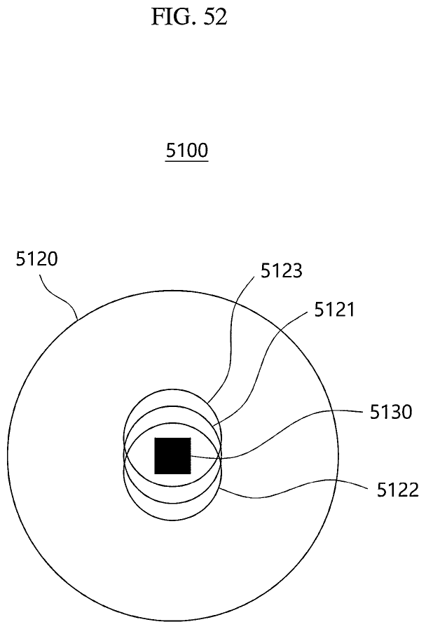

FIGS. 51 and 52 are diagrams for describing a transmission module included in a LiDAR device according to one embodiment.

Referring to FIGS. 51 and 52, a transmission module 5100 included in the LiDAR device according to one embodiment may include a laser emitting array 5110, a first optic unit 5120, and a sub-optic unit 5130.

In this case, since the contents of the above-described laser emitting unit, laser emitting array, and the like may be applied to the laser emitting array 5110, repetitive descriptions will be omitted.

In addition, since the contents of the above-described lens assembly, first optic unit, and the like may be applied to the first optic unit 5120, repetitive descriptions will be omitted.

The laser emitting array 5110 according to one embodiment may include a plurality of emitting units. Hereinafter, for convenience of description, a first emitting unit, a second emitting unit, and a third emitting unit will be mainly described.

In addition, the first emitting unit may emit a first laser 5121, the second emitting unit may emit a second laser 5122, and the third emitting unit may emit a third laser 5123.

In this case, the first laser 5121 emitted from the first emitting unit may be steered in a first direction through the first optic unit 5120, the second laser 5122 emitted from the second emitting unit may be steered in a second direction through the first optic unit 5120, and the third laser 5123 emitted from the third emitting unit may be steered in a third direction through the first optic unit 5120.

The sub-optic unit 5130 according to one embodiment may be configured to diffuse at least a portion of a laser that is emitted from the laser emitting array 5110 and is steered through the first optic unit 5120.

For example, the sub-optic unit 5130 according to one embodiment may be disposed to diffuse at least a portion of the first laser 5121 that is emitted from the first emitting unit included in the laser emitting array 5110 and is steered in the first direction through the first optic unit 5120, but the present invention is not limited thereto.

In addition, for example, the sub-optic unit 5130 according to one embodiment may be disposed to diffuse at least a portion of the second laser 5122 that is emitted from the second emitting unit included in the laser emitting array 5110 and is steered in the second direction through the first optic unit 5120, but the present invention is not limited thereto.

Furthermore, for example, the sub-optic unit 5130 according to one embodiment may be disposed to diffuse at least a portion of the third laser 5123 that is emitted from the third emitting unit included in the laser emitting array 5110 and is steered in the third direction through the first optic unit 5120, but the present invention is not limited thereto.

In addition, a reason why the sub-optic unit 5130 according to one embodiment is disposed to diffuse at least a portion of a laser emitted from the laser emitting array 5110 and steered through the first optic unit 5120 may be to diffuse only a portion of a laser for long-distance measurement, thereby reducing a minimum measurement distance and a dead zone of a LiDAR device and minimizing a reduction in irradiation efficiency of the laser for long-distance measurement, but the present invention is not limited thereto.

In addition, the sub-optic unit 5130 according to one embodiment may be disposed on an optical path through which lasers emitted from the laser emitting array 5110 are guided by the first optic unit 5120.

For example, the sub-optic unit 5130 according to one embodiment may be disposed on an optical path through which the first laser 5121 emitted from the first emitting unit included in the laser emitting array 5110 is guided by the first optic unit 5120, but the present invention is not limited thereto.

In addition, for example, the sub-optic unit 5130 according to one embodiment may be disposed on an optical path through which the second laser 5122 emitted from the second emitting unit included in the laser emitting array 5110 is guided by the first optic unit 5120, but the present invention is not limited thereto.

Furthermore, for example, the sub-optic unit 5130 according to one embodiment may be disposed on an optical path through which the third laser 5123 emitted from the third emitting unit included in the laser emitting array 5110 is guided by the first optic unit 5120, but the present invention is not limited thereto.

In addition, in order to diffuse only a portion of a laser emitted from the laser emitting array 5110, the sub-optic unit 5130 according to one embodiment may be designed to have a size that is less than a diameter of a pupil of the first optic unit 5120.

For example, as shown in FIG. 52, a length of one side of the sub-optic unit 5130 may be designed to be less than a diameter of a pupil of an outermost lens of the first optic unit 5120, but the present invention is not limited thereto.

In addition, in order to diffuse only a portion of a laser emitted from the laser emitting array 5110, the sub-optic unit 5130 according to one embodiment may be designed to have a size that is less than a diameter of each of lasers emitted from the laser emitting array 5110.

In this case, the diameter of each of the lasers emitted from the laser emitting array 5110 may be defined as a diameter of each of the lasers on a surface on which the sub-optic unit 5130 is disposed.

For example, as shown in FIG. 52, the sub-optic unit 5130 according to one embodiment may be designed to have a size that is less than a diameter of the first laser 5121 emitted from the first emitting unit included in the laser emitting array 5110, but the present invention is not limited thereto.

In this case, the diameter of the first laser 5121 may be defined as a diameter of the first laser 5121 on a surface on which the sub-optic unit 5130 is disposed.

In addition, for example, as shown in FIG. 52, the sub-optic unit 5130 according to one embodiment may be designed to have a size that is less than a diameter of the second laser 5122 emitted from the second emitting unit included in the laser emitting array 5110, but the present invention is not limited thereto.

In this case, the diameter of the second laser 5122 may be defined as a diameter of the second laser 5122 on a surface on which the sub-optic unit 5130 is disposed.

In addition, for example, as shown in FIG. 52, the sub-optic unit 5130 according to one embodiment may be designed to have a size that is less than a diameter of the third laser 5123 emitted from the third emitting unit included in the laser emitting array 5110, but the present invention is not limited thereto.

In this case, the diameter of the third laser 5123 may be defined as a diameter of the third laser 5123 on a surface on which the sub-optic unit 5130 is disposed.

In addition, the sub-optic unit 5130 may have an FoV different from an emitting FoV formed by the first optic unit 5120.

For example, the FoV of the sub-optic unit 5130 may be greater than the FoV of the first optic unit 5120, but the present invention is not limited thereto.

In addition, for example, a direction of the FoV of the sub-optic unit 5130 may be different from a direction of the FoV of the first optic unit 5120, but the present invention is not limited thereto.

Furthermore, the sub-optic unit 5130 may be disposed to have an asymmetric FoV with respect to a center of the laser emitting array 5110.

For example, the sub-optic unit 5130 may be disposed to diffuse at least a portion of a laser at an angle of 17° in an upward direction and an angle of 5° in a downward direction with respect to the center of the laser emitting array 5110, but the present invention is not limited thereto.

In addition, for example, the sub-optic unit 5130 may be disposed to diffuse at least a portion of a laser at an angle of 17° in a direction in which a reception module (not shown) is located and an angle of 5° in a direction in which the reception module (not shown) is not located with respect to the center of the laser emitting array 5110, but the present invention is not limited thereto.

Furthermore, for example, the sub-optic unit 5130 may be disposed such that a degree in which a laser is diffused in the direction in which the reception module (not shown) is located is greater than a degree in which a laser is diffused in the direction in which the reception module (not shown) is not located with respect to the center of the laser emitting array 5110, but the present invention is not limited thereto.

In addition, the sub-optic unit 5130 may be disposed to have an asymmetric FoV with respect to the center of the first optic unit 5120.

For example, the sub-optic unit 5130 may be disposed to diffuse at least a portion of a laser at an angle of 17° in an upward direction and an angle of 5° in a downward direction with respect to the center of the first optic unit 5120, but the present invention is not limited thereto.

In addition, for example, the sub-optic unit 5130 may be disposed to diffuse at least a portion of a laser at an angle of 17° in a direction in which the reception module (not shown) is located and an angle of 5° in a direction in which the reception module (not shown) is not located with respect to the center of the first optic unit 5120, but the present invention is not limited thereto.

Furthermore, for example, the sub-optic unit 5130 may be disposed such that a degree in which a laser is diffused in the direction in which the reception module (not shown) is located is greater than a degree in which a laser is diffused in the direction in which the reception module (not shown) is not located with respect to the center of the first optic unit 5120, but the present invention is not limited thereto.

In addition, the sub-optic unit 5130 may include a diffuser so as to diffuse at least a portion of lasers emitted from the laser emitting array 5110.

In addition, as shown in FIG. 52, a center of the sub-optic unit 5130 may be aligned with the center of the first optic unit 5120, but the present invention is not limited thereto.

In addition, the sub-optic unit 5130 may be disposed in an area in which optical paths, through which lasers emitted from the laser emitting array 5110 are guided by the first optic unit 5120, overlap each other, but the present invention is not limited thereto.

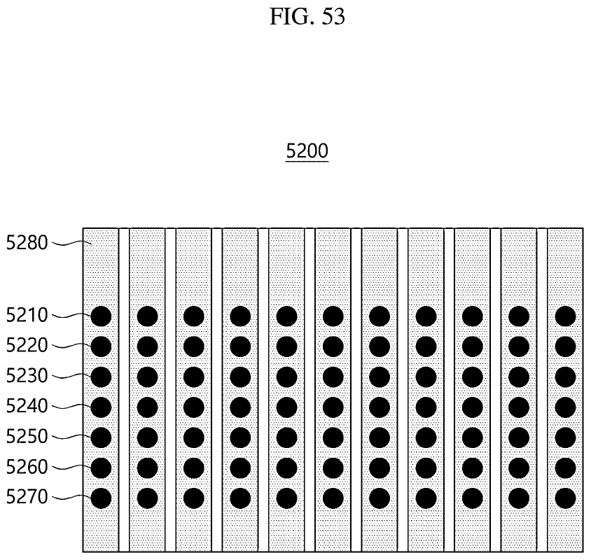

FIG. 53 is a diagram for describing a laser radiated through a transmission module according to one embodiment.

Referring to FIG. 53, a laser 5200 radiated through the transmission module according to one embodiment may include lasers that are emitted from the above-described laser emitting array and are steered through the above-described first optic unit and lasers that are emitted from the above-described laser emitting array, are steered through the above-described first optic unit, and are diffused through the above-described sub-optic unit.

Hereinafter, for more detailed description, descriptions will be made using first to seventh emitting units located in an N^{th} column included in the laser emitting array and first to seventh lasers emitted from the first to seventh emitting units.

According to one embodiment, lasers emitted from the first to seventh emitting units included in the laser emitting array may be steered in different directions through the first optic unit and radiated onto a scan area as first to seventh point lasers 5210 to 5270.

In this case, the point laser may refer to a laser having a laser divergence angle that is less than or equal to a certain range. For example, the point laser may refer to a laser having a laser divergence angle of 1.5° or less, but the present invention is not limited to numerical values. The point laser may include a concept of a point laser in a range that can be understood by those skilled in the art.

In addition, according to one embodiment, the lasers emitted from the first to seventh emitting units included in the laser emitting array may be steered in different directions through the first optic unit, and then at least portions thereof may be diffused through the sub-optic unit to be radiated onto a scan area as line or plane lasers 5280.

In this case, the line or plane laser may refer to a laser having a line or plane shape, but the present invention is not limited thereto. The line or plane laser may include a concept of a line or plane laser in a range that can be understood by those skilled in the art.

In addition, the above-described point laser may be a laser having a divergence angle that is less than or equal to a certain range. Loss of energy density according to traveling of a laser may be small, and thus, the point laser may be usefully used to measure a distance to an object located at a long distance.

In addition, the above-described line or plane laser may be a laser having a divergence angle that is greater than or equal to a certain range. Loss of energy density according to traveling of a laser is greater, and thus, the line or plane laser may not be suitable for measuring a distance to an object located at a long distance. However, the line or plane laser may be usefully used to minimize a minimum measurement distance of a LiDAR device and to minimize a dead zone in a short distance area.

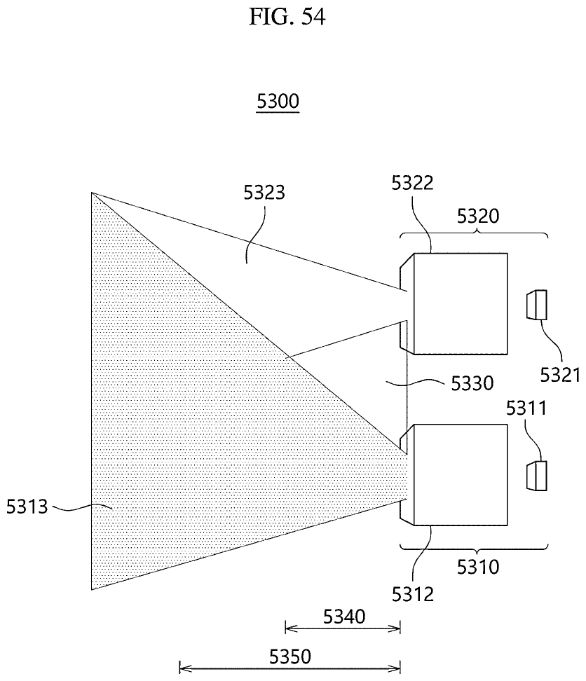

FIG. 54 is a diagram for describing a LiDAR device and a dead zone and a minimum measurement distance of the LiDAR device according to one embodiment.

Prior to description with reference to FIG. 54, it should be noted that FIG. 54 is a diagram for mainly describing the LiDAR device described with reference to FIGS. 51 to 53.

Referring to FIG. 54, a LiDAR device 5300 according to one embodiment may include a transmission module 5310 and a reception module 5320.

In addition, the transmission module 5310 may include a laser emitting array 5311 and a first optic unit 5312, but the present invention is not limited thereto.

In this case, since the contents of the above-described laser emitting unit or laser emitting array may be applied to the laser emitting array 5311, repetitive descriptions will be omitted.

In addition, since the contents of the above-described lens assembly and the like may be applied to the first optic unit 5312, repetitive descriptions will be omitted.

In this case, the first optic unit 5312 may be understood as a concept including the above-described first optic unit and the above-described sub-optic unit.

For example, the first optic unit 5312 may be understood as an integrated concept including a bulk optic unit (the above-described first optic unit) and a sub-optic unit which are for steering a laser.

In addition, an irradiation area of lasers emitted from the laser emitting array 5311 and steered or diffused through the first optic unit 5312 may be defined as an emitting FoV. In FIG. 54, the irradiation area of the lasers emitted from the laser emitting array 5311 and steered or diffused through the first optic unit 5312 is schematized and expressed two-dimensionally.

Accordingly, an emitting FoV 5313 may be understood as an irradiation area of a plurality of lasers emitted from the laser emitting array 5311 and steered or diffused through the first optic unit 5312

In addition, the reception module 5320 may include a laser detecting array 5321 and a second optic unit 5322, but the present invention is not limited thereto.

In this case, since the contents of the above-described detector unit and the like may be applied to the laser detecting array 5321, repetitive descriptions will be omitted.

In addition, since the contents of the above-described second lens assembly, the second optic unit, and the like may be applied to the second optic unit 5322, repetitive descriptions will be omitted.

In addition, an area in which a plurality of detectors included in the laser detecting array 5321 can obtain light may be defined as a detecting FoV. In FIG. 54, the area in which the plurality of detectors included in the laser detecting array 5321 can obtain light is schematized and expressed two-dimensionally.

Accordingly, the detecting FoV 5323 may be understood as an area in which the plurality of detectors included in the laser detecting array 5321 can obtain light through the second optic unit 5322.

In the LiDAR device 5300 according to one embodiment, a dead zone may occur in which it is difficult to measure a distance to an object within a maximum measurement distance range.

Referring to FIG. 54, a dead zone 5330 occurring in the LiDAR device 5300 according to one embodiment may be an area in which the emitting FoV 5313 and the detecting FoV 5323 do not overlap each other.

For example, the dead zone 5330 occurring in the LiDAR device 5300 according to one embodiment may be an area in which a laser reflected in the emitting FoV 5313 is not received by the laser detecting array 5321 because the emitting FoV 5313 and the detecting FoV 5323 do not overlap each other, but the present invention is not limited thereto.

In addition, since the dead zone 5330 occurring in the LiDAR device 5300 according to one embodiment occurs in a short distance area, a concept of a minimum measurement distance may be applied to the LiDAR device 5300 according to one embodiment.

For example, the LiDAR device 5300 according to one embodiment may have a first minimum measurement distance 5340, and it may be difficult to acquire distance information about an object located within a range of the first minimum measurement distance 5340.

In this case, a second minimum measurement distance 5350 shown in FIG. 54 may be a minimum measurement distance of the LiDAR device according to one embodiment described with reference to FIG. 50, and referring to FIG. 54, according to one embodiment, the first minimum measurement distance 5340 that is a minimum measurement distance of a LiDAR device including a sub-optic unit may be shorter than the second minimum measurement distance 5350 that is a minimum measurement distance of a LiDAR device not including a sub-optic unit.

In addition, referring to FIG. 54, the dead zone 5330 of the LiDAR device including the sub-optic unit according to one embodiment may be smaller than a dead zone of the LiDAR device not including the sub-optic unit according to one embodiment shown in FIG. 50.

Hereinafter, various embodiments of a sub-optic unit will be described in more detail.

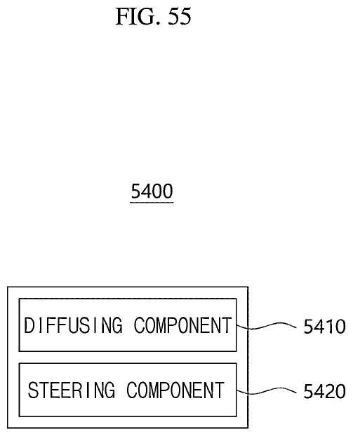

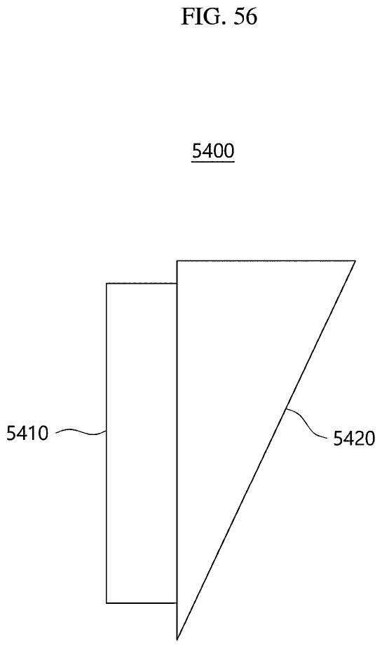

FIGS. 55 and 56 are diagrams for describing a sub-optic unit according to one embodiment.

Referring to FIGS. 55 and 56, a sub-optic unit 5400 according to one embodiment may include a diffusing component 5410 and a steering component 5420.

As described above, in order to minimize a dead zone and a minimum measurement distance of a LiDAR device, a sub-optic unit for diffusing at least a portion of a laser emitted from a laser emitting array may be required.

In this case, as a diffusion degree of a laser diffused from the sub-optic unit is increased, a degree, in which an energy density of the diffused laser is decreased according to a distance, may be increased. Accordingly, it may be necessary to increase a distance area, which may be covered using the diffused laser, by minimizing the dead zone and the minimum measurement distance of the LiDAR device and decreasing the degree in which the energy density of the diffused laser is decreased according to the distance.

That is, when at least a portion of the laser emitted from the laser emitting array is diffused so as to cover the dead zone and the minimum measurement distance, the diffusion degree is decreased, and directionality is given to the diffused laser, as described above, it is possible to increase a distance area, which may be covered using the diffused laser, by minimizing the dead zone and the minimum measurement distance of the LiDAR device and decreasing the degree in which the energy density of the diffused laser is decreased according to the distance.

The diffusing component 5410 according to one embodiment may be configured to diffuse at least a portion of a laser that is emitted from the laser emitting array and is steered through the above-described first optic unit.

For example, the diffusing component 5410 according to one embodiment may be disposed to diffuse at least a portion of a first laser that is emitted from a first emitting unit included in the laser emitting array and is steered in a first direction through the first optic unit, but the present invention is not limited thereto.

In addition, the diffusing component 5410 according to one embodiment may be disposed on an optical path through which lasers emitted from the laser emitting array are guided by the first optic unit.

For example, the diffusing component 5410 according to one embodiment may be disposed on an optical path through which the first laser emitted from the first emitting unit included in the laser emitting array is guided by the first optic unit, but the present invention is not limited thereto.

In addition, in order to diffuse only a portion of a laser emitted from the laser emitting array, the diffusing component 5410 according to one embodiment may be designed to have a size that is less than a diameter of a pupil of the first optic unit.

For example, a length of one side of the diffusing component 5410 may be designed to be less than a diameter of a pupil of an outermost lens of the first optic unit, but the present invention is not limited thereto.

In addition, in order to diffuse only a portion of a laser emitted from the laser emitting array, the diffusing component 5410 according to one embodiment may be designed to have a size that is less than a diameter of each of lasers emitted from the laser emitting array.

In this case, the diameter of each of the lasers emitted from the laser emitting array may be defined as a diameter of each of the lasers on a surface on which the diffusing component 5410 is disposed.

In addition, the diffusing component 5410 according to one embodiment may have an FoV different from an emitting FoV formed by the first optic unit.

For example, the FoV of the diffusing component 5410 may be less than the FoV of the first optic unit, but the present invention is not limited thereto

In addition, a center of the diffusing component 5410 according to one embodiment may be aligned with a center of the first optic unit, but the present invention is not limited thereto.

Furthermore, the diffusing component 5410 according to one embodiment may be disposed in an area in which optical paths, along which lasers emitted from the laser emitting array are guided by the first optic unit, overlap each other, but the present invention is not limited thereto.

In addition, the diffusing component 5410 according to one embodiment may include a diffuser so as to diffuse at least a portion of lasers emitted from the laser emitting array.

Furthermore, the steering component 5420 according to one embodiment may be configured to steer at least a portion of a laser that is emitted from the laser emitting array and is steered through the above-described first optic unit.

For example, the steering component 5420 according to one embodiment may be disposed to steers at least a portion of the first laser that is emitted from the first emitting unit included in the laser emitting array and is steered in the first direction through the first optic unit, but the present invention is not limited thereto.

In addition, the steering component 5420 according to one embodiment may be disposed on an optical path through which lasers emitted from the laser emitting array are guided by the first optic unit.

For example, the steering component 5420 according to one embodiment may be disposed on an optical path through which the first laser emitted from the first emitting unit included in the laser emitting array is guided by the first optic unit, but the present invention is not limited thereto

In addition, in order to diffuse only a portion of a laser emitted from the laser emitting array, the steering component 5420 according to one embodiment may be designed to have a size that is less than the diameter of the pupil of the first optic unit.

For example, the length of one side of the steering component 5420 may be designed to be less than the diameter of the pupil of the outermost lens of the first optic unit, but the present invention is not limited thereto.

In addition, in order to diffuse only a portion of a laser emitted from the laser emitting array, the steering component 5420 according to one embodiment may be designed to have a size that is less than a diameter of each of lasers emitted from the laser emitting array.

In this case, the diameter of each of the lasers emitted from the laser emitting array may be defined as a diameter of each of the lasers on a surface on which the steering component 5420 is disposed.

In addition, the center of the steering component 5420 according to one embodiment may be aligned with the center of the first optic unit, but the present invention is not limited thereto.

Furthermore, the steering component 5420 according to one embodiment may be disposed in an area in which optical paths, along which lasers emitted from the laser emitting array are guided by the first optic unit, overlap each other, but the present invention is not limited thereto.

In addition, the steering component 5420 according to one embodiment may include a prism so as to steer at least a portion of lasers emitted from the laser emitting array, but the present invention is not limited thereto.

Furthermore, the steering component 5420 according to one embodiment may be disposed to steer at least a portion of lasers emitted from the laser emitting array in a direction in which a reception module is disposed, but the present invention is not limited thereto.

In addition, the steering component 5420 according to one embodiment may be disposed closer to the first optic unit or the laser emitting array than the diffusing component 5410.

Furthermore, the diffusing component 5410 and the steering component 5420 according to one embodiment may be disposed such that a laser emitted from the laser emitting array passes through the first optic unit, passes through the steering component 5420, and then passes through the diffusing component 5410.

For example, the diffusing component 5410 and the steering component 5420 according to one embodiment may be disposed to steer at least a portion of the first laser, which is emitted from the first emitting unit included in the laser emitting array and is steered in the first direction through the first optic unit, in a second direction and then diffuse the at least a portion of the first laser, but the present invention is not limited thereto.

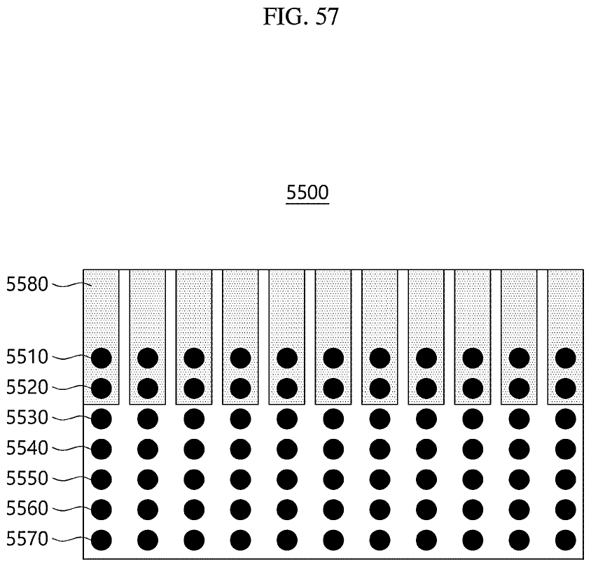

FIG. 57 is a diagram for describing a laser radiated through a transmission module according to one embodiment.

Referring to FIG. 57, a laser 5500 radiated through the transmission module according to one embodiment may include lasers that are emitted from the above-described laser emitting array and are steered through the above-described first optic unit and lasers that are emitted from the above-described laser emitting array, are steered through the above-described first optic unit, and are steered and diffused through the above-described sub-optic unit.

Hereinafter, for more detailed description, descriptions will be made using first to seventh emitting units located in an N^{th} column included in the laser emitting array and first to seventh lasers emitted from the first to seventh emitting units.

According to one embodiment, lasers emitted from the first to seventh emitting units included in the laser emitting array may be steered in different directions through the first optic unit and radiated onto a scan area as first to seventh point lasers 5510 to 5570.

In this case, the point laser may refer to a laser having a laser divergence angle that is less than or equal to a certain range. For example, the point laser may refer to a laser having a laser divergence angle of 1.5° or less, but the present invention is not limited to numerical values. The point laser may include a concept of a point laser in a range that can be understood by those skilled in the art.

In addition, according to one embodiment, the lasers emitted from the first to seventh emitting units included in the laser emitting array may be steered in different directions through the first optic unit, and then at least portions thereof may be diffused through the sub-optic unit to be radiated onto a scan area as line or plane lasers 5580.

In this case, the line or plane laser may refer to a laser having a line or plane shape, but the present invention is not limited thereto. The line or plane laser may include a concept of a line or plane laser in a range that can be understood by those skilled in the art.

In addition, the above-described point laser may be a laser having a divergence angle that is less than or equal to a certain range. Loss of energy density according to traveling of a laser may be small, and thus, the point laser may be usefully used to measure a distance to an object located at a long distance.

In addition, the above-described line or plane laser may be a laser having a divergence angle that is greater than or equal to a certain range. Loss of energy density according to traveling of a laser is greater, and thus, the line or plane laser may not be suitable for measuring a distance to an object located at a long distance. However, the line or plane laser may be usefully used to minimize a minimum measurement distance of a LiDAR device and to minimize a dead zone in a short distance area.

Furthermore, referring to FIG. 57, unlike that shown in FIG. 53, it can be seen that a diffusion degree of the line or plane lasers 5580 is small and diffusion directions of the line or plane lasers 5580 are different.

As shown in FIG. 57, a distance that may be covered using the line or plane laser 5580 having a small diffusion degree may be longer than a distance that may be covered using the line or plane laser 5580 having a great diffusion degree.

In addition, as shown in FIG. 57, when the above-described sub-optic unit includes a diffusing component and a steering component, since the line or plane laser 5580, which has directionality for effectively covering a dead zone by the steering component and is partially diffused by the diffusing component, is radiated onto a scan area, it is possible to manufacture a LiDAR device in which it is possible to more efficiently minimize a dead zone and a minimum measurement distance of the LiDAR device and to increase a distance area that may be covered using the line or plane laser 5580.

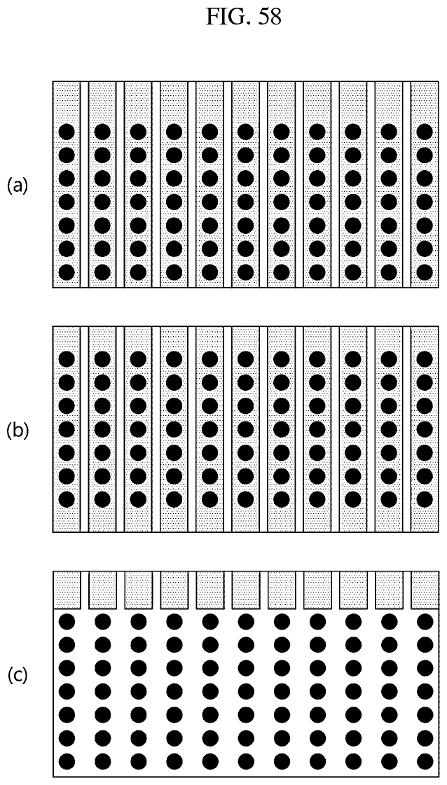

FIG. 58 shows diagrams for describing various embodiments of a laser radiated through a transmission module.

The contents described with reference to FIGS. 50 to 57 may be used to derive various embodiments of a laser radiated through the transmission module.

For example, as shown in FIG. 58A, lasers radiated through the transmission module may include line or plane lasers in which some of the lasers emitted from the laser emitting array are diffused asymmetrically.

In addition, for example, as shown in FIG. 58B, lasers radiated through the transmission module may include line or plane lasers in which some of the lasers emitted from the laser emitting array are diffused symmetrically.

Furthermore, for example, as shown in FIG. 58C, lasers radiated through the transmission module may include line or plane lasers in which some of the lasers emitted from the laser emitting array are diffused and have directionality.

In addition, other than the embodiments described with reference to FIG. 58, various embodiments may be derived using the above-described sub-optic unit, which may correspond to an area included in the technical idea of the present invention in which only a portion of a laser emitted from the laser emitting array may be used as a line or plane laser using the sub-optic unit.

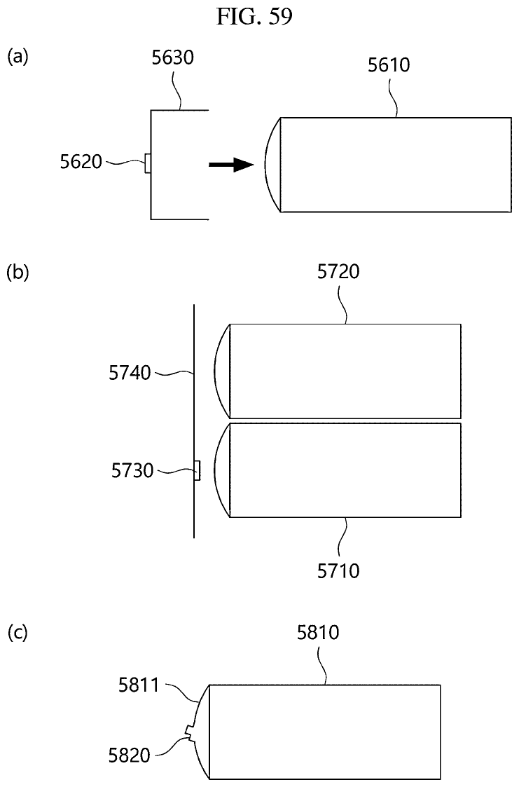

FIG. 59 shows diagrams for describing various embodiments of an arrangement of a sub-optic unit.

Referring to FIG. 59A, a LiDAR device according to one embodiment may include a transmission optic unit 5610 and a sub-optic unit 5620.

In this case, since the contents of the above-described first lens assembly, the first optic unit, and the like may be applied to the transmission optic unit 5610 and the contents of the above-described sub-optic unit and the like may be applied to the sub-optic unit 5620, repetitive descriptions will be omitted.

Referring to FIG. 59A, the sub-optic unit 5620 according to one embodiment may be located on a sub-optic mount 5630.

In this case, as shown in FIG. 59A, the sub-optic unit 5620 may be located outside the sub-optic mount 5630, but the present invention is not limited thereto. The sub-optic unit 5620 may be located inside the sub-optic mount 5630. When the sub-optic unit 5620 includes two or more components, the sub-optic unit 5620 may be located outside and inside the sub-optic mount 5630, but the present invention is not limited thereto.

In addition, the sub-optic mount 5630 may be coupled to the transmission optic unit 5610.

For example, the sub-optic mount 5630 may be formed to be coupled to a body tube forming an outside of the transmission optic unit 5610, but the present invention is not limited thereto.

In addition, referring to FIG. 59B, a LiDAR device according to one embodiment may include a transmission optic unit 5710, a reception optic unit 5720, a sub-optic unit 5730, and a window 5740.

In this case, since the contents of the above-described first lens assembly, first optic unit, and the like may be applied to the transmission optic unit 5710, the contents of the above-described second lens assembly, second optic unit, and the like may be applied to the reception optic unit 5720, and the contents of the above-described sub-optic unit and the like may be applied to the sub-optic unit 5730, repetitive descriptions will be omitted.

Referring to FIG. 59B, the sub-optic unit 5730 according to one embodiment may be located on the window 5740 included in the LiDAR device.

In this case, as shown in FIG. 59B, the sub-optic unit 5730 may be located inside the window 5740, but the present invention is not limited thereto. The sub-optic unit 5730 may be located outside the window 5740. When the sub-optic unit 5730 includes two or more components, the sub-optic unit 5730 may be located outside and inside the window 5740, but the present invention is not limited thereto.

In addition, referring to FIG. 59C, a LiDAR device according to one embodiment may include a transmission optic unit 5810 and a sub-optic unit 5820.

In this case, since the contents of the above-described first lens assembly, first optic unit, and the like may be applied to the transmission optic unit 5810 and the contents of the above-described sub-optic unit and the like may be applied to the sub-optic unit 5820, repetitive descriptions will be omitted.

Referring to FIG. 59C, the sub-optic unit 5820 according to one embodiment may be formed integrally with the transmission optic unit 5810 included in the LiDAR device.

For example, as shown in FIG. 59C, the sub-optic unit 5820 according to one embodiment may be formed as a part of an outermost lens 5811 of the transmission optic unit 5810 to be formed integrally with the transmission optic unit 5810, but the present invention is not limited thereto.

In addition, other than the various embodiments related to the arrangement of the sub-optic unit described with reference to FIG. 59, there may be various embodiments for disposing the sub-optic unit, and such embodiments may be included in the technical spirit of the present invention as modified embodiments of the present invention.

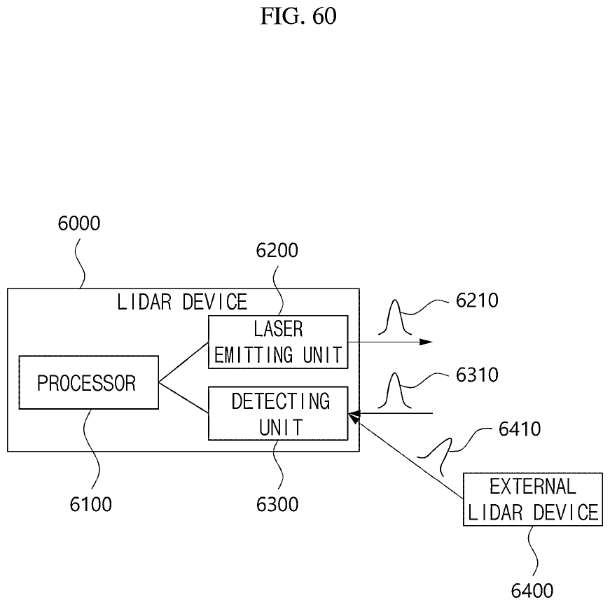

FIG. 60 is a diagram for describing an interference phenomenon with an external device according to one embodiment.

Referring to FIG. 60, a LiDAR device 6000 according to one embodiment may include a processor 6100, a laser emitting unit 6200, and a detecting unit 6300.

The LiDAR device 6000 may be the LiDAR device 1000 of FIG. 1, the LiDAR device 1100 of FIG. 2, or the LiDAR device 1150 of FIG. 3. Since the description of the LiDAR device 6000 may overlap the descriptions of those of FIGS. 1, 2, and 3, detailed descriptions thereof will be omitted.

The processor 6100 may be the control unit 400 of FIG. 1. The processor 6100 may be used interchangeably with the term such as a control part, a controller, or a control unit. Since the description of the processor 6100 may overlap the description of that of FIG. 1, detailed descriptions thereof will be omitted.

The laser emitting unit 6200 may be the laser emitting unit 100 of FIG. 1, 2, or 3. Since the description of the laser emitting unit 6200 may overlap the descriptions of those of FIGS. 1, 2, and 3, detailed descriptions thereof will be omitted.

Since the description of the detecting unit 6300 may overlap the descriptions of those of FIGS. 1, 2, and 3, detailed descriptions thereof will be omitted.

According to one embodiment, the processor 6100 may transmit a control signal for outputting a laser to the laser emitting unit 6200. The laser emitting unit 6200 receiving the control signal may emit a laser 6210 in response to the control signal.

In this case, the laser emitting unit 6200 may include an optic unit. For example, the laser emitting unit 6200 may include a lens for collimating a laser beam. In addition, for example, the laser emitting unit 6200 may include a bulk lens including a plurality of lenses. Thus, the laser 6210 may be a laser collimated through the optic unit.

Alternatively, the laser 6210 emitted from the laser emitting unit 6200 may pass through the optic unit before being radiated onto an object. In this case, the optic unit may be the optic unit 200 of FIG. 1, 2, or 3. Since the description of the optic unit may overlap the description of that of FIG. 1, 2, or 3, detailed descriptions thereof will be omitted.

The laser 6210 may be radiated onto an object or a specific area to be scattered. In this case, a reflected laser 6310 that is a portion of the laser 6210 may be received by the detecting unit 6300.

The detecting unit 6300 may receive the reflected laser 6310 to generate an output signal. The detecting unit 6300 may generate, store, or transmit data sets to the processor 6100 based on the output signal. Alternatively, the processor 6100 may generate or store data sets based on the output signal received from the detecting unit 6300.

In this case, the data set may be a set of pieces of data corresponding to a plurality of time periods. In addition, in this case, the plurality of time periods of the data set may be times corresponding to time bins of a histogram. For example, pieces of data corresponding to the plurality of time periods may be data for 0 ns to 1 ns, data for 1 ns to 2 ns, data for 2 ns to 3 ns, and the like but are not limited to the numerical values.

The processor 6100 may store the plurality of data sets based on the output signal generated by the detecting unit 6300. The processor 6100 may generate a histogram by accumulating the plurality of data sets.

The processor 6100 may acquire a detecting time point at which the reflected laser 6310 is detected by the detecting unit 6300 through the histogram generated by accumulating the plurality of data sets. Since a method of acquiring a detecting time point may overlap that described with reference to FIG. 32, detailed descriptions thereof will be omitted.

According to one embodiment, the detecting unit 6300 may be the SPAD array 750 of FIG. 31. In this case, a plurality of SPADs 751 included in the detecting unit may detect the reflected lasers 6310 reflected from different areas. Accordingly, the processor 6100 may store a plurality of data sets based on output signals generated by the plurality of SPADs 751. Accordingly, the processor 6100 may generate histograms for respective areas.

For example, a first SPAD may detect a laser reflected from a first area. The processor 6100 may generate a first histogram by accumulating a plurality of data sets based on an output signal of the first SPAD.

In addition, for example, a second SPAD may detect a laser reflected from a second area different from the first area. The processor 6100 may generate a second histogram by accumulating a plurality of data sets based on an output signal of the second SPAD.

According to such processes, the processor 6100 may generate N histograms corresponding to N SPADs 751 included in the detecting unit 6300. Accordingly, the processor 6100 may determine characteristics of each area such as a distance and a center point of each of N areas included in an FoV of the detecting unit 6300.

Data generated by an interference laser 6410 emitted from the external device 6400 may be included in a histogram generated when the processor 6100 of the LiDAR device 6000 emits the laser 6210 through the laser emitting unit 6200 and receives the reflected laser 6310 reflected from an object through the detecting unit 6300.

The external device 6400 may be a device which emits another laser rather than the laser 6210 emitted from the LiDAR device 6000. That is, the external device 6400 may be a device which emits the interference laser 6410 rather than the laser 6210 emitted from the LiDAR device 6000.

For example, the external device 6400 may be a LiDAR device included in another vehicle or a LiDAR device different from the LiDAR device 6000, such as a LiDAR device included in a road infrastructure. In addition, for example, the external device 6400 may be a headlight of another vehicle, a laser emitting device of a road infrastructure, or the like. The external device 6400 is not limited to the described devices and may include any device for radiating the interference laser 6410.

When data generated by the interference laser 6410 is included in the histogram generated by the processor 6100, the processor 6100 may inaccurately extract a detecting time point of the reflected laser 6310 reflected from an object.

For example, when data generated by the interference laser 6410 is generated near a specific time bin of a histogram, the data generated by the interference laser 6410 may be allocated to the vicinity of the specific time bin of the histogram in which a plurality of data sets are accumulated.

Specifically, when data generated by the interference laser 6410 is generated in a 20^{th} time bin or near the 20^{th} time bin, the data generated by the interference laser 6410 may be allocated to the 20^{th} time bin or near the 20^{th} time bin in a histogram in which 1,024 data sets are accumulated.

In this case, when data generated by the interference laser 6410 is a numerical value greater than or equal to a threshold value of a histogram, the processor 6100 may erroneously extract the data generated by the interference laser 6410 as data generated by the reflected laser 6310 reflected from an object.

Accordingly, in order to prevent the data generated by the interference laser 6410 from being accumulated to have a numerical value greater than or equal to the threshold value of the histogram, the processor 6100 needs to control a laser emitting time point of the laser emitting unit 6200.

Hereinafter, a data type generated by the interference laser 6410 in a histogram according to control of a laser emitting time point of the laser emitting unit 6200 in the processor 6100 will be described.

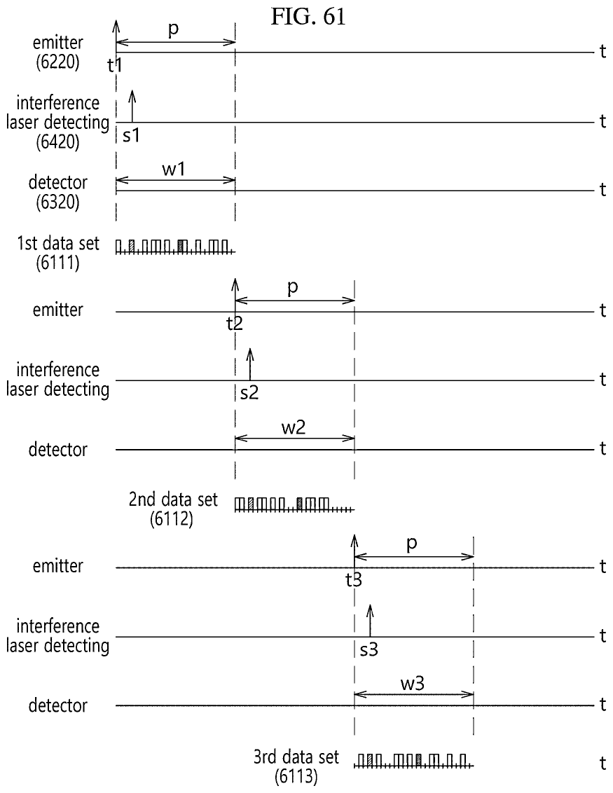

FIG. 61 shows diagrams for describing a plurality of data sets based on a plurality of output signals of a detecting unit according to one embodiment. In particular, FIG. 61 shows diagrams for describing an embodiment in which a laser emitting unit 6200 emits a laser 6210 in a certain period.

When the laser emitting unit 6200 emits the laser 6210 in a certain period, data generated by an interference laser 6410 emitted from an external device 6400 may have a numerical value greater than or equal to a threshold value and may be included in a histogram generated by the processor 6100.

Accordingly, when the processor 6100 extracts a detecting time point of a reflected laser 6310 reflected from an object through a histogram, data generated by the interference laser 6410 may become an obstructive factor.

Hereinafter, a time bin, to which data generated by the interference laser 6410 is allocated when the laser emitting unit 6200 emits the laser 6210 in a certain period, will be described in detail.

Referring to FIG. 61, the laser emitting unit 6200 may emit a laser through an emitter 6220. In addition, the external device 6400 may emit the interference laser 6410. In addition, a detecting unit 6300 may detect photons through a detector 6320.

In this case, photons may be included in the reflected laser 6310 received when a laser emitted from the emitter 6220 is returned by being reflected from an object or may be included in the interference laser 6410 emitted from the external device. Alternatively, photons may be included in external noise such as sunlight.

The detector 6320 may generate an output signal by detecting photons. The detector 6320 or the processor 6100 may generate data sets 6111, 6112, and 6113 including a plurality of pieces of data based on the output signal of the detector 6320. For example, the processor 6100 may generate 50, 100, 500, 1,024, 2,048, or 4,096 data sets based on the output signal of the detector 6320, but the present invention is not limited thereto.

As a result, the processor 6100 may generate a histogram by accumulating the plurality of data sets 6111, 6112, and 6113. For example, the processor 6100 may generate a histogram by accumulating the 50, 100, 500, 1,024, 2,048, or 4,096 data sets, but the present invention is not limited thereto. The processor 6100 may determine characteristics of an object based on the generated histogram.

According to one embodiment, the emitter 6220 may emit the laser 6210 every a first period p. For example, the emitter 6220 may emit a first laser at a first time point t1 and may emit a second laser at a second time point t2 which is a time point that is later than the first time point t1 by the first period p. In addition, the emitter 6220 may emit a third laser at a third time point t3 which is a time point that is later than the second time point t2 by the first period p.

The detector 6320 may detect photons during a first time period w1, a second time period w2, and a third time period w3.

In this case, an interval between a start point of the first time period w1 and the first time point t1, an interval between a start point of the second time period w2 and the second time point t2, and an interval between a start point of the third time period w3 and the third time point t3 may be a first time interval.

The first time interval may be described by being divided into a case in which the first time interval is zero and a case in which the first time interval is non-zero.

First, describing the case in which the first time interval is zero, the first time period w1 may include the first time point t1 at which the first laser is emitted, the second time period w2 may include the second time point t2 at which the second laser is emitted, and the third time period w3 may include the third time point t3 at which the third laser is emitted.

Specifically, for example, the start point of the first time period w1 may be the same as the first time point t1, the start point of the second time period w2 may be the same as the second time point t2, and the start point of the third time period w3 may be the same as the third time point t3.

When the first time is zero, the detector 6320 may detect photons from a time point at which the emitter 6220 emits a laser. Since a measurable minimum distance of a LiDAR device 6000 using the emitter 6220 and the detector 6320 is shortened, as a result, short distance measurement of the LiDAR device 6000 becomes possible.

Alternatively, describing the case in which the first time interval is non-zero, the first time period w1 may not include the first time point t1, the second time period w2 may not include the second time point t2, and the third time period w3 may not include the third time point t3.

Specifically, for example, the start point of the first time period w1 may be a time point that is later than the first time point t1 by the first time interval, the start point of the second time period w2 may be a time point that is later than the second time point t2 by the first time interval, and the start point of the third time period w3 may be a time point that is later than the third time point t3 by the first time interval.

In this case, as the first time interval is decreased, a measurable minimum distance of the LiDAR device 6000 may be decreased. For example, when the first time interval is greater than a certain numerical value, the LiDAR device 6000 may not detect an object present at a distance that is less than a certain distance. Since the measurable minimum distance of the LiDAR device 6000 using the emitter 6220 and the detector 6320 is increased, as a result, short distance measurement of the LiDAR device 6000 may become impossible.

According to one embodiment, the processor 6100 or the detector 6320 may generate a first data set 6111 based on a result of detecting photons during the first time period w1, may generate a second data set 6112 based on a result of detecting photons during the second time period w2, and may generate a third data set 6113 based on a result of detecting photons during the third time period w3.

An interference laser detecting time point 6420 of FIG. 61 is a result in which a time point at which the detector 6320 detects the interference laser 6410 is shown according to a time.

For example, the detector 6320 may detect a first interference laser at a first interference time point s1 included in the first time period w1, may detect a second interference laser at a second interference time point s2 included in the second time period w2, and may detect a third interference laser at a third interference time point s3 included in the third time period w3.

Accordingly, the first data set 6111 may include data generated by the first interference laser, the second data set 6112 may include data generated by the second interference laser, and the third data set 6113 may include data generated by the third interference laser.

When an emission period of the interference laser 6410 is constant, the interference laser 6410 may be constantly detected in photon detecting periods w1, w2, and w3 of the detector 6320. Therefore, the interference laser 6410 may be detected by the detector 6320 during a specific time bin period. For example, referring to FIG. 61, the interference laser 6410 may be detected by the detector 6320 during a time period of a fourth time bin or a time period of a time bin near the fourth time bin.

When the interference laser 6410 is detected by the detector 6320 during a specific time bin period, data generated by the interference laser 6410 may be generated in the specific time bin period. Accordingly, a histogram in which a plurality of data sets are accumulated may include data that is generated by the interference laser 6410 in a specific time bin period and has a numerical value greater than or equal to a certain numerical value.

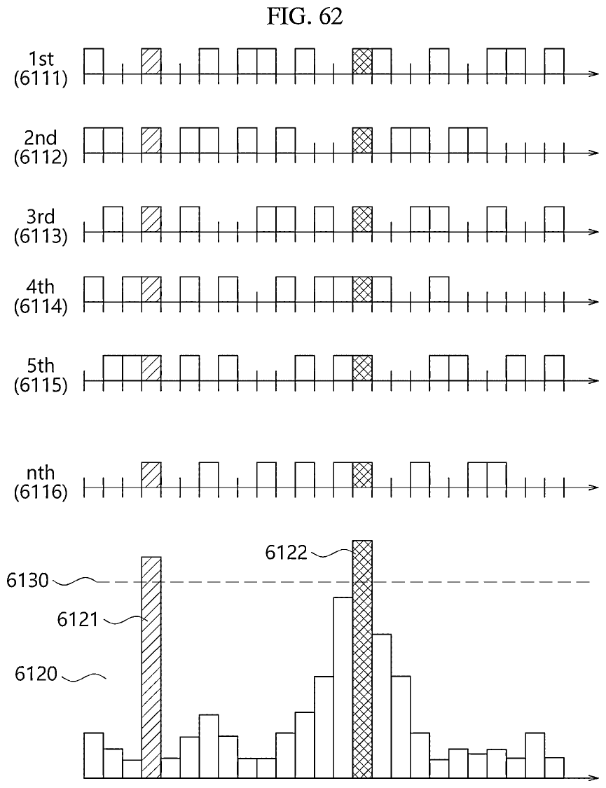

FIG. 62 shows diagrams for describing a histogram in which a plurality of data sets are accumulated according to one embodiment. The histogram of FIG. 62 is generated from a result of accumulating a plurality of data sets based on an output signal of the detector 6320 of FIG. 61.

According to one embodiment, the histogram may include a first data set 6111, a second data set 6112, a third data set 6113, a fourth data set 6114, and fifth to N^{th} data sets 6115 to 6116.

Each data set may include pieces of data allocated to a plurality of histogram time bins. In particular, each data set may include data generated by an interference laser 6410 and data generated by a reflected laser 6310.

For example, the first data set 6111 may include data generated by the interference laser 6410 in a fourth time bin and data generated by the reflected laser 6310 in a fifteenth time bin.

Each of the second data set 6112, the third data set 6113, the fourth data set 6114, and the fifth to N^{th} data sets 6115 to 6116 may also include data generated by the interference laser 6410 in a fourth time bin of each data set and data generated by the reflected laser 6310 in a fifteenth time bin.

In the above example, positions of time bins to which data generated by the interference laser 6410 is allocated may be the fourth in the first data set 6111, the fourth in the second data set 6112, and the fourth in the third data set 6113 and thus may all be the same. That is, the positions of the time bins to which the data generated by the interference laser 6410 is allocated may be the same or similar in the data sets.

In addition, in the above example, positions of time bins to which data generated by the reflected laser 6310 is allocated may be the fifteenth in the first data set 6111, the fifteenth in the second data set 6112, and the fifteenth in the third data set 6113 and thus may all be the same. That is, the positions of the time bins to which the data generated by the reflected laser 6310 is allocated may be the same or similar in the data sets

Since the laser emitting unit 6200 of FIG. 61 regularly emits a laser 6210 every a first period p, data generated by the reflected laser 6310 and included in a data set may be generated in a specific time bin or near the specific time bin. For example, the data generated by the reflected laser 6310 may be generated in the fifteenth time bin or near the fifteenth time bin, such as a fourteenth time bin or a sixteenth time bin.

In addition, for example, since the laser emitting unit 6200 regularly emits the laser 6210 every the first period p, the detector 6320 may also detect photons during a certain time period every the first period p. For example, the detector 6320 may detect photons during a first time period w1, a second time period w2, and a third time period w3.

For a specific example, a first time point t1, which is a time point at which an emitter 6220 outputs a first laser, may be a start point of the first time period w1, and a second time point t2, which is a time point at which the emitter 6220 outputs a second laser, may be an end point of the first time period w1.

In addition, the second time point t2, which is the time point at which the emitter 6220 outputs the second laser, may be a start point of the second time period w2, and a third time point t3, which is a time point at which the emitter 6220 outputs a third laser, may be an end point of the second time period w2. Furthermore, the third time point t3, which is the time point at which the emitter 6220 outputs the third laser, may be a start point of the third time period w3.

Since a time period in which the detector 6320 detects photons is repeated with a certain period, data generated by the interference laser 6410 emitted from an external device 6400 may also be generated in a specific histogram time bin or near the specific histogram time bin. For example, the data generated by the interference laser 6410 may be generated in the fourth time bin or near the fourth time bin, such as a third time bin or a fifth time bin.

Accordingly, a histogram, in which the first data set 6111, the second data set 6112, the third data set 6113, the fourth data set 6114, and the fifth to N^{th} data sets 6115 to 6116 are accumulated, may include the data generated by the interference laser 6410 in the fourth time bin and the data generated by the reflected laser 6310 in the fifteenth time bin.

A processor 6100 may extract a detecting time point of the reflected laser 6310 through data having a numerical value that is greater than or equal to a certain numerical value or a threshold value 6130 in a histogram. However, since data generated by the interference laser 6410 and data generated by the reflected laser 6310 are each generated in a specific time bin, in a histogram in which a plurality of data sets are accumulated, there may be a plurality of pieces of data having a numerical value greater than or equal to the threshold value 6130.

For example, data 6121, which is generated by the interference laser 6410 and has a numerical value greater than or equal to the threshold value 6130, may be allocated to a fourth time bin of a histogram. In addition, for example, data 6122, which is generated by the reflected laser 6310 and has a numerical value greater than or equal to the threshold value 6130, may be allocated to a fifteenth time bin of a histogram.

In this case, in a process in which the processor 6100 extracts a detecting time point, the processor 6100 may have a problem in selecting any data among a plurality of data having a numerical value greater than or equal to the threshold value 6130 in order to extract a detecting time point of the reflected laser 6310.

In this case, the processor 6100 may solve the above problem by allowing data generated by the interference laser 6410 to be generated irregularly in various time bins rather than in a specific time bin. That is, when the processor 6100 generates a histogram by accumulating a plurality of data sets, the processor 6100 may prevent data, which is generated by the interference laser 6410 and is allocated to a specific time bin, from having a numerical value greater than or equal to the threshold value 6130.

That is, the processor 6100 may increase temporal dispersion of data generated by the interference laser 6410, thereby preventing data generated by the interference laser 6410 in a specific time bin from having a numerical value greater than or equal to the threshold value 6130.

In this case, the processor 6100 should increase the temporal dispersion of the data generated by the interference laser 6410 and should decrease temporal dispersion of the data generated by the reflected laser 6310 received when the laser 6210 emitted from the laser emitting unit 6200 in a LiDAR device 6000 is reflected from an object.

That is, the processor 6100 may decrease the temporal dispersion of the data generated by the reflected laser 6310 reflected from the same object to control a laser emitting time point of the laser emitting unit 6200 and a detecting time period of a detecting unit 6300 so that the data may be accumulated in a specific time bin and may have a numerical value greater than or equal to a certain numerical value.

Hereinafter, a method in which the processor 6100 controls a laser emitting time point of the laser emitting unit 6200 and a detecting time period of the detecting unit 6300 will be described.

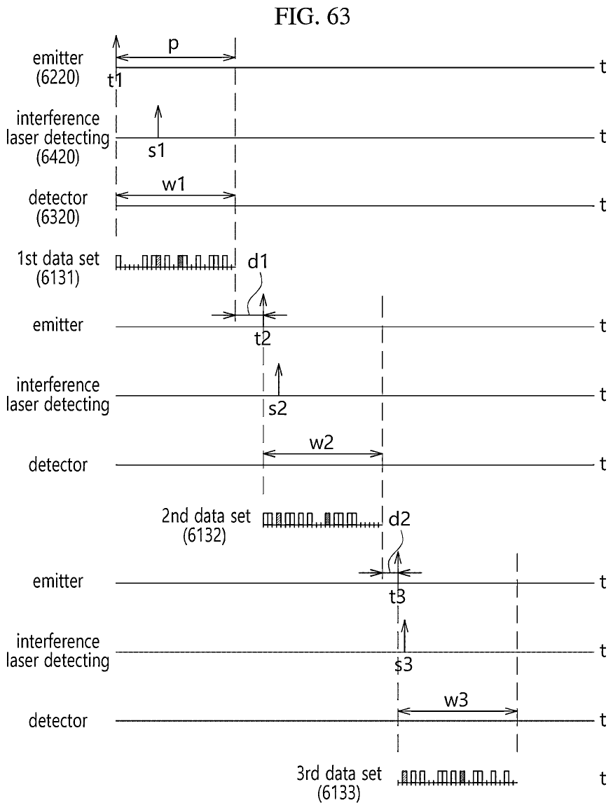

FIG. 63 shows diagrams for describing a plurality of data sets based on a plurality of output signals of a detecting unit according to another embodiment. In particular, FIG. 63 shows diagrams for describing an embodiment in which a laser emitting unit 6200 outputs a laser 6210 in a non-uniform period.

When a laser emitting unit 6200 emits the laser 6210 in a non-uniform period, data generated by an interference laser 6410 emitted from an external device 6400 may have a numerical value that is less than or equal to a certain numerical value and may be included in a histogram generated by a processor 6100.

Accordingly, when the processor 6100 extracts a detecting time point of the laser 6310 reflected from an object through a histogram, data generated by the interference laser 6410 may become an obstructive factor.

Referring to FIG. 63, as in FIG. 61, the laser emitting unit 6200 may emit a laser through an emitter 6220. In addition, the external device 6400 may emit the interference laser 6410. In addition, a detecting unit 6300 may detect photons through a detector 6320.

In this case, the photons may be included in the laser emitted from the emitter 6220 or may be included in the interference laser 6410. Alternatively, the photons may be included in external noise such as sunlight.

Since the description of a process of generating a histogram through a plurality of data sets based on an output signal of the detector 6320 may overlap the description of that of FIG. 61, detailed descriptions thereof will be omitted.

According to one embodiment, the emitter 6220 may emit the laser 6210 at irregular intervals. For example, the emitter 6220 may emit a first laser at a first time point t1, may emit a second laser at a second time point t2, and may emit a third laser at a third time point t3. In this case, an interval between the first time point t1 and the second time point t2 may be different from an interval between the second time point t2 and the third time point t3.

For example, the interval between the first time point t1 and the second time point t2 may be the sum of a first time period w1 and a first delay d1. In addition, for example, the interval between the second time point t2 and the third time point t3 may be the sum of a second time period w2 and a second delay d2.

In this case, a length of the first time period w1 may be the same as a length of the second time period w2, but the present invention is not limited thereto. In this case, a length of the first delay d1 may be different from a length of the second delay d2, but the present invention is not limited thereto.

For a specific example, the interval between the first time point t1 and the second time point t2 may be 3 μs, and the interval between the second time point t2 and the third time point t3 may be 2.5 μs. In this case, the first time period w1 and the second time period w2 may be the same as 2 μs, the first delay d1 may be 1 μs, and the second delay dd2 may be 0.5 μs.

The emitter 6220 of the laser emitting unit 6200 outputting the laser 6210 at irregular intervals may be implemented in various ways.

According to one embodiment, the processor 6100 may transmit a trigger signal to the laser emitting unit 6200 to allow the emitter 6220 of the laser emitting unit 6200 to emit the laser 6210. In this case, the trigger signal may be the sum of a first control signal and a second control signal.

For example, the first control signal may be a signal having a regular period. Specifically, the first control signal may be a signal in which an emission period of the emitter 6220 of FIG. 61, that is, a first period p, is repeated.

In addition, for example, the second control signal may be a signal having an irregular period. Specifically, the second control signal may include a signal having a random time interval. For example, the second control signal may include a signal expressed by a random function, a signal using jitter, and a signal determined according to a certain sequence.

For a specific example, the second control signal may be a signal having an interval between signals which is a time interval of T, 2T, 3T, or 4T that is a multiple of a certain time T or may be a signal having an interval between signals which follows a preset sequence of T, 3T, 2T, or 4T.

According to another embodiment, the processor 6100 may transmit a trigger signal to the laser emitting unit 6200 to allow the emitter 6220 of the laser emitting unit 6200 to emit the laser 6210. In this case, the trigger signal may be an irregular single signal rather than the above-described sum of the first signal and the second control signal.

For example, the trigger signal itself may be a signal having an irregular period. Specifically, the trigger signal may include a signal expressed by a random function and may include a signal determined according to a certain sequence.

For a specific example, like the above-described second control signal, the trigger signal may be a signal having a time interval that is a multiple of a certain time or a signal that follows a preset sequence.

The present invention is not limited to the above two methods, and in order to allow the emitter 6220 to irregularly emit the laser 6210, there may be various methods in which the processor 6100 generates a trigger signal having an irregular time interval.

As described with reference to FIG. 61, the detector 6320 may detect photons during the first time period w1, the second time period w2, and the third time period w3.

In this case, an interval between a start point of the first time period w1 and the first time point t1, an interval between a start point of the second time period w2 and the second time point t2, and an interval between a start point of the third time period w3 and the third time point t3 may be a first time interval.

Since the description of a case in which the first time interval is zero and a case in which the first time interval is non-zero may overlap the description of that of FIG. 61, detailed descriptions thereof will be omitted.

According to one embodiment, the processor 6100 or the detector 6320 may generate a first data set 6131 based on a result of detecting photons during the first time period w1, may generate a second data set 6132 based on a result of detecting photons during the second time period w2, and may generate a third data set 6133 based on a result of detecting photons during the third time period w3.

For example, the detector 6320 may detect a first interference laser at a first interference time point s1 included in the first time period w1, may detect a second interference laser at a second interference time point s2 included in the second time period w2, and may detect a third interference laser at a third interference time point s3 included in the third time period w3.

The processor 6100 or the detector 6320 may generate data generated by the first interference laser during the first time period w1, may generate data generated by the second interference laser during the second time interval w2, and may generate data generated by the third interference laser during the third time period w3.

Accordingly, the first data set 6131 may include data generated by the first interference laser, the second data set 6132 may include data generated by the second interference laser, and the third data set 6133 may include data generated by the third interference laser.

Unlike that of FIG. 61, since a laser emission time point of the emitter 6220 and time periods w1, w2, and w3 in which the detector 6320 detects photons do not have a certain period, the interference laser 6410 may be detected by the detector 6320 not only during a specific time bin period but during various time bin periods. That is, in the embodiment of FIG. 63, a range of a time bin to which data generated by the interference laser 6410 is allocated may be wider than that of FIG. 61.

For example, referring to an interference laser detecting time point 6420 of FIG. 63, after the first time t1 at which the emitter 6220 outputs the first laser, the interference laser 6410 may be detected at a first interference time s1 within the first time period w1. As a result, data generated by the interference laser 6410 may be generated in a tenth time bin of the first data set 6131.

In addition, for example, after the second time point t2 at which the emitter 6220 outputs the second laser, the interference laser 6410 may be detected at a second detecting time point s2 within the second time period w2. As a result, data generated by the interference laser 6410 may be generated in a fourth time bin of the second data set 6132.

Furthermore, for example, after the third time point t3 at which the emitter 6220 outputs the third laser, the interference laser 6410 may be detected at a third detecting time point s3 within the third time period w3. As a result, data generated by the interference laser 6410 may be generated in a second time bin of the third data set 6133.

In the above example, positions of time bins to which data generated by the interference laser 6410 is allocated are the tenth in the first data set 6131, the fourth in the second data set 6132, and the second in the third data set 6133 and thus may be different from each other. That is, the positions of the time bins to which the data generated by the interference laser 6410 is allocated may be different according to the data sets.

Therefore, when the interference laser 6410 is detected by the detector 6320, since data generated by the interference laser 6410 is not generated only during a specific time bin period but is generated in various time bin periods, a histogram in which a plurality of data sets are accumulated may not include data that is generated by the interference laser 6410 and has a numerical value greater than or equal to a certain numerical value.

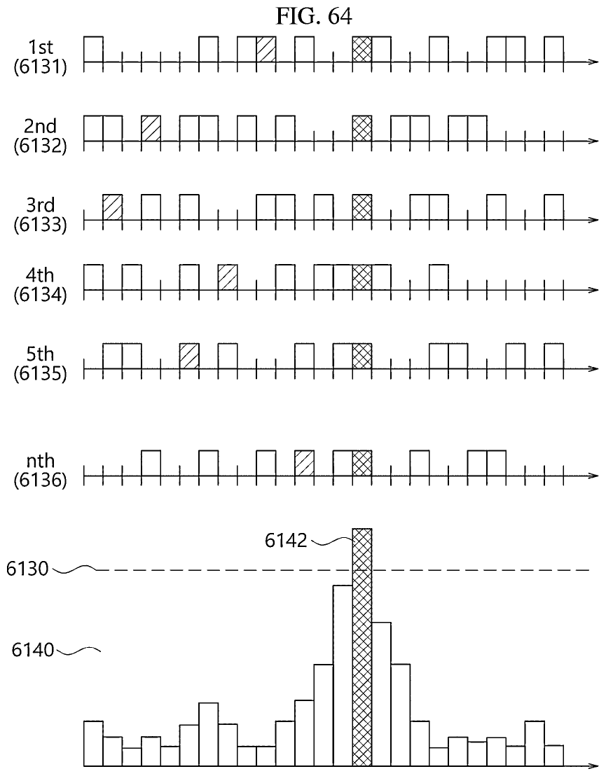

FIG. 64 shows diagrams for describing a histogram in which a plurality of data sets are accumulated according to another embodiment. A histogram 6140 of FIG. 64 is generated from a result of accumulating a plurality of data sets based on an output signal of the detector 6320 of FIG. 63.

According to one embodiment, the histogram 6140 may include a first data set 6131, a second data set 6132, a third data set 6133, a fourth data set 6134, a fifth data set 6135, and fifth to N^{th} data sets 6315 and 6136.

Each data set may include pieces of data allocated to a plurality of histogram time bins. In particular, each data set may include data generated by the interference laser 6410 and data generated by a reflected laser 6310 received when a laser emitted from a laser emitting unit 6200 is returned by being reflected from an object.

For example, the first data set 6131 may include data generated by the interference laser 6410 in a tenth time bin and data generated by the reflected laser 6310 in a fifteenth time bin.

In addition, for example, the second data set 6132 may include data generated by the interference laser 6410 in a fourth time bin and data generated by the reflected laser 6310 in a fifteenth time bin.

Furthermore, for example, the third data set 6133 may include data generated by the interference laser 6410 in a second time bin and data generated by the reflected laser 6310 in a fifteenth time bin.

In addition, for example, the fourth data set 6134 may include data generated by the interference laser 6410 in an eighth time bin and data generated by the reflected laser 6310 in a fifteenth time bin.

Furthermore, for example, the fifth data set 6135 may include data generated by the interference laser 6410 in a sixth time bin and data generated by the reflected laser 6310 in a fifteenth time bin.

In addition, for example, the N^{th} data set 6136 may include data generated by the interference laser 6410 in a twelfth time bin and data generated by the reflected laser 6310 in a fifteenth time bin.

Since the laser emitting unit 6200 of FIG. 63 outputs a laser 6210 in an irregular period, data generated by the interference laser 6410 may not be generated in a specific time bin or near the specific time bin but may be generated in various time bins. For example, data generated by the interference laser 6410 may be generated in each of the tenth, fourth, second, eighth, sixth, and twelfth time bins of the data sets.

A processor 6100 may allow the laser emitting unit 6200 to emit the laser 6210 in an irregular period, thereby increasing temporal dispersion of data generated by the interference laser 6410. Accordingly, in the histogram 6140 in which the plurality of data sets are accumulated, a value of data generated by the interference laser 6410 may not be greater than or equal to a certain numerical value (threshold value 6130).

Conversely, since an emitting time point of the laser 6210 of the laser emitting unit 6200 and a time point of a time period in which the detector 6320 detects photons are constant (or synchronized), data generated by the reflected laser 6310 and included in a data set may be generated in a specific time bin or near the specific time bin. For example, data generated by the reflected laser 6310 may be generated in the fifteenth time bin of each data set or near the fifteenth time bin, such as a fourteenth time bin or a sixteenth time bin.

The processor 6100 may make an interval between the emitting time point of the laser 6210 of the laser emitting unit 6200 and a start point of a detection period of the detector 6320 constant, thereby decreasing temporal dispersion of data generated by the laser 6210 emitted by the laser emitting unit 6200. Accordingly, in the histogram 6140 in which the plurality of data sets are accumulated, only data generated by the reflected laser 6310 may have a numerical value that is greater than or equal to a certain numerical value (threshold value 6130).

The processor 6100 may extract a detecting time of the reflected laser 6310 through the histogram 6140. The processor 6100 may extract data having a numerical value greater than or equal to the threshold value 6130 among pieces of data in the histogram 6140 and may extract the detecting time of the reflected laser 6310 based on a time period of the data.

In this case, in the histogram 6140 of FIG. 64, since the number of pieces of data having a numerical value greater than or equal to the threshold value 6130 is less than the number of those of the histogram 6120 of FIG. 62, a process of extracting the detecting time of the reflected laser 6310 may be easier.

That is, the processor 6100 may decrease temporal dispersion of data generated by the reflected laser 6310 and may increase temporal dispersion of data generated by the interference laser 6410 to minimize the number of pieces of data having a numerical value greater than or equal to the threshold value, thereby easily extracting the detecting time of the reflected laser 6310.

For example, in the histogram 6120 of FIG. 62, since temporal dispersion of data generated by the interference laser 6410 is small, the number of pieces of data having a numerical value greater than or equal to the threshold value 6130 may be 2 so that the processor 6100 may erroneously extract a detecting time point of the reflected laser 6310 based on the data 6121 generated by the interference laser 6410.

However, in the histogram 6140 of FIG. 64, since temporal dispersion of data generated by the interference laser 6410 is great, the number of pieces of data having a numerical value greater than or equal to the threshold value 6130 may be 1 so that the processor 6100 may correctly extract a detecting time point of the reflected laser 6310 based on data 6142 generated by the reflected laser 6310.

As a method in which the processor 6100 extracts a detecting time of the reflected laser 6310 in a histogram, only an extraction method using the threshold value 6130 has been described, but the present invention is not limited thereto, and various methods may be applied.

For example, the processor 6100 may extract a detecting time of the reflected laser 6310 using a center of mass of pieces of data in a histogram.

In addition, for example, when a plurality of pieces of generated data having a numerical value greater than or equal to the threshold value 6130 are present in a histogram, the processor 6100 may extract a detecting time of the reflected laser 6310 based on a period in which data having the highest numerical value is present or based on periods in which the data having the highest numerical value and pieces of data adjacent thereto are present.

For a specific example, a case may be present in which, among a plurality of pieces of data having a numerical value greater than or equal to the threshold value 6130, a numerical value of data generated in a fifth time bin with a time period of 4 μs to 5 μs is 50, a numerical value of data generated in a fourth time bin with a time period of 3 μs to 4 μs is 40, and a numerical value of data generated in a sixth time bin with a time period of 5 μs to 6 μs is 30.

In this case, since data having the highest numerical value is the data generated in the fifth time bin, the processor 6100 may determine that the reflected laser 6310 is detected by the detector 6320 in a period of 4 μs to 5 μs which is the time period of the fifth time bin. In this case, additionally, the processor 6100 may extract a detecting time point with reference to the numerical value of the data generated in the fourth time bin that is a time bin before the fifth time bin and the numerical value of the data generated in the sixth time bin that is a time bin after the fifth time bin.

For example, since the numerical value generated in the fifth time bin is greater than the numerical value generated in the sixth time bin, the processor 6100 may determine that the reflected laser 6310 is detected by the detector 6320 at a time point before 4.5 μs which is a midpoint of the time period of the fifth time bin.

For a specific example, the processor 6100 may divide the time period of 4 μs to 5 μs of the fifth time bin at a ratio of the numerical value of the data generated in the fourth time bin and the numerical value of the data generated in the sixth time bin. That is, the processor 6100 may determine that the reflected laser 6310 is detected by the detector 6320 at 4.42 μs through the ratio (of 40:30, that is, 4:3). However, the present invention is not limited thereto, and there may be various calculation methods through the ratio.

The present invention is not limited to the above example, and as a method in which the processor 6100 finds a detecting time point of the reflected laser 6310 in a histogram, any method applicable by those skilled in the art may be applied.

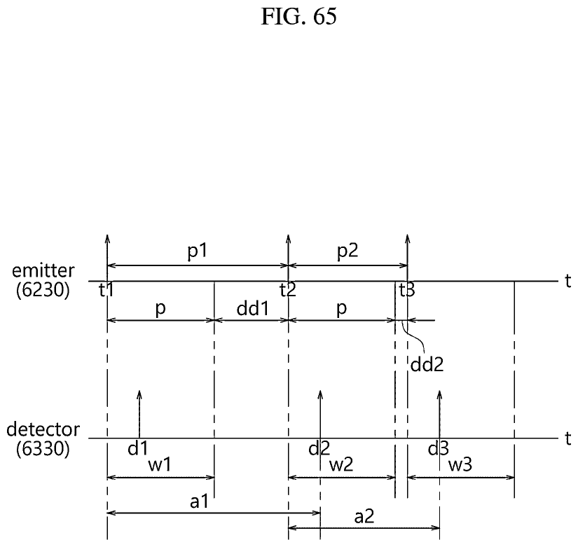

FIG. 65 is a diagram for describing a timing of a laser emitting signal of a laser emitting unit and a timing of a received signal of a detecting unit.

Referring to FIG. 65, a laser emitting unit 6200 may include an emitter 6230 which outputs a laser, and a detecting unit 6300 may include a detector 6330 which detects photons.

Since the description of the emitter 6230 and the detector 6330 overlaps the above description, detailed descriptions thereof will be omitted.

According to one embodiment, under control of a processor 6100, the emitter 6230 may emit a first laser at a first time point t1, may emit a second laser at a second time point t2, and may emit a third laser at a third time point t3.

A time interval corresponding to a first period p1 may be present between the first time point t1 and the second time point t2, and a time interval corresponding to a second period p2 may be present between the second time point t2 and the third time point t3.

The first time interval may be the sum of a fixed period p and a first delay dd1, and the second time interval may be the sum of the fixed period p and a second delay dd2. In this case, when the first delay dd1 and the second delay dd2 are the same, the first period p1 and the second period p2 may be the same. Alternatively, when the first delay dd1 and the second delay dd2 are different, the first period p1 and the second period p2 may be different.

In order to increase temporal dispersion of data generated by an interference laser 6410, the processor 6100 may control a laser emitting time point of the emitter 6230 by making the first period p1 and the second period p2 different.

The processor 6100 may irregularly control an emitting time point itself of the emitter 6230, that is, the first period p1, the second period p2, and the like, thereby determining the first time point t1, the second time point t2, and the third time point t3. Alternatively, the processor 6100 may transmit a trigger signal to the emitter 6230 so as to have the certain fixed period p and may add an irregular variable delay d1 or d2 to the trigger signal, thereby determining the first time point t1, the second time point t2, and the third time point t3. Detailed contents thereof overlap those described above, descriptions thereof will be omitted.

According to one embodiment, the detector 6330 may detect photons during a certain period under control of the processor 6100. Referring to FIG. 65, the detector 6330 may detect photons during a first time period w1, a second time period w2, and a third time period w3.

In this case, an interval between the first time point t1 and a start point of the first time period w1, an interval between the second time point t2 and a start point of the second time period w2, and an interval between the third time point t3 and a start point of the third time period w3 may all be the same as a first time interval.

A reason why all of intervals between laser emitting time points of the emitter 6230 and start points of photon detecting time periods of the detector are the same is to decrease temporal dispersion of data generated by the reflected laser 6310.

That is, when the first laser, the second laser, and the third laser directed to the same area or object are reflected and detected by the detector 6330, since the lasers are reflected from the same area or object, a distance to the area calculated by the first laser, a distance to the area calculated by the second laser, and a distance to the area calculated by the third laser should all be the same.

Accordingly, all the intervals between the laser emitting time points of the emitter 6230 and the start points of the photon detecting time periods of the detector may be the same as the first time interval such that the distances calculated by the lasers are all the same.

Since the description of a case in which the first time interval is zero and a case in which the first time interval is non-zero may overlap the description of that of FIG. 61, detailed descriptions thereof will be omitted.

According to one embodiment, a laser emitted from the emitter 6230 may be detected in a photon detecting period of the detector 6330.

For example, at a first detecting time point d1 in the first time period w1 that is a photon detecting period, the detector 6330 may detect the reflected laser 6310 returned by being reflected from an object among the first laser emitted by the emitter 6230 at the first time point t1.

In addition, for example, at a second detecting time point d2 in the second time period w2 that is a photon detecting period, the detector 6330 may detect the reflected laser 6310 returned by being reflected from an object among the second laser emitted by the emitter 6230 at the second time point t2.

Furthermore, for example, at a third detecting time point d3 in the third time period w3 that is a photon detecting period, the detector 6330 may detect the reflected laser 6310 returned by being reflected from an object among the third laser emitted by the emitter 6230 at the third time point t3.

When all the intervals between the laser emitting time points of the emitter 6230 and the start points of the photon detecting time periods of the detector are the same as the first time interval, and an interval between the first time point t1 and the first detecting time point d1, an interval between the second time point t2 and the second detecting time point d2, and an interval between the third time point t3 and the third detecting time point d3 may all be the same.

In this case, when the laser emitting period of the emitter 6230 is irregular, a first distribution interval a1 that is an interval between the first time point t1 and the second detecting time point d2 may be different from a second distribution interval a2 that is an interval between the second time point t2 and the third detecting time point d3.

Since 1) all the intervals between the laser emitting time points of the emitter 6230 and the start points of the photon detecting time periods of the detector are the same as the first time interval, 2) intervals between the laser emitting time points and laser detecting time points are the same, and 3) the first distribution interval a1 and the second distribution interval (a2) are different, temporal distribution of data generated by the interference laser 6410 may be wide, and temporal distribution of data generated by the reflected laser 6310 may be narrow.

Accordingly, when a plurality of data sets are accumulated, the processor 6100 may generate a histogram such that a range of a time bin to which data generated by the interference laser 6410 is allocated is wide and a range of a time bin to which data generated by the reflected laser 6310 is allocated is narrow.

In other words, in the histogram, the range of the time bin to which the data generated by the interference laser 6410 is allocated may be a first range, and the range of the time bin to which the data generated by the reflected laser 6310 is allocated may be a second range that is narrower than the first range.

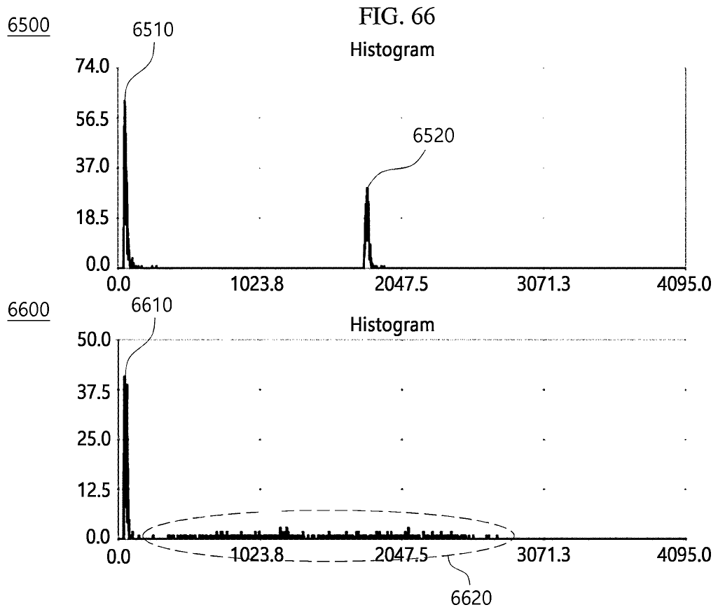

FIG. 66 shows diagrams for describing a histogram according to a timing of a laser emitting signal of a laser emitting unit.

FIG. 66A is a diagram for describing a first histogram 6500 according to a timing of an output signal of the laser emitting unit of FIG. 61. FIG. 66B is a diagram for describing a second histogram 6600 according to a timing of an output signal of the laser emitting unit of FIG. 63.

Referring to FIG. 66A, in the first histogram 6500, data having a numerical value greater than or equal to a threshold value may be first data 6510 and second data 6520.

The first data 6510 may be data generated by a laser emitted from the laser emitting unit 6200, and the second data 6520 may be data generated by an interference laser 6410.

When a processor 6100 calculates a distance to an object through the first histogram 6500, the processor 6100 may calculate the distance based on data having a numerical value that is greater than or equal to a threshold value. In this case, the processor 6100 may calculate the distance based on the first data 6510 or may calculate the distance based on the second data 6520. However, when the processor 6100 calculates the distance based on the second data 6520, an error of distance measurement may occur.

Referring to FIG. 66B, in the second histogram 6600, only third data 6610 may be data having a numerical value that is greater than or equal to a threshold value. In addition, in the second histogram 6600, pieces of fourth data 6620 may be a plurality of pieces of data having a numerical value that is less than or equal to a threshold value.

In this case, the third data 6610 may be data generated by a laser emitted from the laser emitting unit 6200, and the fourth data 6620 may be data generated by the interference laser 6410.

Since the processor 6100 decreases temporal dispersion of data generated by a laser emitted from the laser emitting unit 6200, the data may be accumulated in a narrow time bin to generate the third data 6610 having a numerical value that is greater than or equal to a threshold value.

In addition, since the processor 6100 increases temporal dispersion of data generated by the interference laser 6410, the data may be accumulated in a wide time bin in a certain period to generate the fourth data 6620 having a numerical value that is less than or equal to a threshold value.

When the processor 6100 calculates a distance to an object through the second histogram 6600, the processor 6100 may calculate the distance based on data having a numerical value that is greater than or equal to a threshold value. In this case, since only the third data 6610 is data having a numerical value greater than or equal to a threshold value in the second histogram 6600, the distance may be calculated based on the third data 6610.

Accordingly, when the distance to the object is calculated through the second histogram 6600, the processor 6100 may calculate a more accurate distance as compared with a case in which the distance to the object is calculated through the first histogram 6500.

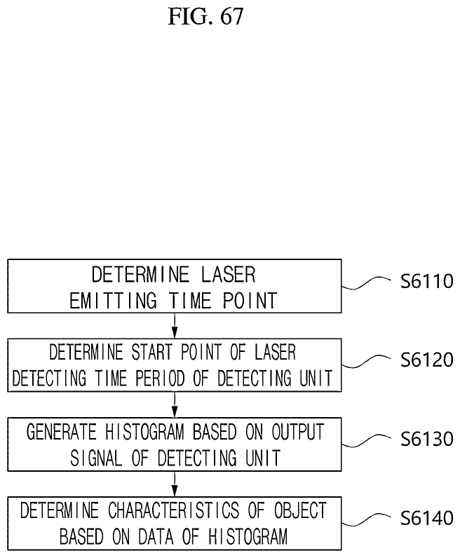

FIG. 67 is a diagram for describing a method of controlling a LiDAR device according to one embodiment.

Referring to FIG. 67, the method of controlling a LiDAR device may include operation S6110 of determining a laser emitting time point, operation S6120 of determining a start point of a laser detecting time period of a detecting unit, operation S6310 of generating a histogram based on an output signal of the detecting unit, and operation S6140 of determining characteristics of an object based on data of the histogram.

According to one embodiment, operation S6110 of determining the laser emitting time point may include an operation of determining the first laser emitting time t1, the second laser emitting time t2, and the third laser emitting time t3 of FIG. 63. Detailed contents thereof overlap the contents described with reference to FIG. 63, descriptions thereof will be omitted.

According to one embodiment, operation S6120 of determining the start point of the laser detecting time period of the detecting unit may include an operation of determining a start point of the first time period w1 of FIG. 63, a start point of the second time period w2 of FIG. 63, and a start point of the third time period w3 of FIG. 63. Detailed contents thereof overlap the contents described with reference to FIG. 63, descriptions thereof will be omitted.

According to one embodiment, operation S6310 of generating the histogram based on the output signal of the detecting unit may include an operation of accumulating the first data set 6131, the second data set 6132, the third data set 6133, the fourth data set 6134, and the fifth to N^{th} data sets 6135 to 6136 of FIG. 64 to generate the histogram 6140. Detailed contents thereof overlap the contents described with reference to FIG. 64, descriptions thereof will be omitted.

According to one embodiment, operation S6140 of determining the characteristics of the object based on the data of the histogram may include an operation of calculating or determining a distance, a center point, position coordinates, and the like of the object. Since the description thereof may overlap the above description, descriptions thereof will be omitted.

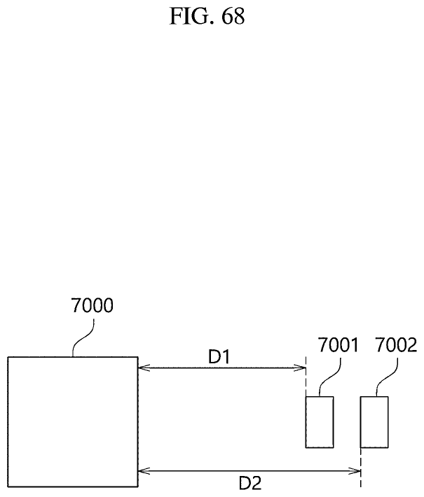

FIG. 68 is a diagram for describing a situation assumed to describe the invention according to one embodiment.

Referring to FIG. 68, a LiDAR device 7000 according to one embodiment may measure a distance to an object using a laser.

More specifically, the LiDAR device 7000 according to one embodiment may emit a laser, may generate a detection signal by obtaining a reflected laser when the emitted laser is reflected from an object, and may measure a distance to the object based on the generated detection signal.

For example, referring to FIG. 68, the LiDAR device 7000 according to one embodiment may measure a distance to a first object 7001 located at a first distance D1 from the LiDAR device 7000 and may measure a distance to a second object 7002 located at a second distance D2 from the LiDAR device 7000.

In this case, although the first object 7001 and the second object 7002 are simultaneously shown in FIG. 68, situations to be described below may be a situation in which the LiDAR device 7000 measures the distance to the first object 7001 and a situation in which the LiDAR device 7000 measures the distance to the second object 7002.

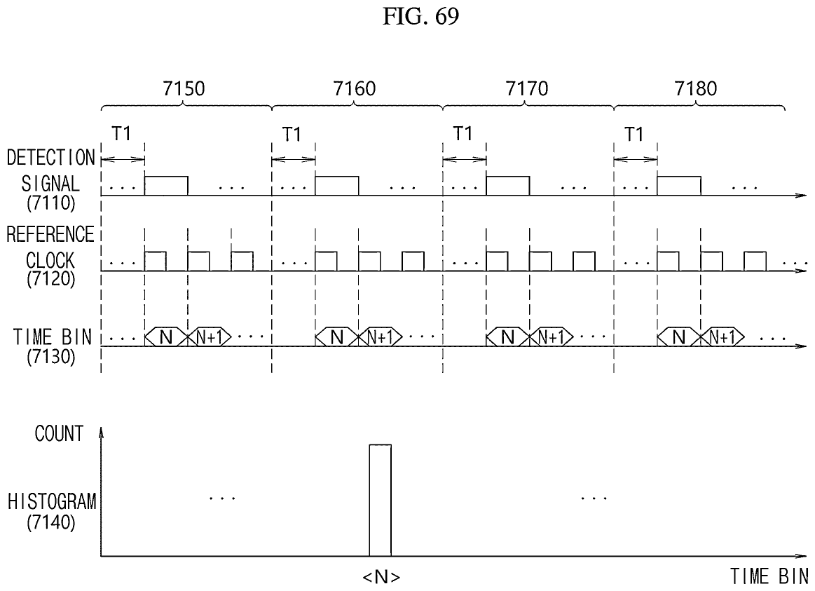

FIG. 69 shows diagrams for describing the operation of a signal processing unit for measuring a distance to a first object in a LiDAR device according to one embodiment.

Referring to FIG. 69, a detecting unit included in the LiDAR device according to one embodiment may detect light to generate detection signals 7110.

In this case, the detection signals 7110 shown in FIG. 69 may be the detection signals 7110 for lasers that are emitted from the LiDAR device and are reflected from a first object 7001 located at a first distance D1.

Referring to FIG. 69, a laser emitted from the LiDAR device and reflected from the first object 7001 located at the first distance D1 may be detected by the detecting unit when a first time interval T1 has elapsed after the laser is emitted from the LiDAR device.

For example, in a first scan period 7150, a first laser emitted from the LiDAR device and reflected from the first object 7001 located at the first distance D1 may be detected by the detecting unit when the first time interval T1 has elapsed after the first laser is emitted from the LiDAR device, but the present invention is not limited thereto.

In addition, for example, in a second scan period 7160, a second laser emitted from the LiDAR device and reflected from the first object 7001 located at the first distance D1 may be detected by the detecting unit when the first time interval T1 has elapsed after the second laser is emitted from the LiDAR device, but the present invention is not limited thereto.

Furthermore, for example, in a third scan period 7170, a third laser emitted from the LiDAR device and reflected from the first object 7001 located at the first distance D1 may be detected by the detecting unit when the first time interval T1 has elapsed after the third laser is emitted from the LiDAR device, but the present invention is not limited thereto.

In addition, for example, in a fourth scan period 7180, a fourth laser emitted from the LiDAR device and reflected from the first object 7001 located at the first distance D1 may be detected by the detecting unit when the first time interval T1 has elapsed after the fourth laser is emitted from the LiDAR device, but the present invention is not limited thereto.

In addition, referring to FIG. 69, the LiDAR device may detect the detection signal 7110 using a reference clock 7120 and may store or update a counting value for a time bin 7130 corresponding to a time point at which the detection signal 7110 is generated based on a detection result, thereby generating histogram data 7140.

For example, in the first scan period 7150, when it is assumed that the detection signal 7110 generated by the first laser emitted from the LiDAR device and reflected from the first object 7001 located at the first distance D1 is a first detection signal, the first detection signal may be detected using the reference clock 7120, and a counting value for an N^{th} time bin may be stored or updated based on a result of detecting the first detection signal.

In addition, for example, in the second scan period 7160, when it is assumed that the detection signal 7110 generated by the second laser emitted from the LiDAR device and reflected from the first object 7001 located at the first distance D1 is a second detection signal, the second detection signal may be detected using the reference clock 7120, and a counting value for an N^{th} time bin may be stored or updated based on a result of detecting the second detection signal.

Furthermore, for example, in the third scan period 7170, when it is assumed that the detection signal 7110 generated by the third laser emitted from the LiDAR device and reflected from the first object 7001 located at the first distance D1 is a third detection signal, the third detection signal may be detected using the reference clock 7120, and a counting value for an N^{th} time bin may be stored or updated based on a result of detecting the third detection signal.

In addition, for example, in the fourth scan period 7180, when it is assumed that the detection signal 7110 generated by the fourth laser emitted from the LiDAR device and reflected from the first object 7001 located at the first distance D1 is a fourth detection signal, the fourth detection signal may be detected using the reference clock 7120, and a counting value for an N^{th} time bin may be stored or updated based on a result of detecting the fourth detection signal.

Furthermore, for example, the histogram data 7140 may be generated through the first to fourth scan periods 7150 to 7180, and a counting value of the histogram data 7140 corresponding to an N^{th} time bin may be 4, but the present invention is not limited thereto.

In this case, although four scan periods and the histogram data through the four scan periods have been described for convenience of description, the number of scan periods of the LiDAR device is not limited to the present description.

In addition, the scan periods may be expressed as scan cycles, cycles, and the like, but the present invention is not limited thereto.

In addition, the LiDAR device may acquire distance information about an object based on the histogram data 7140.

In this case, the distance information about the object may be described as distance information about the detecting unit in that the distance information about the object is acquired based on a detection signal generated from the detecting unit, but the present invention is not limited thereto.

For example, the LiDAR device may determine a peak value based on the histogram data 7140, may determine a time bin corresponding to the peak value, and may acquire information about a distance to an object based on a time value corresponding to the determined time bin.

For a more specific example, the LiDAR device may determine that a time bin corresponding to a peak value is an N^{th} time bin based on the histogram data 7140 and may acquire information about a distance to an object based on a time value corresponding to the N^{th} time bin.

That is, a distance value for the first object 7001 located at the first distance D1 from the LiDAR device to may be obtained based on the time value corresponding to the N^{th} time bin.

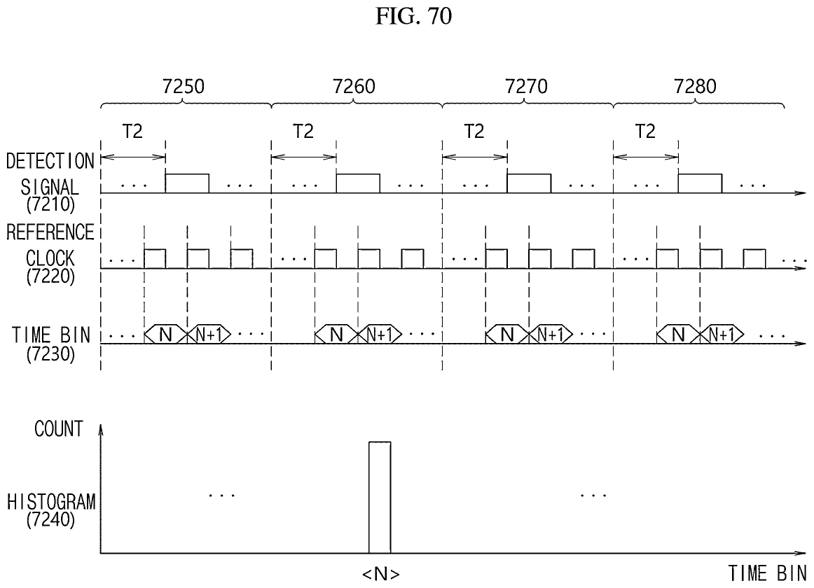

FIG. 70 shows diagrams for describing the operation of a signal processing unit for measuring a distance to a second object in a LiDAR device according to one embodiment.

Referring to FIG. 70, a detecting unit included in the LiDAR device according to one embodiment may detect light to generate detection signals 7210.

In this case, the detection signals 7210 shown in FIG. 70 may be the detection signals 7210 for lasers that are emitted from the LiDAR device and are reflected from a second object 7002 located at a second distance D2.

Referring to FIG. 70, a laser emitted from the LiDAR device and reflected from the second object 7002 located at the second distance D2 may be detected by the detecting unit when a second time interval T2 has elapsed after the laser is emitted from the LiDAR device.

For example, in a fifth scan period 7250, a fifth laser emitted from the LiDAR device and reflected from the second object 7002 located at the second distance D2 may be detected by the detecting unit when the second time interval T2 has elapsed after the fifth laser is emitted from the LiDAR device, but the present invention is not limited thereto.

In addition, for example, in a sixth scan period 7260, a sixth laser emitted from the LiDAR device and reflected from the second object 7002 located at the second distance D2 may be detected by the detecting unit when the second time interval T2 has elapsed after the sixth laser is emitted from the LiDAR device, but the present invention is not limited thereto.

Furthermore, for example, in a seventh scan period 7270, a seventh laser emitted from the LiDAR device and reflected from the second object 7002 located at the second distance D2 may be detected by the detecting unit when the second time interval T2 has elapsed after the seventh laser is emitted from the LiDAR device, but the present invention is not limited thereto.

In addition, for example, in an eighth scan period 7280, an eighth laser emitted from the LiDAR device and reflected from the second object 7002 located at the second distance D2 may be detected by the detecting unit when the second time interval T2 has elapsed after the eighth laser is emitted from the LiDAR device, but the present invention is not limited thereto.

In addition, referring to FIG. 70, the LiDAR device may detect the detection signal 7210 using a reference clock 7220 and may store or update a counting value for a time bin corresponding to a time point at which the detection signal 7210 is generated based on a detection result, thereby generating histogram data 7240.

For example, in the fifth scan period 7250, when it is assumed that the detection signal 7210 generated by the fifth laser emitted from the LiDAR device and reflected from the second object 7002 located at the second distance D2 is a fifth detection signal, the fifth detection signal may be detected using the reference clock 7220, and a counting value for an N^{th} time bin may be stored or updated based on a result of detecting the fifth detection signal.

In addition, for example, in the sixth scan period 7260, when it is assumed that the detection signal 7210 generated by the sixth laser emitted from the LiDAR device and reflected from the second object 7002 located at the second distance D2 is a sixth detection signal, the sixth detection signal may be detected using the reference clock 7220, and a counting value for an N^{th} time bin may be stored or updated based on a result of detecting the sixth detection signal.

Furthermore, for example, in the seventh scan period 7270, when it is assumed that the detection signal 7210 generated by the seventh laser emitted from the LiDAR device and reflected from the second object 7002 located at the second distance D2 is a seventh detection signal, the seventh detection signal may be detected using the reference clock 7220, and a counting value for an N^{th} time bin may be stored or updated based on a result of detecting the seventh detection signal.

In addition, for example, in the eighth scan period 7280, when it is assumed that the detection signal 7210 generated by the eighth laser emitted from the LiDAR device and reflected from the second object 7002 located at the second distance D2 is an eighth detection signal, the eighth detection signal may be detected using the reference clock 7220, and a counting value for an Nth time bin may be stored or updated based on a result of detecting the eighth detection signal.

Furthermore, for example, the histogram data 7240 may be generated through the fifth to eighth scan periods 7250 to 7280, and a counting value of the histogram data 7240 corresponding to an N^{th} time bin may be 4, but the present invention is not limited thereto.

In this case, although four scan periods and the histogram data through the four scan periods have been described for convenience of description, the number of scan periods of the LiDAR device is not limited to the present description.

In addition, the scan periods may be expressed as scan cycles, cycles, and the like, but the present invention is not limited thereto.

In addition, the LiDAR device may acquire distance information about an object based on the histogram data 7240.

In this case, the distance information about the object may be described as distance information about the detecting unit in that the distance information about the object is acquired based on a detection signal generated from the detecting unit, but the present invention is not limited thereto.

For example, the LiDAR device may determine a peak value based on the histogram data 7240, may determine a time bin corresponding to the peak value, and may acquire information about a distance to an object based on a time value corresponding to the determined time bin.

For a more specific example, the LiDAR device may determine that a time bin corresponding to a peak value is an N^{th} time bin based on the histogram data 7240 and may acquire information about a distance to an object based on a time value corresponding to the N^{th} time bin.

That is, a distance value for the second object 7002 located at the second distance D2 from the LiDAR device may be obtained based on the time value corresponding to the Nth time bin.

Referring to FIGS. 68 to 70, the LiDAR device may measure a distance to the first object 7001 or the second object 7002 located at one of different distances (first distance or second distance).

However, since the LiDAR device detects an acquired detection signal using a reference clock and generates histogram data as a detection result, the same distance value may be obtained for objects located at different distances according to a resolution of the reference clock.

For example, since a distance value for the first object 7001 located at the first distance D1 from the LiDAR device is obtained based on the time value corresponding to the N^{th} time bin, and a distance value for the second object 7003 located at the second distance D2 from the LiDAR device is also obtained based on the time value corresponding to the Nth time bin, the distance value for the first object 7001 and the distance value for the second object 7002 may be obtained as the same distance value.

Although such a phenomenon can be solved by increasing a distance resolution of the LiDAR device by as much as an increase in resolution of the reference clock, when the resolution of the reference clock is increased, a volume of LiDAR data such as histogram data may be increased, which may cause difficulties in storing and sharing data in a memory or the like.

Therefore, hereinafter, a hardware configuration and method for increasing a distance resolution of a LiDAR device so as to be greater than or equal to a resolution of a reference clock will be described in more detail.

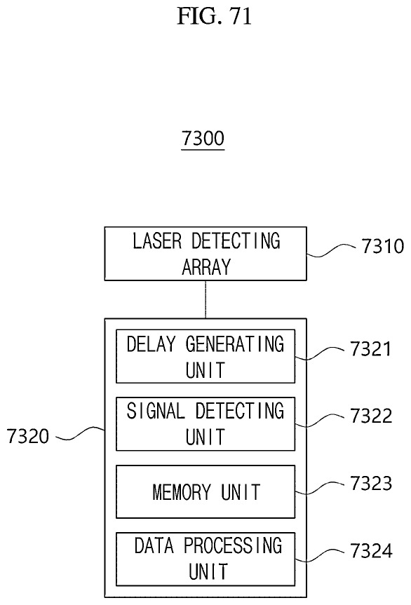

FIG. 71 is a diagram for describing a LiDAR device according to one embodiment.

Referring to FIG. 71, a LiDAR device 7300 according to one embodiment may include a laser detecting array 7310 and a signal processing unit 7320.

In this case, since the above-described contents may be applied to the laser detecting array 7310, repetitive descriptions will be omitted.

The signal processing unit 7320 according to one embodiment may include a delay generating unit 7321, a signal detecting unit 7322, a memory unit 7323, and a data processing unit 7324.

The delay generating unit 7321 according to one embodiment may acquire a detection signal generated from the laser detecting array 7310 to output a delay signal.

For example, the delay generating unit 7321 according to one embodiment may acquire a first detection signal from a first detecting unit included in the laser detecting array 7310 to output a delay signal having a first delay value, but the present invention is not limited thereto.

In addition, for example, the delay generating unit 7321 according to one embodiment may acquire the first detection signal from the first detecting unit included in the laser detecting array 7310 to output a delay signal having a second delay value, but the present invention is not limited thereto.

Furthermore, for example, the delay generating unit 7321 according to one embodiment may acquire a second detection signal from a second detecting unit included in the laser detecting array 7310 to output a delay signal having the first delay value, but the present invention is not limited thereto.

In addition, for example, the delay generating unit 7321 according to one embodiment may acquire a detection signal generated from the laser detecting array 7310 to output a delay signal having a selected delay value.

For example, the delay generating unit 7321 according to one embodiment may acquire the first detection signal from the first detecting unit included in the laser detecting array 7310 to output a delay signal having the selected first delay value, but the present invention is not limited thereto.

In addition, for example, the delay generating unit 7321 according to one embodiment may acquire the first detection signal from the first detecting unit included in the laser detecting array 7310 to output a delay signal having the selected second delay value, but the present invention is not limited thereto.

Furthermore, the delay generating unit 7321 according to one embodiment may acquire a detection signal generated from the laser detecting array 7310 to output a plurality of delay signals having different delay values.

For example, the delay generating unit 7321 according to one embodiment may acquire the first detection signal from the first detecting unit included in the laser detecting array 7310 to output the first delay signal having the first delay value and the second delay signal having the second delay value, but the present invention is not limited thereto.

In addition, the delay generating unit 7321 according to one embodiment may output delay signals having different delay values by applying different delay values according to scan periods.

For example, the delay generating unit 7321 according to one embodiment may output delay signals having the first delay value by applying the first delay value to detection signals acquired from the first detecting unit included in the laser detecting array 7310 during a first scan period and may output delay signals having the second delay value by applying the second delay value to detection signals acquired from the first detecting unit included in the laser detecting array 7310 during a second scan period, but the present invention is not limited thereto.

In addition, a delay value applied by the delay generating unit 7321 according to one embodiment may be set to a multiple of a reference delay value.

For example, when a reference delay value of a delay value applied by the delay generating unit 7321 according to one embodiment is 78.125 ps, the first delay value may be set to 78.125 ps, the second delay value may be set to 156.25 ps, and a third delay value may be set to 234.375 ps, but the present invention is not limited thereto.

In addition, the signal detecting unit 7322 according to one embodiment may detect a delay signal emitted from the delay generating unit 7321 using a preset clock.

For example, the signal detecting unit 7322 according to one embodiment may detect a rising edge of a delay signal emitted from the delay generating unit 7321 using the preset clock, but the present invention is not limited thereto.

In addition, the signal detecting unit 7322 according to one embodiment may be understood as a typical time to digital converter (TDC), but the present invention is not limited thereto.

In addition, the signal detecting unit 7322 according to one embodiment may detect a delay signal emitted from the delay generating unit 7321 based on phase adjustment and synchronization of the preset clock.

For example, the signal detecting unit 7322 according to one embodiment may include a component such as ISERDESE2 for phase adjustment and synchronization of the preset clock and a component such as an edge detector, thereby detecting a delay signal emitted from the delay generating unit 7321 based on phase adjustment and synchronization of the preset clock, but the present invention is not limited thereto.

In addition, various embodiments for determining a time value, a time bin value, or a storage position of a delay signal emitted from the delay generating unit 7321 may be applied to the signal detecting unit 7322 according to one embodiment.

Furthermore, the memory unit 7323 according to one embodiment may store at least one piece of data based on a detection result of the signal detecting unit 7322.

For example, the memory unit 7323 according to one embodiment may store a counting value in a corresponding address based on a detection result of the signal detecting unit 7322, but the present invention is not limited thereto.

In addition, for example, the memory unit 7323 according to one embodiment may store histogram data based on a detection result of the signal detecting unit 7322, but the present invention is not limited thereto.

Furthermore, a preset clock may be used to store data in the memory unit 7323 according to one embodiment.

In addition, the memory unit 7323 according to one embodiment may include at least one of a static random access memory (SRAM), a dynamic random access memory (DRAM), a pseudo SRAM (PSRAM), a synchronous DRAM (SDRAM), a double data rate SDRAM (DDR SDRAM), and a block random access memory (BRAM), but the present invention is not limited thereto. The memory unit 7323 may include various memories.

In addition, the data processing unit 7324 according to one embodiment may calculate LiDAR data based on data stored in the memory unit 7323.

For example, the data processing unit 7324 according to one embodiment may calculate a distance value for a detecting unit based on the histogram data stored in the memory unit 7323, but the present invention is not limited thereto.

In addition, for example, the data processing unit 7324 according to one embodiment may calculate an intensity value for the detecting unit based on the histogram data stored in the memory unit 7323, but the present invention is not limited thereto.

Furthermore, for example, the data processing unit 7324 according to one embodiment may calculate a distance value for at least one object based on the histogram data stored in the memory unit 7323, but the present invention is not limited thereto.

In addition, for example, the data processing unit 7324 according to one embodiment may calculate an intensity value for at least one object based on the histogram data stored in the memory unit 7323, but the present invention is not limited thereto.

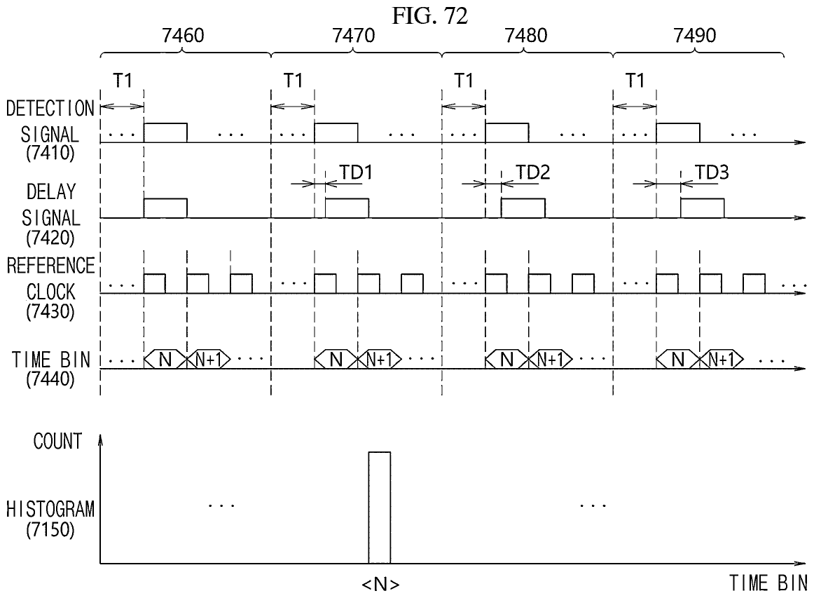

FIG. 72 shows diagrams for describing the operation of a signal processing unit for measuring a distance to a first object in a LiDAR device according to one embodiment.

Referring to FIG. 72, a detecting unit included in the LiDAR device according to one embodiment may detect light to generate detection signals 7410.

In this case, the detection signals 7410 shown in FIG. 72 may be the detection signals 7410 for lasers that are emitted from the LiDAR device and are reflected from a first object 7001 located at a first distance D1.

Referring to FIG. 72, a laser emitted from the LiDAR device and reflected from the first object 7001 located at the first distance D1 may be detected by the detecting unit when a first time interval T1 has elapsed after the laser is emitted from the LiDAR device.

For example, in a first scan period 7460, a first laser emitted from the LiDAR device and reflected from the first object 7001 located at the first distance D1 may be detected by the detecting unit when the first time interval T1 has elapsed after the first laser is emitted from the LiDAR device, but the present invention is not limited thereto.

In addition, for example, in a second scan period 7470, a second laser emitted from the LiDAR device and reflected from the first object 7001 located at the first distance D1 may be detected by the detecting unit when the first time interval T1 has elapsed after the second laser is emitted from the LiDAR device, but the present invention is not limited thereto.

Furthermore, for example, in a third scan period 7480, a third laser emitted from the LiDAR device and reflected from the first object 7001 located at the first distance D1 may be detected by the detecting unit when the first time interval T1 has elapsed after the third laser is emitted from the LiDAR device, but the present invention is not limited thereto.

In addition, for example, in a fourth scan period 7490, a fourth laser emitted from the LiDAR device and reflected from the first object 7001 located at the first distance D1 may be detected by the detecting unit when the first time interval T1 has elapsed after the fourth laser is emitted from the LiDAR device, but the present invention is not limited thereto.

In addition, referring to FIG. 72, a delay generating unit included in the LiDAR device may acquire the detection signal 7410 to output a delay signal 7420.

For example, in the first scan period 7460, when it is assumed that the detection signal 7410 generated by the first laser emitted from the LiDAR device and reflected from the first object 7001 located at the first distance D1 is a first detection signal, the delay generating unit may acquire the first detection signal to output a first delay signal having no delay value, but the present invention is not limited thereto.

In addition, for example, in the second scan period 7470, when it is assumed that the detection signal 7410 generated by the second laser emitted from the LiDAR device and reflected from the first object 7001 located at the first distance D1 is a second detection signal, the delay generating unit may acquire the second detection signal to output a second delay signal having a first delay value TD1, but the present invention is not limited thereto.

Furthermore, for example, in the third scan period 7480, when it is assumed that the detection signal 7410 generated by the third laser emitted from the LiDAR device and reflected from the first object 7001 located at the first distance D1 is a third detection signal, the delay generating unit may acquire the third detection signal to output a third delay signal having a second delay value TD2, but the present invention is not limited thereto.

In addition, for example, in the fourth scan period 7490, when it is assumed that the detection signal 7410 generated by the fourth laser emitted from the LiDAR device and reflected from the first object 7001 located at the first distance D1 is a fourth detection signal, the delay generating unit may acquire the fourth detection signal to output a fourth delay signal having a third delay value TD3, but the present invention is not limited thereto.

Furthermore, referring to FIG. 72, the LiDAR device may detect the delay signal 7420 using a reference clock 7430 and may store or update a counting value for a time bin 7440 corresponding to a time point at which the delay signal 7420 is generated based on a detection result, thereby generating histogram data 7450.

For example, in the first scan period 7460, the first delay signal may be detected using the reference clock 7430, and a counting value for an N^{th} time bin may be stored or updated based on a result of detecting the first delay signal.

In addition, for example, in the second scan period 7470, the second delay signal may be detected using the reference clock 7430, and a counting value for an N^{th} time bin may be stored or updated based on a result of detecting the second delay signal.

Furthermore, for example, in the third scan period 7480, the third delay signal may be detected using the reference clock 7430, and a counting value for an N^{th} time bin may be stored or updated based on a result of detecting the third delay signal.

In addition, for example, in the fourth scan period 7490, the fourth delay signal may be detected using the reference clock 7430, and a counting value for an N^{th} time bin may be stored or updated based on a result of detecting the fourth delay signal.

Furthermore, for example, the histogram data 7450 may be generated through the first to fourth scan periods 7460 to 7450, and a counting value of the histogram data 7450 corresponding to an N^{th} time bin may be 4, but the present invention is not limited thereto.

In this case, although four scan periods and the histogram data through the four scan periods have been described for convenience of description, the number of scan periods of the LiDAR device is not limited to the present description.

In addition, the scan periods may be expressed as scan cycles, cycles, and the like, but the present invention is not limited thereto.

In addition, the LiDAR device may acquire distance information about an object based on the histogram data 7450.

In this case, the distance information about the object may be described as distance information about the detecting unit in that the distance information about the object is acquired based on a detection signal generated from the detecting unit, but the present invention is not limited thereto.

For example, the LiDAR device may determine a peak value based on the histogram data 7450, may determine a time bin corresponding to the peak value, and may acquire information about a distance to an object based on a time value corresponding to the determined time bin.

For a more specific example, the LiDAR device may determine that a time bin corresponding to a peak value is an N^{th} time bin based on the histogram data 7450 and may acquire information about a distance to an object based on a time value corresponding to the N^{th} time bin.

That is, a distance value for the first object 7001 located at the first distance D1 from the LiDAR device may be obtained based on the time value corresponding to the N^{th} time bin.

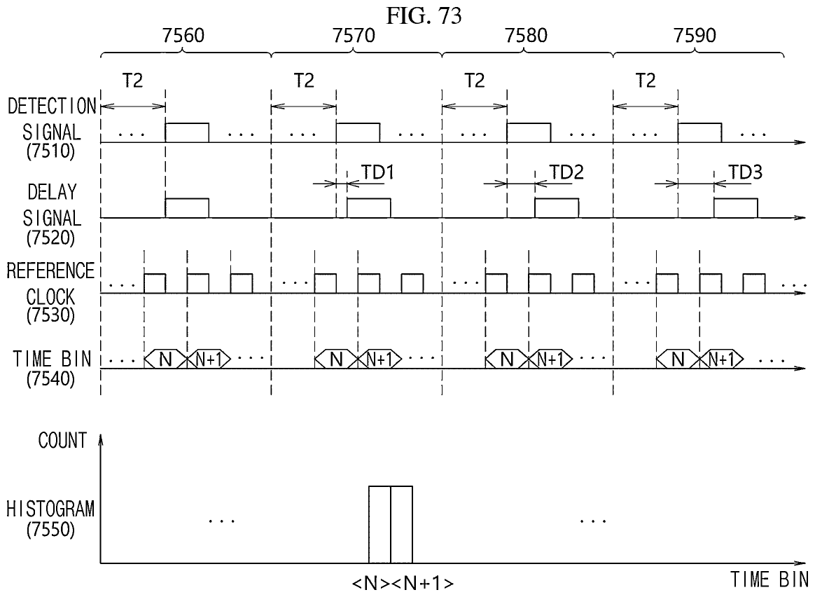

FIG. 73 shows diagrams for describing the operation of a signal processing unit for measuring a distance to a second object in a LiDAR device according to one embodiment.

Referring to FIG. 73, a detecting unit included in the LiDAR device according to one embodiment may detect light to generate detection signals 7510.

In this case, the detection signals 7510 shown in FIG. 73 may be the detection signals 7510 for lasers that are emitted from the LiDAR device and are reflected from a second object 7002 located at a second distance D2.

Referring to FIG. 73, a laser emitted from the LiDAR device and reflected from the second object 7002 located at the second distance D2 may be detected by the detecting unit when a second time interval T2 has elapsed after the laser is emitted from the LiDAR device.

For example, in a fifth scan period 7560, a fifth laser emitted from the LiDAR device and reflected from the second object 7002 located at the second distance D2 may be detected by the detecting unit when the second time interval T2 has elapsed after the fifth laser is emitted from the LiDAR device, but the present invention is not limited thereto.

In addition, for example, in a sixth scan period 7570, a sixth laser emitted from the LiDAR device and reflected from the second object 7002 located at the second distance D2 may be detected by the detecting unit when the second time interval T2 has elapsed after the sixth laser is emitted from the LiDAR device, but the present invention is not limited thereto.

In addition, for example, in a seventh scan period 7580, a seventh laser emitted from the LiDAR device and reflected from the second object 7002 located at the second distance D2 may be detected by the detecting unit when the second time interval T2 has elapsed after the seventh laser is emitted from the LiDAR device, but the present invention is not limited thereto.

In addition, for example, in an eighth scan period 7590, an eighth laser emitted from the LiDAR device and reflected from the second object 7002 located at the second distance D2 may be detected by the detecting unit when the second time interval T2 has elapsed after the eighth laser is emitted from the LiDAR device, but the present invention is not limited thereto.

In addition, referring to FIG. 73, a delay generating unit included in the LiDAR device may acquire the detection signal 7510 to output a delay signal 7520.

For example, in the fifth scan period 7560, when it is assumed that the detection signal 7510 generated by the fifth laser emitted from the LiDAR device and reflected from the second object 7002 located at the second distance D2 is a fifth detection signal, the delay generating unit may acquire the fifth detection signal to output a fifth delay signal having no delay value, but the present invention is not limited thereto.

In addition, for example, in the sixth scan period 7570, when it is assumed that the detection signal 7510 generated by the sixth laser emitted from the LiDAR device and reflected from the second object 7002 located at the second distance D2 is a sixth detection signal, the delay generating unit may acquire the sixth detection signal to output a sixth delay signal having a first delay value TD1, but the present invention is not limited thereto.

Furthermore, for example, in the seventh scan period 7580, when it is assumed that the detection signal 7510 generated by the seventh laser emitted from the LiDAR device and reflected from the second object 7002 located at the second distance D2 is a seventh detection signal, the delay generating unit may acquire the seventh detection signal to output a seventh delay signal having a second delay value TD2, but the present invention is not limited thereto.

In addition, for example, in the eighth scan period 7590, when it is assumed that the detection signal 7510 generated by the eighth laser emitted from the LiDAR device and reflected from the second object 7002 located at the second distance D2 is an eighth detection signal, the delay generating unit may acquire the eighth detection signal to output an eighth delay signal having a third delay value TD3, but the present invention is not limited thereto.

Furthermore, referring to FIG. 73, the LiDAR device may detect the detection signal 7520 using a reference clock 7530 and may store or update a counting value for a time bin 7540 corresponding to a time point at which the detection signal 7520 is generated based on a detection result, thereby generating histogram data 7550.

For example, in the fifth scan period 7560, the fifth delay signal may be detected using the reference clock 7530, and a counting value for an N^{th} time bin may be stored or updated based on a result of detecting the fifth delay signal.

In addition, for example, in the sixth scan period 7570, the sixth delay signal may be detected using the reference clock 7530, and a counting value for an N^{th} time bin may be stored or updated based on a result of detecting the sixth delay signal.

Furthermore, for example, in the seventh scan period 7580, the seventh delay signal may be detected using the reference clock 7530, and a counting value for an (N+1)^{th} time bin may be stored or updated based on a result of detecting the seventh delay signal.

In addition, for example, in the eighth scan period 7590, the seventh delay signal may be detected using the reference clock 7530, and a counting value for an (N+1)^{th} time bin may be stored or updated based on a result of detecting the eighth delay signal.

Furthermore, for example, the histogram data 7550 may be generated through the fifth to eighth scan periods 7560 to 7590, a counting value of the histogram data 7550 corresponding to an N^{th} time bin may be 2, and a counting value thereof corresponding to an (N+1)^{th} time bin may be 2, but the present invention is not limited thereto.

In this case, although four scan periods and the histogram data through the four scan periods have been described for convenience of description, the number of scan periods of the LiDAR device is not limited to the present description.

In addition, the scan periods may be expressed as scan cycles, cycles, and the like, but the present invention is not limited thereto.

In addition, the LiDAR device may acquire distance information about an object based on the histogram data 7550.

In this case, the distance information about the object may be described as distance information about the detecting unit in that the distance information about the object is acquired based on a detection signal generated from the detecting unit, but the present invention is not limited thereto.

For example, the LiDAR device may determine a peak value and valid data based on the histogram data 7550, may calculate a time value based on the peak value and the valid data, and may acquire information about a distance to an object based on the calculated time value.

For a more specific example, the LiDAR device may determine that pieces of data corresponding to an N^{th} time bin and an (N+1)^{th} time bin are valid data based on the histogram data 7550, may calculate a time value based on counting values corresponding to the N^{th} time bin and the (N+1)^{th} time bin, and may acquire information about a distance to an object based on the calculated time value.

That is, a distance value for the second object 7002 located at the second distance D2 from the LiDAR device may be obtained based on a time value between the N^{th} time bin and the (N+1)^{th} time bin.

For example, a distance value for the second object 7002 located at the second distance D2 from the LiDAR device may be obtained based on a time value corresponding to an (N+0.5)^{th} time bin, but the present invention is not limited thereto.

Referring to FIGS. 68, 72, and 73, the LiDAR device may measure a distance to the first object 7001 or the second object 7002 located at one of different distances (first distance or second distance).

In addition, it can be seen that, unlike the embodiments described with reference to FIGS. 69 and 70, distance values for the first object 7001 and the second object 7002 may be different from each other even when the same reference clock is used.

For example, since a distance value for the first object 7001 located at the first distance D1 from the LiDAR device may be obtained based on the time value corresponding to the N^{th} time bin, and a distance value for the second object 7002 located at the second distance D2 from the LiDAR device is also obtained based on the time value corresponding to the (N+0.5)^{th} time bin, the distance value for the first object 7001 and the distance value for the second object 7002 may be obtained as different distance values.

That is, it can be seen that more accurate distance measurement within the same reference clock is possible using a configuration of the above-described delay generating unit.

As a result, in a LiDAR device including the configuration of the delay generating unit according to the present invention, a distance resolution of the LiDAR device may be higher than or equal to a resolution of a reference clock.

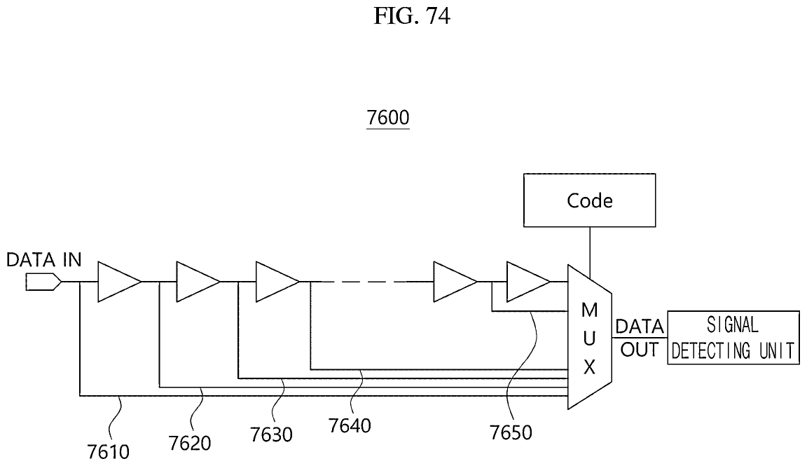

FIG. 74 is a diagram for describing a delay generating unit according to one embodiment.

Referring to FIG. 74, a delay generating unit 7600 according to one embodiment may include a data input line DATA IN, a data output line DATA OUT, a plurality of buffer units, a plurality of delay signal lines, a multiplexer MUX, and a control line.

In this case, the data input line DATA IN may be connected to at least one detecting unit included in a laser detecting array included in a LiDAR device and may be a line for acquiring a detection signal from the at least one detecting unit.

In addition, the data output line DATA OUT may be connected to the above-described signal detecting unit and may be a line for outputting at least one delay signal.

Furthermore, the plurality of buffer units may be configured to delay the detection signal.

In addition, the plurality of delay signal lines may be lines for transmitting at least one delay signal.

For example, a first delay signal line 7610 may be a line for transmitting a first delay signal which is a detection signal that does not pass through the buffer unit, a second delay signal line 7620 may be a line for transmitting a second delay signal which is a detection signal that passes through a first buffer unit, a third delay signal line 7630 may be a line for transmitting a third delay signal which is a detection signal that passes through the first buffer unit and a second buffer unit, a fourth delay signal line 7640 may be a line for transmitting a fourth delay signal which is a detection signal that passes through first to third buffer units, and an N^{th} delay signal line 7650 may be a line for transmitting an N^{th} delay signal which is a detection signal that passes through first to N^{th} buffer units, but the present invention is not limited thereto.

In addition, a plurality of delay signals transmitted through the plurality of delay signal lines may be transmitted to the multiplexer MUX.

Furthermore, the multiplexer MUX may be configured to acquire the plurality of delay signals and output one delay signal.

For example, the multiplexer MUX may be configured to acquire the first to N^{th} delay signals and output one delay signal among the first to N^{th} delay signals, but the present invention is not limited thereto.

In addition, the control line may be a line for acquiring a control signal for determining a delay signal to be emitted from the multiplexer MUX.

For example, when a control signal for outputting the first delay signal is acquired through the control line, the multiplexer MUX may operate to output the first delay signal among the first to N^{th} delay signals, but the present invention is not limited thereto.

In order to help the overall understanding of the present invention, the contents described with reference to FIG. 74 are merely provided to describe an example of a configuration of the delay generating unit according to one embodiment of the present invention. In implementing the technical idea of the present invention, as the configuration of the delay generating unit, all of various configurations for acquiring a detection signal from the laser detecting array and outputting a delay signal may be applied.

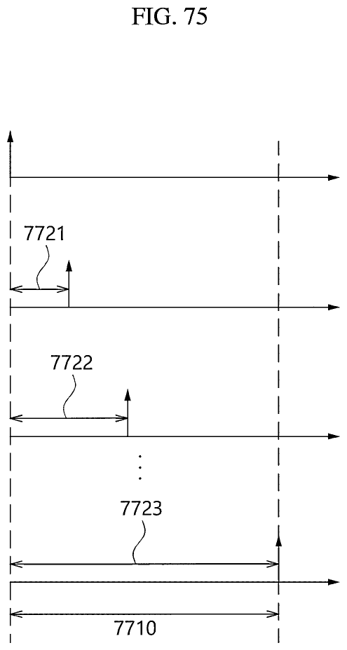

FIG. 75 is a diagram for describing a delay value according to one embodiment.

Referring to FIG. 75, a concept of a time bin unit length 7710 may be introduced to describe the delay value according to one embodiment.

In a LiDAR device according to one embodiment, in order to generate histogram data, a time bin having a preset time period may be set, and the time bin unit length 7710 may be set.

For example, in the LiDAR device according to one embodiment, in order to generate histogram data, the time bin unit length 7710 may be set to 1.25 ns, but the present invention is not limited thereto. The time bin unit length 7710 may be set to one of various time lengths.

In addition, the time bin unit length 7710 may be set based on a reference clock.

For example, when a cycle length of the reference clock is 1.25 ns, the time bin unit length 7710 may be set to 1.25 ns, but the present invention is not limited thereto.

In addition, for example, when the cycle length of the reference clock is 5 ns, and a signal is detected by diversifying a phase of the reference clock into angles of 0°, 90°, 180°, and 270°, the time bin unit length 7710 may be set to 1.25 ns, but the present invention is not limited thereto.

The delay value according to one embodiment may be less than or equal to the time bin unit length 7710.

For example, a first delay value 7721 may be less than the time bin unit length 7710, a second delay value 7722 may be less than the time bin unit length 7710, and an N^{th} delay value 7723 may be equal to the time bin unit length 7710, but the present invention is not limited thereto.

In addition, the delay value according to one embodiment may be a multiple of a reference delay value.

For example, the first delay value 7721 may be the reference delay value, the second delay value 7722 may be twice the reference delay value, and the N^{th} delay value is N times the reference delay value, but the present invention is not limited thereto.

For a more specific example, when the number of the delay values is 16, the first delay value 7721 may be 78.125 ps, the second delay value 7722 may be 156.25 ps, and the N^{th} delay value 7723 may be 1.25 ns, but the present invention is not limited thereto.

In addition, the reference delay value according to one embodiment may be a value obtained by dividing the time bin unit length 7710 by the number of delay values.

For example, when the time bin unit length 7710 is 1.25 ns and the number of the delay values is 16, the reference delay value may be 78.125 ps, but the present invention is not limited thereto.

In addition, the reference delay value according to one embodiment may be less than the time bin unit length 7710.

For example, the time bin unit length 7710 may be 1.25 ns, and the reference delay value may be 78.125 ps, but the present invention is not limited thereto.

In addition, as described above, when the reference delay value according to one embodiment is less than the time bin unit length 7710, it is possible to generate an effect of increasing a distance resolution of the LiDAR device while minimizing dispersion of a counting value.

This may mean that it is possible to generate a good effect as opposed to a case in which, when the reference delay value according to one embodiment is greater than the time bin unit length 7710, a counting value is distributed over various time bins according to a delay value, which makes it difficult to search for a signal for an object.

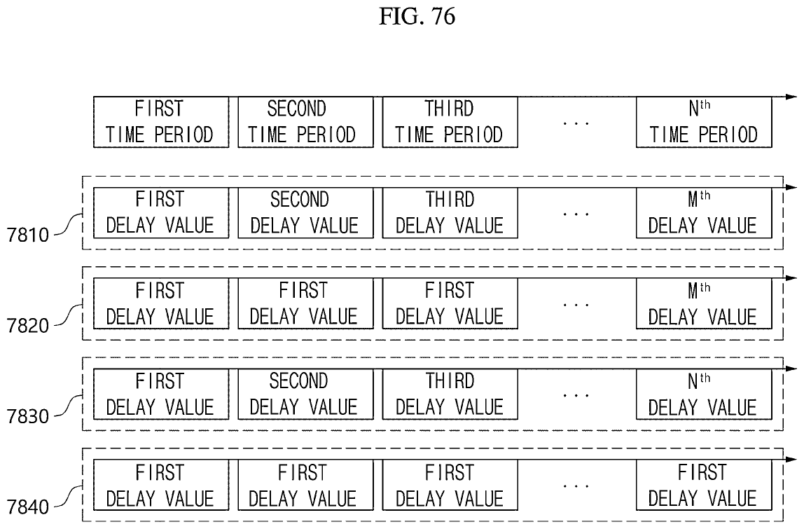

FIG. 76 is a diagram for describing an operation mode of a LiDAR device according to one embodiment.

Referring to FIG. 76, the LiDAR device according to one embodiment may operate in a first operation mode 7810, a second operation mode 7820, a third operation mode 7830, and a fourth operation mode 7840.

In this case, in FIG. 76, representative embodiments of the present invention are merely shown and described, and the operation modes of the LiDAR device according to the present invention may include various operation modes.

In addition, hereinafter, an application of a delay value according to an operation mode may be implemented through the above-described delay generating unit, but the present invention is not limited thereto.

The first operation mode 7810 of the LiDAR device according to one embodiment may be an operation mode in which M delay values are distributed and applied to scan periods of the LiDAR device.

For example, the first operation mode 7810 of the LiDAR device according to one embodiment may be an operation mode in which a first delay value is applied during a first time period corresponding to a first scan period, a second delay value is applied during a second time period corresponding to a second scan period, a third delay value is applied during a third time period corresponding to a third scan period, and an M^{th} delay value is applied during an N^{th} time period corresponding to an N^{th} scan period.

For a more specific example, when the number of scan periods of the LiDAR device according to one embodiment is 128 (which may be a case in which the number of times of sampling is 128), and the number of delay values is 16, the first operation mode 7810 of the LiDAR device according to one embodiment may be an operation mode in which first to sixteenth delay values are sequentially and repeatedly applied to first to N^{th} time periods corresponding to first to N^{th} scan periods, but the present invention is not limited thereto.

In addition, the second operation mode 7820 of the LiDAR device according to one embodiment may be an operation mode in which the M delay values are distributed and applied to the scan periods of the LiDAR device.

For example, the second operation mode 7820 of the LiDAR device according to one embodiment may be an operation in which the first delay value is applied during the first time period corresponding to the first scan period, the first delay value is applied during the second time period corresponding to the second scan period, the first delay value is applied during the third time period corresponding to the third scan period, and the M^{th} delay value is applied during the N^{th} time period corresponding to the N^{th} scan period.

For a more detailed example, the second operation mode 7820 of the LiDAR device according to one embodiment may be an operation in which, when the number of scan periods of the LiDAR device according to one embodiment is 128 (which may be a case in which the number of times of sampling is 128), and the number of delay values is 16, the first delay value is applied to the first to eighth time periods corresponding to the first to eighth scan periods, the second delay value is applied to the ninth to sixteenth time periods corresponding to the ninth to sixteenth scan periods, and the sixteenth delay value is applied to the 121^{st} to 128^{th} time periods corresponding to the 121^{st} to 128^{th} scan periods, but the present invention is not limited thereto.

In addition, the third operation mode 7830 of the LiDAR device according to one embodiment may be an operation mode in which N delay values are distributed and applied to N scan periods of the LiDAR device.

For example, the third operation mode 7830 of the LiDAR device according to one embodiment may be an operation mode in which the first delay value is applied during the first time period corresponding to the first scan period, the second delay value is applied during the second time period corresponding to the second scan period, the third delay value is applied during the third time period corresponding to the third scan period, and an N^{th} delay value is applied during the N^{th} time period corresponding to the N^{th} scan period.

For a more detailed example, the third operation mode 7830 of the LiDAR device according to one embodiment may be an operation mode in which, when the number of scan periods of the LiDAR device according to one embodiment is 16 (which may be a case in which the number of times of sampling is 16), and the number of delay values is 16, the first delay value is applied to the first time period corresponding to the first scan period, the second delay value is applied to the second time period corresponding to the second scan period, the third delay value is applied to the third time period corresponding to the third scan period, and the sixteenth delay value is applied to the sixteenth time period corresponding to the sixteenth scan period, but the present invention is not limited thereto.

In addition, the fourth operation mode 7840 of the LiDAR device according to one embodiment may be an operation mode in which the same delay value is applied to a plurality of scan periods of the LiDAR device.

For example, the fourth operation mode 7840 of the LiDAR device according to one embodiment may be an operation mode in which the first delay value is applied during the first time period corresponding to the first scan period, the first delay value is applied during the second time period corresponding to the second scan period, the first delay value is applied during the third time period corresponding to the third scan period, and the first delay value is applied during the N^{th} time period corresponding to the N^{th} scan period.

For a more detailed example, the fourth operation mode 7840 of the LiDAR device according to one embodiment may be an operation mode in which, when the number of scan periods of the LiDAR device according to one embodiment is 128 (which may be a case in which the number of times of sampling is 128), the first delay value is applied to the first to 128^{th} time periods corresponding to the first to 128^{th} scan periods, but the present invention is not limited thereto

In addition, according to one embodiment, the fourth operation mode 7840 may be set to a basic operation mode of the LiDAR device, and the first to third operation modes 7810 to 7830 may be set to modified operation modes of the LiDAR device.

In addition, according to one embodiment, a delay value applied to the basic operation mode of the LiDAR device may be a median value of a plurality of delay values applied to the modified operation mode of the LiDAR device.

For example, when the number of delay values applied in the modified operation mode of the LiDAR device is 16, a reference delay value is 78.125 ps, and the first to sixteenth delay values are multiples of 78.125 ps to 1.25 ns, a delay value applied in the basic operation mode of the LiDAR device may be 546.875 ps or 625 ps, but the present invention is not limited thereto.

In addition, as in the above example, when a delay value applied to the basic operation mode of the LiDAR device is a median value of a plurality of delay values applied to the modified operation mode of the LiDAR device, a plurality of delay signals output in the modified operation mode may be temporally and uniformly distributed at before and after the delay signal output in the basic operation mode, thereby reducing computing power or the like consumed for distance correction according to a delay.

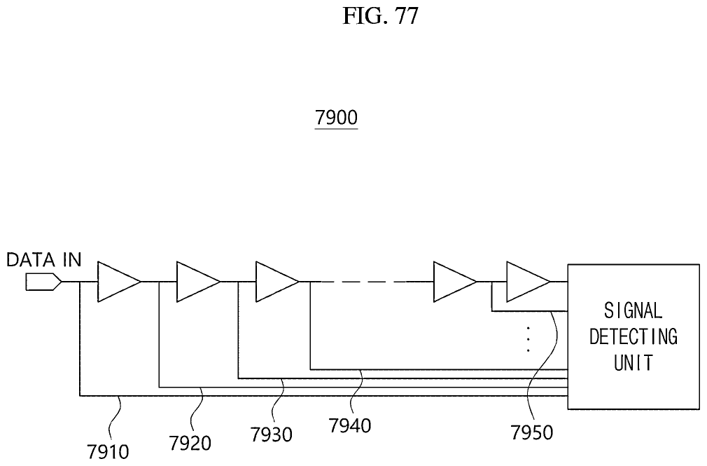

FIG. 77 is a diagram for describing a delay generating unit according to one embodiment.

Referring to FIG. 77, a delay generating unit 7900 according to one embodiment may include a data input line DATA IN, a plurality of buffer units, and a plurality of delay signal output lines.

In this case, the data input line DATA IN may be connected to at least one detecting unit included in a laser detecting array included in a LiDAR device and may be a line for acquiring a detection signal from the at least one detecting unit.

Furthermore, the plurality of buffer units may be configured to delay the detection signal.

In addition, the plurality of delay signal output lines may be lines for transmitting at least one delay signal.

For example, a first delay signal output line 7910 may be a line for transmitting a first delay signal which is a detection signal that does not pass through the buffer unit, a second delay signal output line 7920 may be a line for transmitting a second delay signal which is a detection signal that passes through a first buffer unit, a third delay signal output line 7930 may be a line for transmitting a third delay signal which is a detection signal that passes through the first buffer unit and a second buffer unit, a fourth delay signal output line 7940 may be a line for transmitting a fourth delay signal which is a detection signal that passes through first to third buffer units, and an N^{th} delay signal output line 7950 may be a line for transmitting an N^{th} delay signal which is a detection signal that passes through first to N^{th} buffer units, but the present invention is not limited thereto.

In order to help the overall understanding of the present invention, the contents described with reference to FIG. 77 are merely provided to describe an example of a configuration of the delay generating unit according to one embodiment of the present invention. In implementing the technical idea of the present invention, as the configuration of the delay generating unit, all of various configurations for acquiring a detection signal from the laser detecting array and outputting a delay signal may be applied.

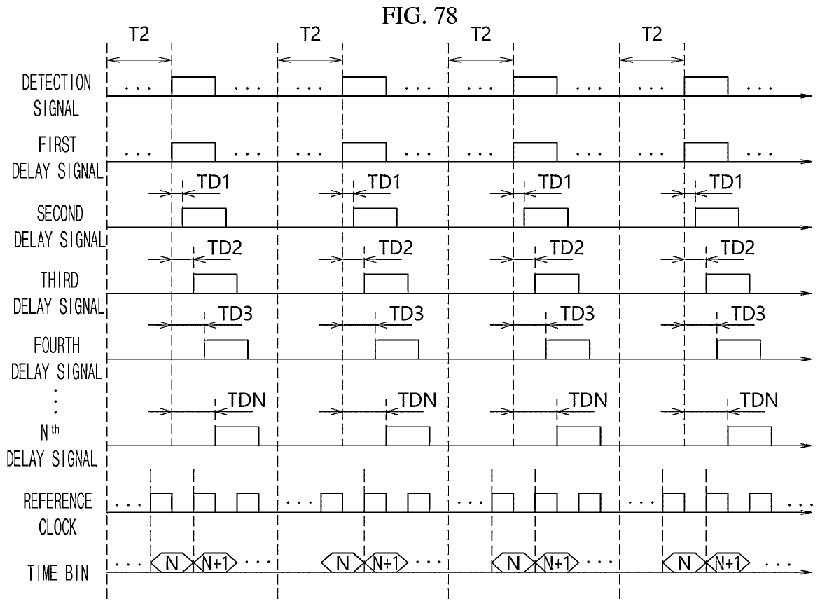

FIG. 78 is a diagram for describing the operation of a signal processing unit for measuring a distance to a second object in a LiDAR device according to one embodiment.

More specifically, FIG. 78 is a diagram for describing the operation of the signal processing unit for measuring the distance to the second object in the LiDAR device including the delay generating unit described with reference to FIG. 77.

In addition, since an example of FIG. 78 is a modified example of the embodiment described with reference to FIG. 73, repetitive descriptions will be omitted, and parts that can be fully understood based on the contents described with reference to FIG. 73 will be omitted.

In this case, according to the delay generating unit described with reference to FIG. 77, N delay signals may be output based on one detection signal.

Accordingly, N delay signals may be output based on a detection signal obtained for each scan period.

In addition, the LiDAR device may detect each of first to N^{th} delay signals using a reference clock.

In addition, histogram data may be stored or updated based on a result of detecting the first to N^{th} delay signals.

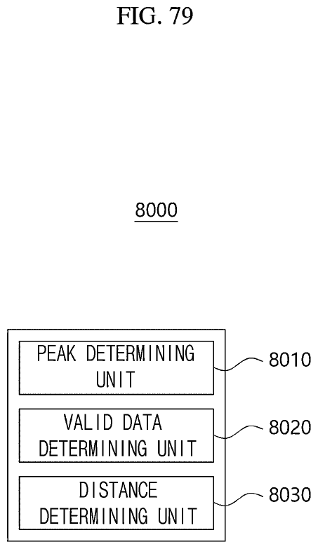

FIG. 79 is a diagram for describing a data processing unit according to one embodiment.

Referring to FIG. 79, a data processing unit 8000 according to one embodiment may include a peak determining unit 8010, a valid data determining unit 8020, and a distance determining unit 8030.

The data processing unit 8000 according to one embodiment may be configured to calculate distance information about an object based on at least one piece of data stored in a memory unit as described above.

The peak determining unit 8010 according to one embodiment may be configured to determine a peak value based on a counting value included in histogram data stored in the memory unit and obtain a time bin value in which the peak value is located, but the present invention is not limited thereto.

In addition, the peak determining unit 8010 according to one embodiment may be configured to determine a rising edge using a counting value and a threshold value included in the histogram data stored in the memory unit and obtain a corresponding time bin value, but the present invention is not limited thereto.

In addition, the valid data determining unit 8020 according to one embodiment may be configured to obtain a time bin value and a counting value in which valid data is located based on the time bin value in which the peak value is located, but the present invention is not limited thereto.

For example, when the peak determining unit 8010 determines that the time bin value in which the peak value is located corresponds to an N^{th} time bin, the valid data determining unit 8020 may determine that values of (N−5)^{th} to (N+5)^{th} time bins and corresponding counting values are valid data based on the N^{th} time bin, but the present invention is not limited thereto.

In addition, the valid data determining unit 8020 according to one embodiment may be configured to obtain a time bin value and a counting value in which valid data is located based on time bin values corresponding to the rising edge and a falling edge, but the present invention is not limited thereto.

For example, when the peak determining unit 8010 determines that the time bin value corresponding to the rising edge corresponds to the N^{th} time bin and the time bin value corresponding to the falling edge corresponds to an M^{th} time bin, the valid data determining unit 8020 may determine that values of the N^{th} time bin, the M^{th} time bin, and a time bin positioned between the N^{th} time bin and the M^{th} time bin, and counting values corresponding thereto are valid data, but the present invention is not limited thereto.

In addition, the distance determining unit 8030 according to one embodiment may be configured to calculate a distance value based on valid data determined by the valid data determining unit 8020.

For example, the distance determining unit 8030 may calculate a distance based on a time bin value in which a peak value of the valid data determined by the valid data determining unit 8020 is located, but the present invention is not limited thereto.

In addition, for example, the distance determining unit 8030 may determine a center of mass of the valid data determined by the valid data determining unit 8020, may extract a time value corresponding to the center of mass, and may calculate a distance value based on the extracted time value, but the present invention is not limited thereto.

In this case, according to one embodiment, the following Equation may be used to extract a time value of a center of mass.

$${T}_{c m} = \frac{{\sum }_{i} {C}_{i} {t}_{i}}{{\sum }_{i} {C}_{i}}$$

In this case, T_{cm} may denote the time value of the center of mass, Cᵢ may denote a counting value of an i^{th} time bin, and tᵢ may denote a time value of the i^{th} time bin.

Furthermore, in addition to the above-described examples, various algorithms for determining a distance based on valid data may be applied to the distance determining unit 8030 according to one embodiment.

In addition, the data processing unit 8000 according to one embodiment may further include an intensity determining unit (not shown).

In this case, various algorithms capable of calculating an intensity based on the sum, average, and the like of counting values of the valid data, calculating an intensity based on a peak value of the valid data, and calculating an intensity based on a width between the rising edge and the falling edge may be applied to the intensity determining unit.

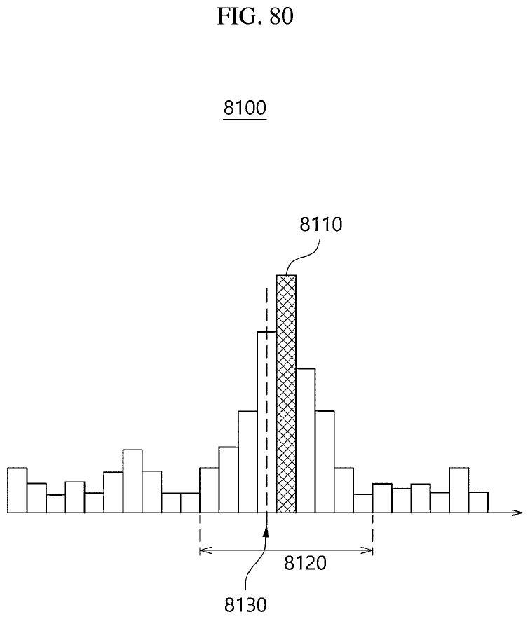

FIG. 80 is a diagram for describing the operation of a data processing unit according to one embodiment.

Referring to FIG. 80, first histogram data 8100 about at least one detecting unit may be obtained from a LiDAR device according to one embodiment.

In this case, a peak value 8110 and a time bin in which the peak value 8110 is located may be determined from the first histogram data 8100, and values of (N±4)^{th} time bins may be determined to be valid data 8120 based on the time bin in which the peak value 8110 is located.

For example, when the time bin in which the peak value 8110 is located is an N^{th} time bin, values of (N−4)^{th} to (N+4)^{th} time bins and counting values corresponding thereto may be determined to be the valid data 8120.

In addition, at least one time value 8130 may be extracted based on the valid data 8120, and the at least one time value 8130 may be extracted through the operation of the above-described distance determining unit.

According to one embodiment of the present invention, there can be provided a LiDAR device with a minimized dead zone.

According to one embodiment of the present invention, there can be provided a LiDAR device which measures a distance using histogram data about a plurality of cycles and has distance resolution higher than that of a preset clock.

Effects of the present invention may not be limited to the above, and other effects which are not described herein should be clearly understood by those skilled in the art, to which the present invention belongs, from the present specification and the accompanying drawings.

Methods according to embodiments may be implemented in the form of program instructions executable through various computing means and may be recorded on computer readable media. The computer-readable media may include, independently or in combination, program instructions, data files, data structures, and so on. Program instructions recorded on the media may be specially designed and configured for the embodiments or may be generally known by those skilled in the computer software field. Computer-readable recording media may include magnetic media such as hard disks, floppy disks, and magnetic tapes, optical media such as a compact disc read only memory (CD-ROM) and a digital versatile disc (DVD), magneto-optical media such as floptical disks, and hardware units, such as a read only memory (ROM), a random access memory (RAM), a flash memory, and so on, which are intentionally formed to store and perform program instructions. Program instructions may include high-class language code executable by computers using interpreters, as well as machine language code made by compilers. The hardware units may be configured to function as one or more software modules for performing the operations according to the embodiments of the present invention, and vice versa.

While embodiments of the present invention have been shown and described with reference to the limited embodiments and drawings, it will be understood by those skilled in the art that various changes and modifications in form and details may be made therein. For example, desired results may be achieved although the embodiments of the present invention are performed in other sequences different from the descriptions, and/or the elements, such as a system, a structure, a device, a circuit, and so on, are combined or assembled in other ways different from the descriptions, or replaced or substituted with other elements or their equivalents.

Therefore, other implementations, other embodiments, and equivalents of the appended claims may be included in the scope of the appended claims.

What is claimed is:

1. A light detection and ranging (LiDAR) device for measuring a distance using histogram data for plurality of detecting cycles, comprising:
a laser detecting array including a first detecting unit;
a delay generating unit configured to obtain a detection signal from the first detecting unit and output a delay signal;
a signal detecting unit configured to detect the delay signal outputted from the delay generating unit using a preset clock;
a memory unit configured to store a histogram data based on a detection result by the signal detecting unit; and
a data processing unit for calculating a distance value for the first detecting unit based on the histogram data stored in the memory unit;
wherein the delay generating unit applies a first delay value for a first detecting cycle, and applies a second delay value for a second detecting cycle,
wherein the first delay value and the second delay value are different from each other.

2. The LiDAR device of claim 1, wherein a number of detecting cycles to which the first delay value is applied among the plurality of detecting cycles is two or more,
wherein a number of detecting cycles to which the second delay value is applied among the plurality of detecting cycles is two or more.

3. The LiDAR device of claim 1, wherein the preset clock is the same for the plurality of detecting cycles.

4. The LiDAR device of claim 1, wherein the first delay value and the second delay value are smaller than a unit length of a time bin of the histogram data.

5. The LiDAR device of claim 1, wherein the second delay value is twice the first delay value.

6. The LiDAR device of claim 1, wherein a number of detecting cycles to which the first delay value is applied is the same as a number of detecting cycles to which the second delay value is applied.

7. The LiDAR device of claim 1, wherein a difference between the first delay value and the second delay value is smaller than a unit length of a time bin of the histogram data.

8. The LiDAR device of claim 1, wherein the data processing unit extracts valid data based on the histogram data,
wherein the data processing unit calculates the distance value for the first detecting unit based on the valid data.

9. The LiDAR device of claim 8, wherein the data processing unit calculates a central time value based on counting values and time bin values included in the valid data,
wherein the data processing unit calculates the distance value for the first detecting unit based on the central time value.

10. A light detection and ranging (LiDAR) device for measuring a distance using histogram data for M detecting cycles, comprising:
a laser detecting array including a first detecting unit;
a delay generating unit configured to obtain a detection signal from the first detecting unit and output a delay signal to which at least one of a first to Nth delay values is applied;
a signal detecting unit configured to detect the delay signal outputted from the delay generating unit using a preset clock;
a memory unit configured to store a histogram data based on a detection result by the signal detecting unit; and
a data processing unit for calculating a distance value for the first detecting unit based on the histogram data stored in the memory unit;
wherein the delay generating unit applies at least one of the first to Nth delay values to each of the M detecting cycles,
wherein a number of detecting cycles to which the same delay value is applied is M/N.

11. The LiDAR device of claim 10,
wherein the M is 128,
wherein the N is 16,
wherein the number of detecting cycles to which the same delay value is applied is 8.

12. A light detection and ranging (LiDAR) device for measuring a distance using histogram data for plurality of detecting cycles, comprising:
a laser detecting array including a first detecting unit;
a delay generating unit configured to obtain a detection signal from the first detecting unit and output a delay signal;
a signal detecting unit configured to detect the delay signal outputted from the delay generating unit using a preset clock;
a memory unit configured to store a histogram data based on a detection result by the signal detecting unit; and
a data processing unit for calculating a distance value for the first detecting unit based on the histogram data stored in the memory unit;
wherein when the LiDAR device operates in a first operation mode, the delay generating unit applies the same delay value to the plurality of detecting cycles,
wherein when the LiDAR device operates in a second operation mode, the delay generating unit applies at least two different delay values to the plurality of detecting cycles.

13. The LiDAR device of claim 12, wherein a delay value applied in the first operation mode is same as one of the at least two different delay values applied in the second operation mode.

14. The LiDAR device of claim 12, wherein the at least two different delay values applied in the second operation mode include a first delay value and a second delay value,
wherein the first delay value is smaller than a delay value applied in the first operation mode,
wherein the second delay value is greater than the delay value applied in the first operation mode.

15. The LiDAR device of claim 12, wherein the laser detecting array include plurality of detecting units,
wherein each of the plurality of detecting units includes at least one of single photon avalanche diode (SPAD).
